(19) United States
(12) Patent Application Publication
(10) Pub. No.: US 2023/0287156 A1
(43) Pub. Date: Sep. 14, 2023

(54) Polyethylene Compositions Obtained Using Transition Metal Bis(Phenolate) Catalyst Complexes and Homogeneous Process for Production Thereof

(71) Applicant: ExxonMobil Chemical Patents Inc., Baytown, TX (US)

(72) Inventors: Peijun Jiang, Katy, TX (US); Jo Ann M. Canich, Houston, TX (US); John R. Hagadorn, Houston, TX (US)

(21) Appl. No.: 17/796,537

(22) PCT Filed: Aug. 11, 2020
(86) PCT No.: PCT/US2020/045823

§ 371 Date: Jul. 29, 2022

Related U.S. Application Data
(60) Provisional application No. 62/972,936, filed on Feb. 11, 2020.

(51) Int. Cl. C08F 210/02; C08F 210/06; C08F 210/08; C08F 210/14; C08F 2/06; C08F 4/64; C08F 4/659

(52) U.S. Cl. CPC C08F 210/02; C08F 2/06; C08F 4/659; C08F 4/64158; C08F 210/06; C08F 210/08; C08F 210/14

(57) ABSTRACT

This invention relates to a homogeneous process to produce polyethylene compositions using transition metal complexes of a dianionic, tridentate ligand that features a central neutral heterocyclic Lewis base and two phenolate donors, where the tridentate ligand coordinates to the metal center to form two eight-membered rings. Preferably the bis(phenolate) complexes are represented by formula I:

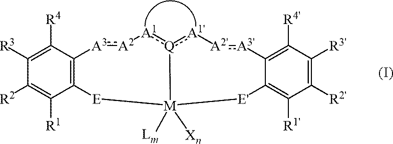

where M, L, X, m, n, E, E′, Q, R¹, R², R³, R⁴, R^{1′}, R^{2′}, R^{3′}, R^{4′}, A¹, A^{1′},

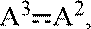

and

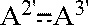

are as defined herein, where A¹QA^{1′} are part of a heterocyclic Lewis base containing 4 to 40 non-hydrogen atoms that links A² to A^{2′} via a 3-atom bridge with Q being the central atom of the 3-atom bridge.

### PRIORITY

This application claims priority to and the benefit of USSN 62/972,936, filed Feb. 11, 2020.

### CROSS REFERENCE TO RELATED APPLICATIONS

This invention is related to:
1) USSN 16/788,022, filed Feb. 11, 2020;
2) USSN 16/788,088, filed Feb. 11, 2020;
3) USSN 16/788,124, filed Feb. 11, 2020;
4) USSN 16/787,909, filed Feb. 11, 2020;
5) USSN 16/787,837, filed Feb. 11, 2020;
6) concurrently filed PCT application number PCT/US2020/__ entitled “Propylene Copolymers Obtained Using Transition Metal Bis(Phenolate) Catalyst Complexes and Homogeneous Process for Production Thereof” (attorney docket number 2020EM048);
7) concurrently filed PCT application number PCT/US/2020__ entitled “Propylene Polymers Obtained Using Transition Metal Bis(Phenolate) Catalyst Complexes and Homogeneous Process for Production Thereof” (attorney docket number 2020EM049); and
8) concurrently filed PCT application number PCT/US/2020__ entitled “Ethylene-Alpha-Olefin-Diene Monomer Copolymers Obtained Using Transition Metal Bis(Phenolate) Catalyst Complexes and Homogeneous Process for Production Thereof” (attorney docket number 2020EM050).

### FIELD OF THE INVENTION

This invention relates polyethylene compositions prepared using novel catalyst compounds comprising group 4 bis(phenolate) complexes, compositions comprising such and processes to prepare such copolymers.

### BACKGROUND OF THE INVENTION

Polyethylene resins are synthesized by copolymerizing ethylene with an alphaolefin comonomer such as propylene, 1-butene, 1-hexene or 1-octene. This copolymerization results in an ethylene-based copolymer with many short chain branches (SCB) along the polymer backbone. For example, the incorporation of propylene, 1-butene, 1-hexene or 1-octene comonomers results in methyl (1 carbon), ethyl (2 carbons), butyl (4 carbons), or hexyl (6 carbons) branches, respectively, along the polymer backbone. Chain length of the short chain branches has effects on the end use properties and processability. The effects of branching on the properties of PE depend on the length and the amount of the branches. Short chain branches (SCB), of less than approximately 40 carbon atoms, interfere with the formation of crystal structures. Short branches mainly influence the mechanical, thermal and optical properties. Applications such as blown film performance are also influenced by the comonomer composition distribution (CCD) (also often referred to as the short chain branch distribution (SCBD)) across the molecular weight distribution (MWD). LLDPE’s have a high impact resistance but are difficult to process, thus LLDPE can benefit from the addition of longer-chain comonomers. Long chain branch (LCB) architecture is another attribute explored for improvements on melt strength and processability.

Polyethylene (PE) and compositions containing polyethylene are useful in many applications, such as in films, fibers, molded or thermoformed articles, pipe coating and the like. Improvements in both the polymer materials used to make such products, and polymer material processability, can synergistically make end-use products more commercially attractive. However, optimum performance is often a matter of trading off one property against another.

Many have been interested in modifying the architecture of such polyolefins in the hopes of obtaining new and better combinations of properties such as melt strength, stiffness, shrink and optical properties. Moreover, high optical clarity, great melt strength, bubble stability and good extrusion characteristics are critical for blown film, such as for heat sealable blown films. However, wide-ranging films made from polyethylene compositions still lack certain properties (e.g., great tensile and impact strength, puncture resistance, excellent optical properties and first-rate sealing properties). Improved strength properties, along with excellent drawability, would allow down gauging in blown film applications (e.g., as a bag).

Catalyst design, polymer reaction engineering, and polymer process technologies have been explored to produce novel polyolefin materials to meet the demands of highly diversified industries. Catalyst design play key roles in manipulating molecular structures of polyethylene, and hence the material properties and processability. Polyethylene markets are currently dominated by products prepared with Ziegler-Natta (ZN) type catalysts and metallocene type catalysts. Optimization of these polyethylene products almost always involve processes that use multiple reactors and/or multiple catalysts. Either of the strategies tends to be complicated and costly. Hence there is interest in finding new catalyst systems that increase the commercial usefulness of the catalyst and allow the production of polymers having improved properties.

Catalysts for olefin polymerization can be based on bis(phenolate) complexes as catalyst precursors, which are activated typically by an alumoxane or an activator containing a non-coordinating anion. Examples of bis(phenolate) complexes can be found in the following references:

KR 2018-022137 (LG Chem.) describes transition metal complexes of bis(methylphenyl phenolate)pyridine.

US 7,030,256 B2 (Symyx Technologies, Inc.) describes bridged bi-aromatic ligands, catalysts, processes for polymerizing and polymers therefrom.

US 6,825,296 (University of Hong Kong) describes transition metal complexes of bis(phenolate) ligands that coordinate to metal with two 6-membered rings.

US 7,847,099 (California Institute of Technology) describes transition metal complexes of bis(phenolate) ligands that coordinate to metal with two 6-membered rings.

WO 2016/172110 (Univation Technologies) describes complexes of tridentate bis(phenolate) ligands that feature a non-cyclic ether or thioether donor.

Other references of interest include: Baier, M. C. et al. in “Post-Metallocenes in the Industrial Production of Polyolefins” Angew. Chem. Int. Ed. 2014, 53, 9722-9744; and Golisz and Bercaw in “Synthesis of Early Transition Metal Bisphenolate Complexes and their use as Olefin Polymerization Catalysts” Macromolecules 2009, 42, 8751-8762.

Further, it is advantageous to conduct commercial solution polymerization reactions at elevated temperatures. Two major catalyst limitations often preventing access to such high temperature polymerizations are the catalyst efficiency and the molecular weight of produced polymers, as both of these factors decrease with rising temperature. Typical metallocene catalysts suitable for use in producing polyethylene copolymer have relatively limited molecular weight capabilities which require low process temperatures to achieve a desired low melt flow rate product.

The newly developed single-site catalyst described herein and in related USSN 16/787,909, filed Feb. 11, 2020 entitled “Transition Metal Bis(Phenolate) Complexes and Their Use as Catalysts for Olefin Polymerization,” (attorney docket number 2020EM045), has the capability of producing high molecular weight polymer at elevated polymerization temperatures. These catalysts, when paired with various types of activators and used in a solution process can produce polyethylene compositions with plastomer properties, such as lower Tm’s with good molecular weight, among other things. Further, the catalyst activity is high which facilitates use in commercially relevant process conditions. This new process provides new copolymers having an extended melt flow rate range and that can be produced with increased reactor throughput and at higher polymerization temperatures during polymer production.

### SUMMARY OF THE INVENTION

This invention relates to polyethylene compositions, such as ethylene and C₃ to C₈ olefin copolymers, and blends comprising such copolymers, where the polyethylene composition are prepared in a solution process using transition metal catalyst complexes of a dianionic, tridentate ligand that features a central neutral heterocyclic Lewis base and two phenolate donors, where the tridentate ligand coordinates to the metal center to form two eight-membered rings. The compositions of polymers and copolymers described herein preferably contain greater than 20 mol% ethylene, with optional C₃ or higher alpha olefin comonomer content of 80 mol% or less.

This invention also relates to polyethylene composition, such as ethylene and C₃ to C₁₂ copolymer (such as ethylene-octene) copolymers, and blends comprising such copolymers, where the polyethylene composition are, prepared in a solution process using bis(phenolate) complexes represented by Formula (I):

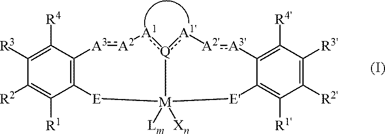

wherein:
M is a group 3-6 transition metal or Lanthanide;
E and E′ are each independently O, S, or NR⁹, where R⁹ is independently hydrogen, C₁-C₄₀ hydrocarbyl, C₁-C₄₀ substituted hydrocarbyl, or a heteroatom-containing group;
Q is group 14, 15, or 16 atom that forms a dative bond to metal M; A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl;

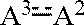

is a divalent group containing 2 to 40 non-hydrogen atoms that links A¹ to the E-bonded aryl group via a 2-atom bridge;

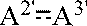

is a divalent group containing 2 to 40 non-hydrogen atoms that links A^{1′} to the E′-bonded aryl group via a 2-atom bridge;
   L is a neutral Lewis base;
   X is an anionic ligand;
   n is 1, 2 or 3;
   m is 0, 1, or 2;
   n+m is not greater than 4;
   each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
   any two L groups may be joined together to form a bidentate Lewis base;
   an X group may be joined to an L group to form a monoanionic bidentate group;
   any two X groups may be joined together to form a dianionic ligand group.

This invention also relates to a solution phase method to polymerize olefins comprising contacting a catalyst compound as described herein with an activator, ethylene and one or more comonomers. This invention further relates to polyethylene composition compositions produced by the methods described herein.

### Definitions

For the purposes of this invention and the claims thereto, the following definitions shall be used:

The new numbering scheme for the Periodic Table Groups is used as described in CHEMICAL AND ENGINEERING NEWS, 63(5), pg. 27 (1985). Therefore, a “group 4 metal” is an element from group 4 of the Periodic Table, e.g. Hf, Ti, or Zr.

“Catalyst productivity” is a measure of the mass of polymer produced using a known quantity of polymerization catalyst. Typically, “catalyst productivity” is expressed in units of kg of polymer per kg of catalyst or grams of polymer per mmols of catalyst or the like. If units are not specified then the “catalyst productivity” is in units of kg of polymer per gram of catalyst. For calculating catalyst productivity only the weight of the transition metal component of the catalyst is used (i.e. the activator and/or co-catalyst is omitted). “Catalyst activity” is a measure of the mass of polymer produced using a known quantity of polymerization catalyst per unit time for batch and semi-batch polymerizations. Typically, “catalyst activity” is expressed in units of (g of polymer)/(mmol of catalyst)/hour or (kg of polymer)/(mmols of catalyst)/hour or the like. If units are not specified then the “catalyst activity” is in units of (g of polymer)/(mmol of catalyst)/hour.

“Conversion” is the percentage of a monomer that is converted to polymer product in a polymerization, and is reported as % and is calculated based on the polymer yield, the polymer composition, and the amount of monomer fed into the reactor.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt% to 55 wt%, it is understood that the mer unit in the copolymer is derived from ethylene in the polymerization reaction and said derived units are present at 35 wt% to 55 wt%, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mole% ethylene derived units, a “propylene polymer” or “propylene copolymer” is a polymer or copolymer comprising at least 50 mole% propylene derived units, and so on. A polyethylene composition comprises an ethylene polymer or ethylene copolymer.

Ethylene shall be considered an α-olefin.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthalenyl, and the like.

Unless otherwise indicated, (e.g., the definition of “substituted hydrocarbyl”, etc.), the term “substituted” means that at least one hydrogen atom has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring (typically made of 6 carbon atoms) and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph—O—, Ph—S—, and Ph—N(R^)—groups, where R^ is hydrogen, C₁-C₄₀ hydrocarbyl, C₁-C₄₀ substituted hydrocarbyl, a heteroatom or a heteroatom-containing group). Preferably, a “substituted phenolate” group in the catalyst compounds described herein is represented by the formula:

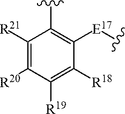

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R¹⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy lines show where the substituted phenolate group forms bonds to the rest of the catalyst compound.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantanyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocyclic, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)_{q}—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by formula A:

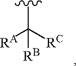

wherein R^{A}, R^{B} and R^{C} are hydrocarbyl groups or substituted hydrocarbyl groups that may optionally be bonded to one another, and the wavy line shows where the tertiary hydrocarbyl group forms bonds to other groups.

A cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantanyl, 1-methylcyclohexyl, 1-methylcyclopentyl, 1-methylcyclooctyl, 1-methylcyclodecyl, 1-methylcyclododecyl, bicyclo[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by formula B:

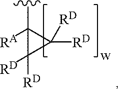

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical,” and “alkyl” are used interchangeably throughout this disclosure. For purposes of this disclosure, “alkyl radical” is defined to be C₁-C₁₀₀ alkyls, that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q—SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt% is weight percent, and mol% is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme (also referred to as DME) is 1,2-dimethoxyethane, p-tBu is para-tertiary butyl, TMS is trimethylsilyl, TIBAL is triisobutylaluminum, TNOA and TNOAL are tri(n-octyl)aluminum, p-Me is para-methyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is carbazole, Cy is cyclohexyl, h is hours, and min is minutes.

A “catalyst system” is a combination comprising at least one catalyst compound and at least one activator. When “catalyst system” is used to describe such a pair before activation, it means the unactivated catalyst complex (precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this invention and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors in the context of the present invention include, but are not limited to, methyl, chloride, fluoride, alkoxide, aryloxide, alkyl, alkenyl, thiolate, carboxylate, amido, methyl, benzyl, hydrido, amidinate, amidate, and phenyl. Two anionic donors may be joined to form a dianionic group.

A “neutral Lewis base or “neutral donor group” is an uncharged (i.e. neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, allenes, and carbenes. Lewis bases may be joined together to form bidentate or tridentate Lewis bases.

For purposes of this invention and the claims thereto, phenolate donors include Ph—O—, Ph—S—, and Ph—N(R^)— groups, where R^ is hydrogen, C₁-C₄₀ hydrocarbyl, C₁-C₄₀ substituted hydrocarbyl, a heteroatom or a heteroatom-containing group, and Ph is optionally substituted phenyl.

### DETAILED DESCRIPTION

This invention relates solution processes and polyethylene compositions prepared using a new catalyst family comprising transition metal complexes of a dianionic, tridentate ligand that features a central neutral donor group and two phenolate donors, where the tridentate ligands coordinate to the metal center to form two eight-membered rings. In complexes of this type it is advantageous for the central neutral donor to be a heterocyclic group. It is particularly advantageous for the heterocyclic group to lack hydrogens in the position alpha to the heteroatom. In complexes of this type it is also advantageous for the phenolates to be substituted with one or more cyclic tertiary alkyl substituents. The use of cyclic tertiary alkyl substituted phenolates is demonstrated to improve the ability of these catalysts to produce high molecular weight polymer.

Complexes of substituted bis(phenolate) ligands (such as adamantanyl-substituted bis(phenolate) ligands) useful herein form active olefin polymerization catalysts when combined with activators, such as non-coordinating anion or alumoxane activators. Useful bis(aryl phenolate)pyridine complexes comprise a tridentate bis(aryl phenolate)pyridine ligand that is coordinated to a group 4 transition metal with the formation of two eight-membered rings.

This invention also relates to solution processes to produce polyethylene compositions utilizing a metal complex comprising: a metal selected from groups 3-6 or Lanthanide metals, and a tridentate, dianionic ligand containing two anionic donor groups and a neutral Lewis base donor, wherein the neutral Lewis base donor is covalently bonded between the two anionic donors, and wherein the metal-ligand complex features a pair of 8-membered metallocycle rings.

This invention relates to catalyst systems used in solution processes to prepare polyethylene compositions comprising activator and one or more catalyst compounds as described herein.

This invention also relates to solution processes (preferably at higher temperatures) to polymerize olefins using the catalyst compounds described herein comprising contacting ethylene and one or more olefin comonomers with a catalyst system comprising an activator and a catalyst compound described herein.

The present disclosure also relates to a catalyst system comprising a transition metal compound and an activator compound as described herein, to the use of such activator compounds for activating a transition metal compound in a catalyst system for polymerizing ethylene and olefin comonomers, and to processes for polymerizing said olefins, the process comprising contacting under polymerization conditions ethylene and one or more olefin comonomers with a catalyst system comprising a transition metal compound and activator compounds, where aromatic solvents, such as toluene, are absent (e.g. present at zero mol% relative to the moles of activator, alternately present at less than 1 mol%, preferably the catalyst system, the polymerization reaction and/or the polymer produced are free of detectable aromatic hydrocarbon solvent, such as toluene).

The polyethylene compositions produced herein preferably contain 0 ppm (alternately less than 1 ppm, alternately less than 100 ppm, alternately less than 500 ppm) of aromatic hydrocarbon, such as toluene. Preferably, the polyethylene compositions produced herein contain 0 ppm (alternately less than 1 ppm) of toluene.

The catalyst systems used herein preferably contain 0 ppm (alternately less than 1 ppm) of aromatic hydrocarbon. Preferably, the catalyst systems used herein contain 0 ppm (alternately less than 1 ppm) of toluene.

### Catalyst Compounds

The terms “catalyst”, “compound”, “catalyst compound”, and “complex” may be used interchangeably to describe a transition metal or Lanthanide metal complex that forms an olefin polymerization catalyst when combined with a suitable activator.

The catalyst complexes of the present invention comprise a metal selected from groups 3, 4, 5 or 6 or Lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. Preferably the dianionic, tridentate ligand features a central heterocyclic donor group and two phenolate donors and the tridentate ligand coordinates to the metal center to form two eight-membered rings.

The metal is preferably selected from group 3, 4, 5, or 6 elements. Preferably the metal, M, is a group 4 metal. Most preferably the metal, M, is zirconium or hafnium.

Preferably the heterocyclic Lewis base donor features a nitrogen or oxygen donor atom. Preferred heterocyclic groups include derivatives of pyridine, pyrazine, pyrimidine, triazine, thiazole, imidazole, thiophene, oxazole, thiazole, furan, and substituted variants of thereof. Preferably the heterocyclic Lewis base lacks hydrogen(s) in the position alpha to the donor atom. Particularly preferred heterocyclic Lewis base donors include pyridine, 3-substituted pyridines, and 4-substituted pyridines.

The anionic donors of the tridentate dianionic ligand may be arylthiolates, phenolates, or anilides. Preferred anionic donors are phenolates. It is preferred that the tridentate dianionic ligand coordinates to the metal center to form a complex that lacks a mirror plane of symmetry. It is preferred that the tridentate dianionic ligand coordinates to the metal center to form a complex that has a two-fold rotation axis of symmetry; when determining the symmetry of the bis(phenolate) complexes only the metal and dianionic tridentate ligand are considered (i.e. ignore remaining ligands).

The bis(phenolate) ligands useful in the present invention include dianionic multidentate ligands that feature two anionic phenolate donors. Preferably, the bis(phenolate) ligands are tridentate dianionic ligands that coordinate to the metal M in such a fashion that a pair of 8-membered metallocycle rings are formed. The preferred bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins, particularly isotactic poly(alpha olefins). If the ligands were coordinated to the metal in such a manner that the complex had mirror-plane (Cₛ) symmetry, then the catalyst would be expected to produce only atactic poly(alpha olefins); these symmetry-reactivity rules are summarized by Bercaw in Macromolecules 2009, 42, 8751-8762. The pair of 8-membered metallocycle rings of the inventive complexes is also a notable feature that is advantageous for catalyst activity, temperature stability, and isoselectivity of monomer enchainment. Related group 4 complexes featuring smaller 6-membered metallocycle rings are known (Macromolecules 2009, 42, 8751-8762) to form mixtures of C₂ and Cₛ symmetric complexes when used in olefin polymerizations and are thus not well suited to the production of highly isotactic poly(alpha olefins).

Bis(phenolate) ligands that contain oxygen donor groups (i.e. E = E′ = oxygen in Formula (I) in the present invention are preferably substituted with alkyl, substituted alkyl, aryl, or other groups. It is advantageous that each phenolate group be substituted in the ring position that is adjacent to the oxygen donor atom. It is preferred that substitution at the position adjacent to the oxygen donor atom be an alkyl group containing 1-20 carbon atoms. It is preferred that substitution at the position next to the oxygen donor atom be a non-aromatic cyclic alkyl group with one or more five- or six-membered rings. It is preferred that substitution at the position next to the oxygen donor atom be a cyclic tertiary alkyl group. It is highly preferred that substitution at the position next to the oxygen donor atom be adamantan-1-yl or substituted adamantan-1-yl.

The neutral heterocyclic Lewis base donor is covalently bonded between the two anionic donors via “linker groups” that join the heterocyclic Lewis base to the phenolate groups. The “linker groups” are indicated by (A³A²) and (A^{2′}A^{3′}) in Formula (I). The choice of each linker group may affect the catalyst performance, such as the tacticity of the poly(alpha olefin) produced. Each linker group is typically a C₂-C₄₀ divalent group that is two-atoms in length. One or both linker groups may independently be phenylene, substituted phenylene, heteroaryl, vinylene, or a non-cyclic two-carbon long linker group. When one or both linker groups are phenylene, the alkyl substituents on the phenylene group may be chosen to optimize catalyst performance. Typically, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

This invention further relates to catalyst compounds, and catalyst systems comprising such compounds, represented by the Formula (I):

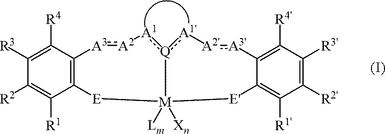

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
Q is group 14, 15, or 16 atom that forms a dative bond to metal M, preferably Q is C, O, S or N, more preferably Q is C, N or O, most preferably Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line joining A¹ and A^{1′} represents the heterocyclic Lewis base), A¹ and A^{1′} are independently C, N, or C(R²²), where R²² is selected from hydrogen, C₁-C₂₀ hydrocarbyl, and C₁-C₂₀ substituted hydrocarbyl. Preferably A¹ and A^{1′} are C;

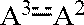

is a divalent group containing 2 to 40 non-hydrogen atoms that links A¹ to the E-bonded aryl group via a 2-atom bridge, such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably

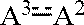

is a divalent hydrocarbyl group;

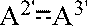

is a divalent group containing 2 to 40 non-hydrogen atoms that links A^{1′} to the E′-bonded aryl group via a 2-atom bridge such as ortho-phenylene, substituted ortho-phenylene, ortho-arene, indolene, substituted indolene, benzothiophene, substituted benzothiophene, pyrrolene, substituted pyrrolene, thiophene, substituted thiophene, 1,2-ethylene (—CH₂CH₂—), substituted 1,2-ethylene, 1,2-vinylene (—HC═CH—), or substituted 1,2-vinylene, preferably

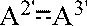

is a divalent hydrocarbyl group;
   each L is independently a Lewis base;
   each X is independently an anionic ligand;
   n is 1, 2 or 3;
   m is 0, 1, or 2;
   n+m is not greater than 4;
   each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group (preferably R^{1′} and R¹ are independently a cyclic group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
   any two L groups may be joined together to form a bidentate Lewis base;
   an X group may be joined to an L group to form a monoanionic bidentate group;
   any two X groups may be joined together to form a dianionic ligand group.

This invention is further related to catalyst compounds, and catalyst systems comprising such compounds, represented by the Formula (II):

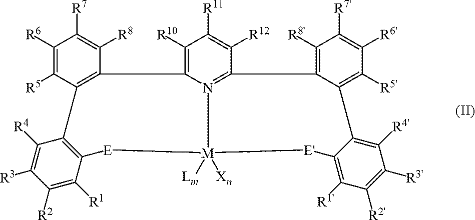

wherein:
M is a group 3, 4, 5, or 6 transition metal or a Lanthanide (such as Hf, Zr or Ti);
E and E′ are each independently O, S, or NR⁹, where R⁹ is independently hydrogen, C₁-C₄₀ hydrocarbyl, C₁-C₄₀ substituted hydrocarbyl, or a heteroatom-containing group, preferably O, preferably both E and E′ are O;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is preferably selected from group 3, 4, 5, or 6 elements, more preferably group 4. Most preferably the metal, M, is zirconium or hafnium.

The donor atom Q of the neutral heterocyclic Lewis base (in Formula (I)) is preferably nitrogen, carbon, or oxygen. Preferred Q is nitrogen.

Non-limiting examples of neutral heterocyclic Lewis base groups include derivatives of pyridine, pyrazine, pyrimidine, triazine, thiazole, imidazole, thiophene, oxazole, thiazole, furan, and substituted variants of thereof. Preferred heterocyclic Lewis base groups include derivatives of pyridine, pyrazine, thiazole, and imidazole.

Each A¹ and A^{1′} of the heterocyclic Lewis base (in Formula (I)) are independently C, N, or C(R²²), where R²² is selected from hydrogen, C₁-C₂₀ hydrocarbyl, and C₁-C₂₀ substituted hydrocarbyl. Preferably A¹ and A^{1′} are carbon. When Q is carbon, it is preferred that A¹ and A^{1′} be selected from nitrogen and C(R²²). When Q is nitrogen, it is preferred that A¹ and A^{1′} be carbon. It is preferred that Q = nitrogen, and A¹ = A^{1′} = carbon. When Q is nitrogen or oxygen, is preferred that the heterocyclic Lewis base in Formula (I) not have any hydrogen atoms bound to the A¹ or A^{1′} atoms. This is preferred because it is thought that hydrogens in those positions may undergo unwanted decomposition reactions that reduce the stability of the catalytically active species.

The heterocyclic Lewis base (of Formula (I)) represented by A¹QA^{1′} combined with the curved line joining A¹ and A^{1′} is preferably selected from the following, with each R²³ group selected from hydrogen, heteroatoms, C₁-C₂₀ alkyls, C₁-C₂₀ alkoxides, C₁-C₂₀ amides, and C₁-C₂₀ substituted alkyls.

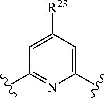

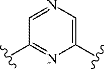

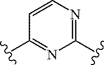

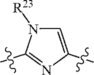

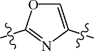

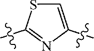

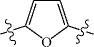

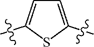

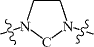

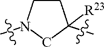

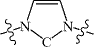

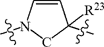

In Formula (I) or (II), E and E′ are each selected from oxygen or NR⁹, where R⁹ is independently hydrogen, C₁-C₄₀ hydrocarbyl, C₁-C₄₀ substituted hydrocarbyl, or a heteroatom-containing group. It is preferred that E and E′ are oxygen. When E and/or E′ are NR⁹ it is preferred that R⁹ be selected from C₁ to C₂₀ hydrocarbyls, alkyls, or aryls. In one embodiment E and E′ are each selected from O, S, or N(alkyl) or N(aryl), where the alkyl is preferably a C₁ to C₂₀ alkyl, such as methyl, ethyl, propyl, butyl, pentyl, hexyl, octyl, nonyl, decyl, undecyl, dodecyl and the like, and aryl is a C₆ to C₄₀ aryl group, such as phenyl, naphthalenyl, benzyl, methylphenyl, and the like.

In embodiments,

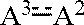

and

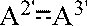

are independently a divalent hydrocarbyl group, such as C₁ to C₁₂ hydrocarbyl group.

In complexes of Formula (I) or (II), when E and E′ are oxygen it is advantageous that each phenolate group be substituted in the position that is next to the oxygen atom (i.e. R¹ and R^{1′} in Formula (I) and (II)). Thus, when E and E′ are oxygen it is preferred that each of R¹ and R^{1′} is independently a C₁-C₄₀ hydrocarbyl, a C₁-C₄₀ substituted hydrocarbyl, a heteroatom or a heteroatom-containing group, more preferably, each of R¹ and R^{1′} is independently a non-aromatic cyclic alkyl group with one or more five- or six-membered rings (such as cyclohexyl, cyclooctyl, adamantanyl, or 1-methylcyclohexyl, or substituted adamantanyl), most preferably a non-aromatic cyclic tertiary alkyl group (such as 1-methylcyclohexyl, adamantanyl, or substituted adamantanyl).

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

In some embodiments of the invention of Formula (I) or (II), each of R¹ and R^{1′} is independently a tertiary hydrocarbyl group. In other embodiments of the invention of Formula (I) or (II), each of R¹ and R^{1′} is independently a cyclic tertiary hydrocarbyl group. In other embodiments of the invention of Formula (I) or (II), each of R¹ and R^{1′} is independently a polycyclic tertiary hydrocarbyl group.

The linker groups (i.e.

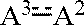

and

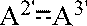

in Formula (I)) are each preferably part of an ortho-phenylene group, preferably a substituted ortho-phenylene group. It is preferred for the R⁷ and R^{7′} positions of Formula (II) to be hydrogen, or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as iospropyl, etc. For applications targeting polymers with high tacticity it is preferred for the R⁷ and R^{7′} positions of Formula (II) to be a C₁ to C₂₀ alkyl, most preferred for both R⁷ and R^{7′} to be a C₁ to C₃ alkyl.

In embodiments of Formula (I) herein, Q is C, N or O, preferably Q is N.

In embodiments of Formula (I) herein, A¹ and A^{1′} are independently carbon, nitrogen, or C(R²²), with R²² selected from hydrogen, C₁-C₂₀ hydrocarbyl, C₁-C₂₀ substituted hydrocarbyl. Preferably A¹ and A^{1′} are carbon.

In embodiments of Formula (I) herein, A¹QA^{1′} in Formula (I) is part of a heterocyclic Lewis base, such as a pyridine, pyrazine, pyrimidine, triazine, thiazole, imidazole, thiophene, oxazole, thiazole, furan, or a substituted variant of thereof.

In embodiments of Formula (I) herein, A¹QA^{1′} are part of a heterocyclic Lewis base containing 2 to 20 non-hydrogen atoms that links A² to A^{2′} via a 3-atom bridge with Q being the central atom of the 3-atom bridge. Preferably each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In one embodiment of Formula (I) herein, Q is carbon, and each A¹ and A^{1′} is N or C(R²²), where R²² is selected from hydrogen, C₁-C₂₀ hydrocarbyl, C₁-C₂₀ substituted hydrocarbyl, a heteroatom or a heteroatom-containing group. In this embodiment, the A¹QA^{1′} fragment forms part of a cyclic carbene, N-heterocyclic carbene, cyclic amino alkyl carbene, or a substituted variant of thereof group, or a substituted variant thereof.

In embodiments of Formula (I) herein,

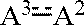

is a divalent group containing 2 to 20 non-hydrogen atoms that links A¹ to the E-bonded aryl group via a 2-atom bridge, where the

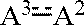

is a linear alkyl or forms part of a cyclic group (such as an optionally substituted ortho-phenylene group, or ortho-arylene group) or a substituted variant thereof.

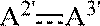

is a divalent group containing 2 to 20 non-hydrogen atoms that links A^{1′} to the E′-bonded aryl group via a 2-atom bridge, where the

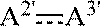

is a linear alkyl or forms part of a cyclic group (such as an optionally substituted ortho-phenylene group, or ortho-arylene group or, or a substituted variant thereof.

In embodiments of the invention herein, in Formula (I) and (II), M is a group 4 metal, such as Hf or Zr.

In embodiments of the invention herein, in Formula (I) and (II), E and E′ are O.

In embodiments of the invention herein, in Formula (I) and (II), R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, preferably hydrogen, methyl, ethyl, propyl, butyl, pentyl, hexyl, or an isomer thereof.

In embodiments of the invention herein, in Formula (I) and (II), R¹, R², R³, R⁴, R^{1′}, R^{2′}, R^{3′}, R⁴, and R⁹ are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of the invention herein, in Formula (I) and (II), R⁴ and R^{4′} is independently hydrogen or a C₁ to hydrocarbyl, such as methyl, ethyl or propyl.

In embodiments of the invention herein, in Formula (I) and (II), R⁹ is hydrogen, C₁-C₄₀ hydrocarbyl, C₁-C₄₀ substituted hydrocarbyl, or a heteroatom-containing group, preferably hydrogen, methyl, ethyl, propyl, butyl, pentyl, hexyl, or an isomer thereof. Preferably R⁹ is methyl, ethyl, propyl, butyl, C₁ to C₆ alkyl, phenyl, 2-methylphenyl, 2,6-dimethylphenyl, or 2,4,6-trimethylphenyl.

In embodiments of the invention herein, in Formula (I) and (II), each X is, independently, selected from the group consisting of hydrocarbyl radicals having from 1 to 20 carbon atoms (such as alkyls or aryls), hydrides, amides, alkoxides, sulfides, phosphides, halides, alkyl sulfonates, and a combination thereof, (two or more X’s may form a part of a fused ring or a ring system), preferably each X is independently selected from halides, aryls, and C₁ to C₅ alkyl groups, preferably each X is independently a hydrido, dimethylamido, diethylamido, methyltrimethylsilyl, neopentyl, phenyl, benzyl, methyl, ethyl, propyl, butyl, pentyl, fluoro, iodo, bromo, or chloro group.

Alternatively, each X may be, independently, a halide, a hydride, an alkyl group, an alkenyl group or an arylalkyl group.

In embodiments of the invention herein, in Formula (I) and (II), each L is a Lewis base, independently, selected from the group consisting of ethers, thioethers, amines, nitriles, imines, pyridines, halocarbons, and phosphines, preferably ethers and thioethers, and a combination thereof, optionally two or more L’s may form a part of a fused ring or a ring system, preferably each L is independently selected from ether and thioether groups, preferably each L is a ethyl ether, tetrahydrofuran, dibutyl ether, or dimethylsulfide group.

In embodiments of the invention herein, in Formula (I) and (II), R¹ and R^{1′} are independently cyclic tertiary alkyl groups.

In embodiments of the invention herein, in Formula (I) and (II), n is 1, 2 or 3, typically 2.

In embodiments of the invention herein, in Formula (I) and (II), m is 0, 1 or 2, typically 0.

In embodiments of the invention herein, in Formula (I) and (II), R¹ and R^{1′} are not hydrogen.

In embodiments of the invention herein, in Formula (I) and (II), M is Hf or Zr, E and E′ are O; each of R¹ and R^{1′} is independently a C₁-C₄₀ hydrocarbyl, a C₁-C₄₀ substituted hydrocarbyl, a heteroatom or a heteroatom-containing group, each R², R³, R⁴, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; each X is, independently, selected from the group consisting of hydrocarbyl radicals having from 1 to 20 carbon atoms (such as alkyls or aryls), hydrides, amides, alkoxides, sulfides, phosphides, halides, and a combination thereof, (two or more X’s may form a part of a fused ring or a ring system); each L is, independently, selected from the group consisting of ethers, thioethers, and halo carbons (two or more L’s may form a part of a fused ring or a ring system).

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, C₁-C₄₀ hydrocarbyl, C₁-C₄₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In embodiments of the invention herein, in Formula (II), each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of the invention herein, in Formula (II), M is Hf or Zr, E and E′ are O; each of R¹ and R^{1′} is independently a C₁-C₄₀ hydrocarbyl, a C₁-C₄₀ substituted hydrocarbyl, a heteroatom or a heteroatom-containing group,
each R¹, R², R³, R⁴, R^{1′}, R^{2′}, R^{3′}, and R^{4′} is independently hydrogen, C₁-C₂₀ hydrocarbyl, C₁-C₂₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; R⁹ is hydrogen, C₁-C₂₀ hydrocarbyl, C₁-C₂₀ substituted hydrocarbyl, or a heteroatom-containing group, such as hydrogen, methyl, ethyl, propyl, butyl, pentyl, hexyl, or an isomer thereof;
each X is, independently, selected from the group consisting of hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X’s may form a part of a fused ring or a ring system); n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, C₁-C₂₀ substituted hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is are independently selected from methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

Preferred embodiment of Formula (I) is M is Zr or Hf, Q is nitrogen, both A¹ and A^{1′} are carbon, both E and E′ are oxygen, and both R¹ and R^{1′} are C₄-C₂₀ cyclic tertiary alkyls.

Preferred embodiment of Formula (I) is M is Zr or Hf, Q is nitrogen, both A¹ and A^{1′} are carbon, both E and E′ are oxygen, and both R¹ and R^{1′} are adamantan-1-yl or substituted adamantan-1-yl.

Preferred embodiment of Formula (I) is M is Zr or Hf, Q is nitrogen, both A¹ and A^{1′} are carbon, both E and E′ are oxygen, and X is methyl or chloro, and n is 2.

Preferred embodiment of Formula (II) is M is Zr or Hf, both E and E′ are oxygen, and both R¹ and R^{1′} are C₄-C₂₀ cyclic tertiary alkyls.

Preferred embodiment of Formula (II) is M is Zr or Hf, both E and E′ are oxygen, and both R¹ and R^{1′} are adamantan-1-yl or substituted adamantan-1-yl.

Preferred embodiment of Formula (II) is M is Zr or Hf, both E and E′ are oxygen, and each of R¹, R^{1′}, R³ and R^{3′} are adamantan-1-yl or substituted adamantan-1-yl.

Preferred embodiment of Formula (II) is M is Zr or Hf, both E and E′ are oxygen, both R¹ and R^{1′} are C₄-C₂₀ cyclic tertiary alkyls, and both R⁷ and R^{7′} are C₁-C₂₀ alkyls.

Catalyst compounds that are particularly useful in this invention include one or more of: dimethylzirconium[2′,2‴-(pyridine-2,6-diyl)bis(3-adamantan-1-yl)-5-(tert-butyl)-[1,1′-biphenyl]-2-olate)], dimethylhafnium[2′,2‴-(pyridine-2,6-diyl)bis(3-adamantan-1-yl)-5-(tert-butyl)-[1,1′-biphenyl]-2-olate)], dimethylzirconium[6,6′-(pyridine-2,6-diylbis(benzo[b]thiophene-3,2-diyl))bis(2-adamantan-1-yl)-4-methylphenolate)], dimethylhafnium[6,6′-(pyridine-2,6-diylbis(benzo[b]thiophene-3,2-diyl))bis(2-adamantan-1-yl)-4-methylphenolate)], dimethylzirconium[2′,2‴-(pyridine-2,6-diyl)bis(3-((3r,5r,7r)-adamantan-1-yl)-5-methyl-[1,1′-biphenyl]-2-olate)], dimethylhafnium[2′,2‴-(pyridine-2,6-diyl)bis(3-((3r,5r,7r)-adamantan-1-yl)-5-methyl-[1,1′-biphenyl]-2-olate )], dimethylzirconium[2′,2‴-(pyridine-2,6-diyl)bis(3-((3r,5r,7r)-adamantan-1-yl)-4′,5-dimethyl-[1,1′-biphenyl]-2-olate)], dimethylhafnium[2′,2‴-(pyridine-2,6-diyl)bis(3-((3r,5r,7r)-adamantan-1-yl)-4′,5-dimethyl-[1,1′-biphenyl]-2-olate)].

Catalyst compounds that are particularly useful in this invention include those represented by one or more of the formulas:

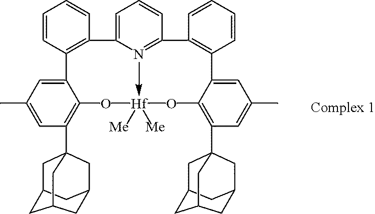

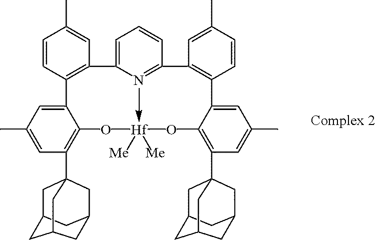

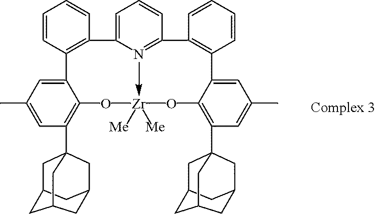

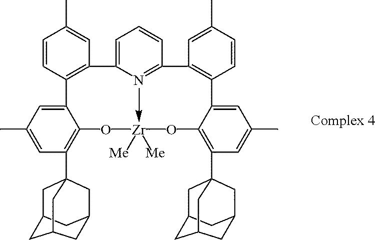

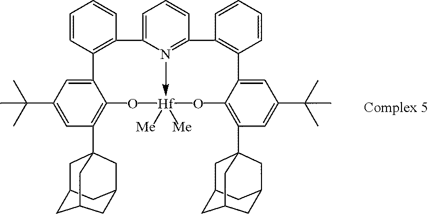

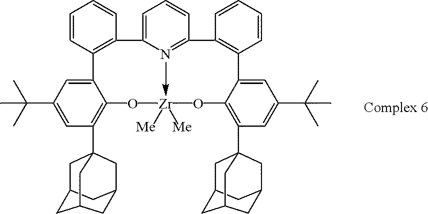

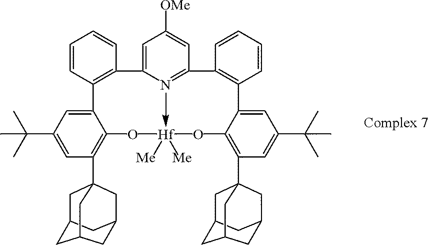

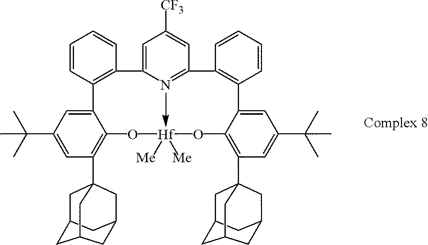

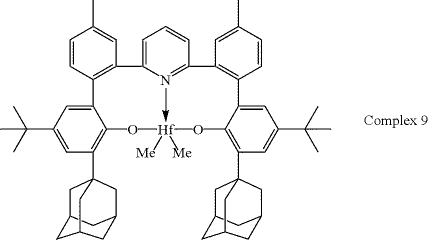

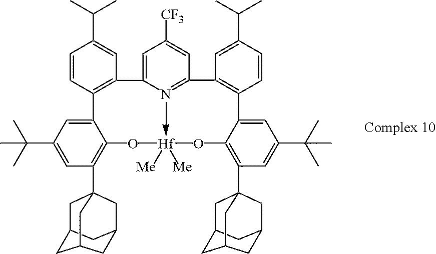

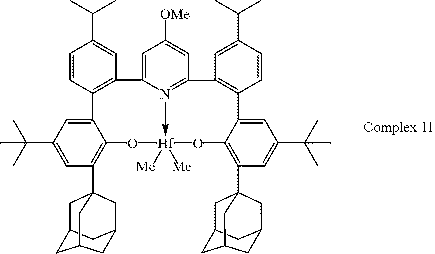

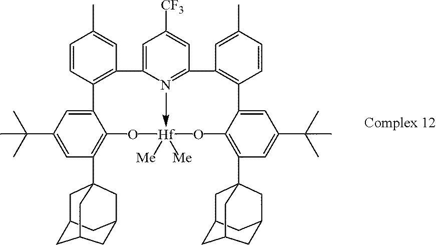

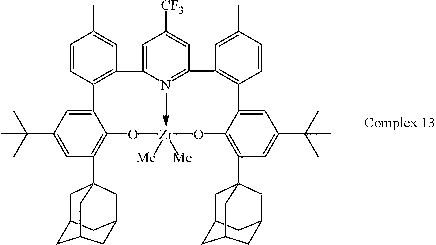

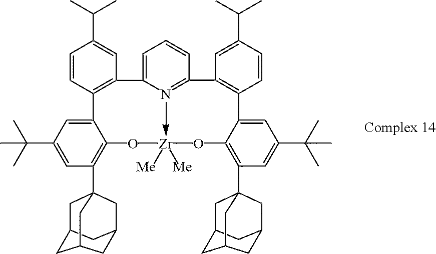

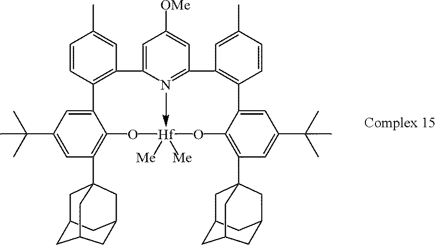

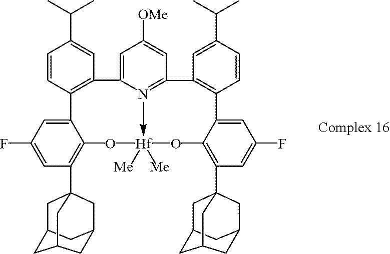

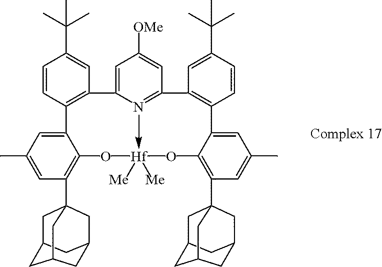

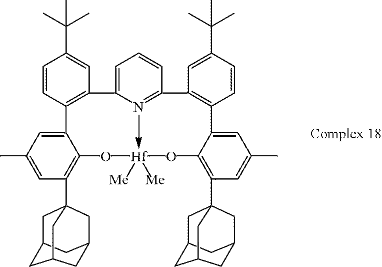

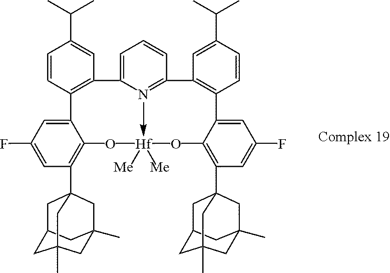

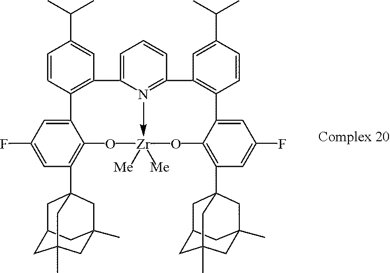

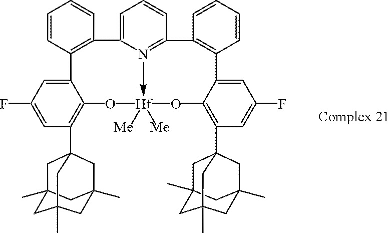

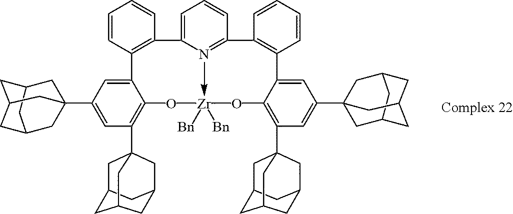

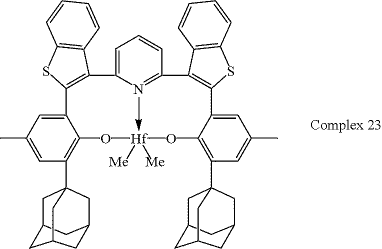

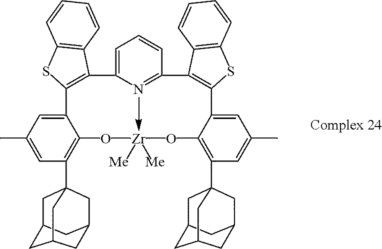

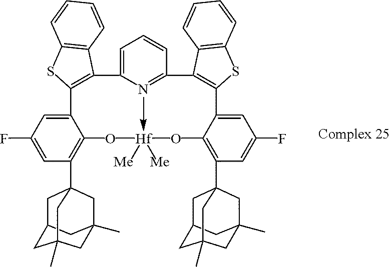

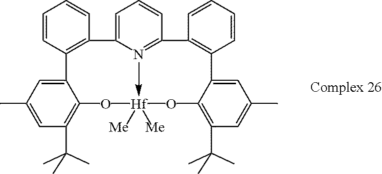

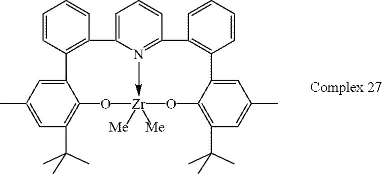

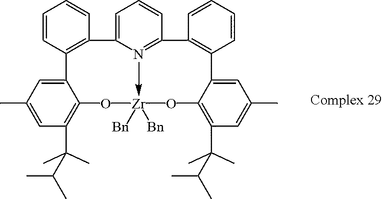

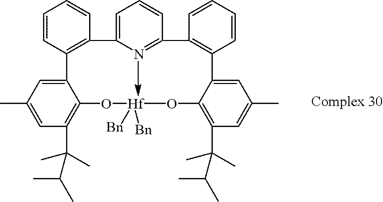

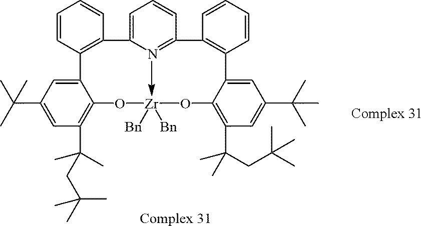

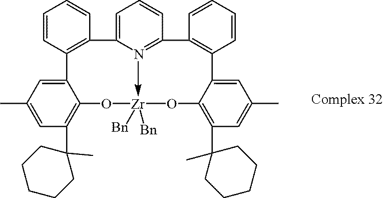

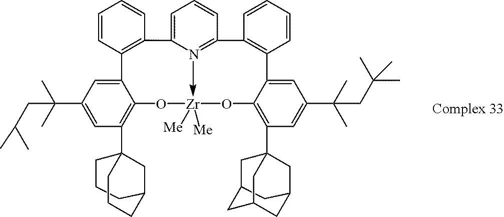

In some embodiments, two or more different catalyst compounds are present in the catalyst system used herein. In some embodiments, two or more different catalyst compounds are present in the reaction zone where the process(es) described herein occur. It is preferable to use the same activator for the transition metal compounds, however, two different activators, such as a non-coordinating anion activator and an alumoxane, can be used in combination. If one or more transition metal compounds contain an X group which is not a hydride, hydrocarbyl, or substituted hydrocarbyl, then the alumoxane can be contacted with the transition metal compounds prior to addition of the non-coordinating anion activator.

The two transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Methods to Prepare the Catalyst Compounds

### Ligand Synthesis

The bis(phenol) ligands may be prepared using the general methods shown in Scheme 1. The formation of the bis(phenol) ligand by the coupling of compound A with compound B (method 1) may be accomplished by known Pd- and Ni-catalyzed couplings, such as Negishi, Suzuki, or Kumada couplings. The formation of the bis(phenol) ligand by the coupling of compound C with compound D (method 2) may also be accomplished by known Pd- and Ni-catalyzed couplings, such as Negishi, Suzuki, or Kumada couplings. Compound D may be prepared from compound E by reaction of compound E with either an organolithium reagent or magnesium metal, followed by optional reaction with a main-group metal halide (e.g. ZnCl₂) or boron-based reagent (e.g. B(OⁱPr)₃, ⁱPrOB(pin)). Compound E may be prepared in a non-catalyzed reaction from by the reaction of an aryllithium or aryl Grignard reagent (compound F) with a dihalogenated arene (compound G), such as 1-bromo-2-chlorobenzene. Compound E may also be prepared in a Pd- or Ni-catalyzed reaction by reaction of an arylzinc or aryl-boron reagent (compound F) with a dihalogenated arene (compound G).

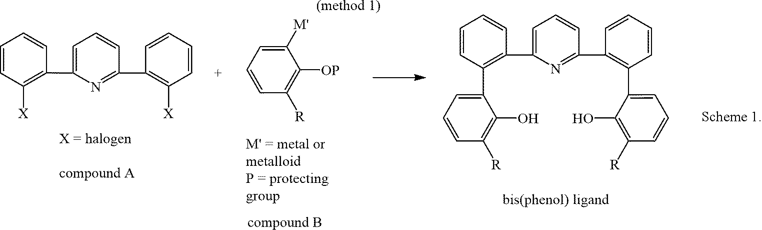

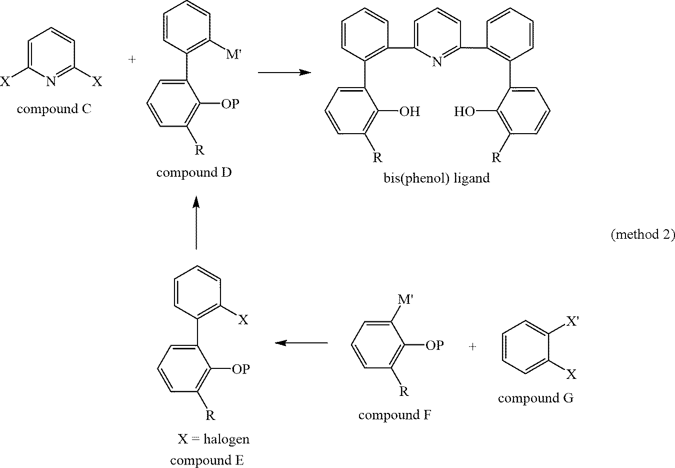

where M′ is a group 1, 2, 12, or 13 element or substituted element such as Li, MgCl, MgBr, ZnCl, B(OH)₂, B(pinacolate), P is a protective group such as methoxymethyl (MOM), tetrahydropyranyl (THP), t-butyl, allyl, ethoxymethyl, trialkylsilyl, t-butyldimethylsilyl, or benzyl, R is a C₁-C₄₀ alkyl, substituted alkyl, aryl, tertiary alkyl, cyclic tertiary alkyl, adamantanyl, or substituted adamantanyl and each X′ and X is halogen, such as Cl, Br, F or I.

It is preferred that the bis(phenol) ligand and intermediates used for the preparation of the bis(phenol) ligand are prepared and purified without the use of column chromatography. This may be accomplished by a variety of methods that include distillation, precipitation and washing, formation of insoluble salts (such as by reaction of a pyridine derivative with an organic acid), and liquid-liquid extraction. Preferred methods include those described in Practical Process Research and Development – A Guide for Organic Chemists by Neal C. Anderson (ISBN: 1493300125X).

### Synthesis of Carbene Bis(Phenol) Ligands

The general synthetic method to produce carbene bis(phenol) ligands is shown in Scheme 2. A substituted phenol can be ortho-brominated then protected by a known phenol protecting group, such as MOM, THP, t-butyldimethylsilyl (TBDMS), benzyl (Bn), etc. The bromide is then converted to a boronic ester (compound I) or boronic acid which can be used in a Suzuki coupling with bromoaniline. The biphenylaniline (compound J) can be bridged by reaction with dibromoethane or condensation with oxalaldehyde, then deprotected (compound K). Reaction with triethyl orthoformate forms an iminium salt that is deprotonated to a carbene.

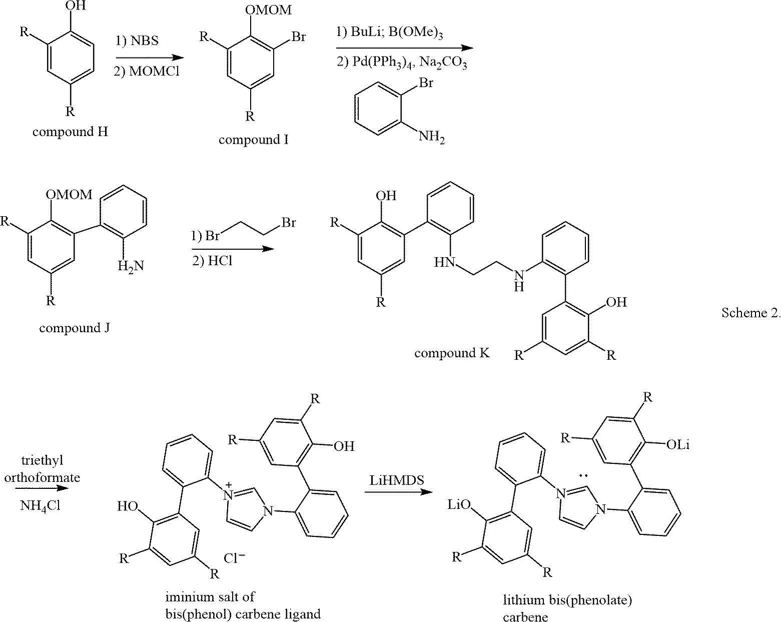

To the substituted phenol (compound H) dissolved in methylene chloride, is added an equivalent of N-bromosuccinimide and 0.1 equivalent of diisopropylamine. After stirring at ambient temperature until completion, the reaction is quenched with a 10% solution of HCl. The organic portion is washed with brine, dried over magnesium sulfate, filtered, and concentrated under reduced pressure to give a bromophenol, typically as a solid. The substituted bromophenol, methoxymethylchloride, and potassium carbonate are dissolved in dry acetone and stirred at ambient temperature until completion of the reaction. The solution is filtered and the filtrate concentrated to give protected phenol (compound I). Alternatively, the substituted bromophenol and an equivalent of dihydropyran is dissolved in methylene chloride and cooled to 0° C. A catalytic amount of para-toluenesulfonic acid is added and the reaction stirred for 10 min, then quenched with trimethylamine. The mixture is washed with water and brine, then dried over magnesium sulfate, filtered, and concentrated under reduced pressure to give a tetrahydropyran-protected phenol.

Aryl bromide (compound I) is dissolved in THF and cooled to -78° C. n-Butyllithium is added slowly, followed by trimethoxy borate. The reaction is allowed to stir at ambient temperature until completion. The solvent is removed and the solid boronic ester washed with pentane. A boronic acid can be made from the boronic ester by treatment with HCl. The boronic ester or acid is dissolved in toluene with an equivalent of ortho-bromoaniline and a catalytic amount of palladium tetrakistriphenylphosphine. An aqueous solution of sodium carbonated is added and the reaction heated at reflux overnight. Upon cooling, the layers are separated and the aqueous layer extracted with ethyl acetate. The combined organic portions are washed with brine, dried (MgSO4), filtered, and concentrated under reduced pressure. Column chromatography is typically used to purify the coupled product (compound J).

The aniline (compound J) and dibromoethane (0.5 equiv.) are dissolved in acetonitrile and heated at 60° C. overnight. The reaction is filtered and concentrated to give an ethylene bridged dianiline. The protected phenol is deprotected by reaction with HCl to give a bridged bisamino(biphenyl)ol (compound K).

The diamine (compound K) is dissolved in triethylorthoformate. Ammonium chloride is added and the reaction heated at reflux overnight. A precipitate is formed which is collected by filtration and washed with ether to give the iminium salt. The iminium chloride is suspended in THF and treated with lithium or sodium hexamethyldisilylamide. Upon completion, the reaction is filtered and the filtrate concentrated to give the carbene ligand.

### Preparation of Bis(Phenolate) Complexes

Transition metal or Lanthanide metal bis(phenolate) complexes are used as catalyst components for olefin polymerization in the present invention. The terms “catalyst” and “catalyst complex” are used interchangeably. The preparation of transition metal or Lanthanide metal bis(phenolate) complexes may be accomplished by reaction of the bis(phenol) ligand with a metal reactant containing anionic basic leaving groups. Typical anionic basic leaving groups include dialkylamido, benzyl, phenyl, hydrido, and methyl. In this reaction, the role of the basic leaving group is to deprotonate the bis(phenol) ligand. Suitable metal reactants for this type of reaction include, but are not limited to, HfBn₄ (Bn = CH₂Ph), ZrBn₄, TiBn₄, ZrBn₂Cl₂(OEt₂), HfBn₂Cl₂(OEt₂)₂, Zr(NMe₂)₂Cl₂(dimethoxyethane), Hf(NMe₂)₂Cl₂(dimethoxyethane), Hf(NMe₂)₄, Zr(NMe₂)₄, and Hf(NEt₂)₄. Suitable metal reagents also include ZrMe₄, HfMe₄, and other group 4 alkyls that may be formed in situ and used without isolation.

A second method for the preparation of transition metal or Lanthanide bis(phenolate) complexes is by reaction of the bis(phenol) ligand with an alkali metal or alkaline earth metal base (e.g., Na, BuLi, ⁱPrMgBr) to generate deprotonated ligand, followed by reaction with a metal halide (e.g., HfCl₄, ZrCl₄) to form a bis(phenolate) complex. Bis(phenolate) metal complexes that contain metal-halide, alkoxide, or amido leaving groups may be alkylated by reaction with organolithium, Grignard, and organoaluminum reagents. In the alkylation reaction the alkyl groups are transferred to the bis(phenolate) metal center and the leaving groups are removed. Reagents typically used for the alkylation reaction include, but are not limited to, MeLi, MeMgBr, AlMe₃, Al(ⁱBu)₃, AlOct₃, and PhCH2MgCl. Typically 2 to 20 molar equivalents of the alkylating reagent are added to the bis(phenolate) complex. The alkylations are generally performed in ethereal or hydrocarbon solvents or solvent mixtures at temperatures typically ranging from -80° C. to 120° C.

### Activators

The terms “cocatalyst” and “activator” are used herein interchangeably.

The catalyst systems described herein typically comprises a catalyst complex, such as the transition metal or Lanthanide bis(phenolate) complexes described above, and an activator such as alumoxane or a non-coordinating anion. These catalyst systems may be formed by combining the catalyst components described herein with activators in any manner known from the literature. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, include alumoxanes, ionizing activators, which may be neutral or ionic, and conventional-type cocatalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators are utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in US 9,340,630; US 8,404,880; and US 8,975,209.

When the activator is an alumoxane (modified or unmodified), typically the maximum amount of activator is at up to a 5000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator is represented by the Formula (III):

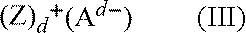

wherein Z is (L-H) or a reducible Lewis Acid, L is an neutral Lewis base; H is hydrogen; (L-H)⁺ is a Bronsted acid; A^{d-} is a non-coordinating anion having the charge d-; and d is an integer from 1 to 3 (such as 1, 2 or 3), preferably Z is (Ar₃C⁺), where Ar is aryl or aryl substituted with a heteroatom, a C₁ to C₄₀ hydrocarbyl, or a substituted C₁ to C₄₀ hydrocarbyl. The anion component A^{d-} includes those having the formula [M^{k+}Qₙ]^{d-} wherein k is 1, 2, or 3; n is 1, 2, 3, 4, 5, or 6 (preferably 1, 2, 3, or 4); n - k = d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 20) carbon atoms, more preferably each Q is a fluorinated aryl group, such as a perfluorinated aryl group and most preferably each Q is a pentafluoro aryl group or perfluoronaphthalenyl group. Examples of suitable A^{d-} also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof.

In particularly useful embodiments of the invention, the activator is soluble in non-aromatic-hydrocarbon solvents, such as aliphatic solvents.

In one or more embodiments, a 20 wt% mixture of the activator compound in n-hexane, isohexane, cyclohexane, methylcyclohexane, or a combination thereof, forms a clear homogeneous solution at 25° C., preferably a 30 wt% mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon soluble activator compound.

Non-aromatic-hydrocarbon soluble activator compounds useful herein include those represented by the Formula (V):

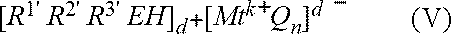

wherein:
E is nitrogen or phosphorous;
d is 1, 2 or 3; k is 1, 2, or 3; n is 1, 2, 3, 4, 5, or 6; n - k = d (preferably d is 1, 2 or 3; k is 3; n is 4, 5, or 6);
R^{1′}, R^{2′}, and R^{3′} are independently a C₁ to C₅₀ hydrocarbyl group optionally substituted with one or more alkoxy groups, silyl groups, a halogen atoms, or halogen containing groups,
wherein R^{1′}, R^{2′}, and R^{3′} together comprise 15 or more carbon atoms;
Mt is an element selected from group 13 of the Periodic Table of the Elements, such as B or Al; and
each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VI):

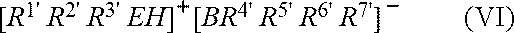

wherein: E is nitrogen or phosphorous; R^{1′} is a methyl group; R^{2′} and R^{3′} are independently is C₄-C₅₀ hydrocarbyl group optionally substituted with one or more alkoxy groups, silyl groups, a halogen atoms, or halogen containing groups wherein R^{2′} and R^{3′} together comprise 14 or more carbon atoms; B is boron; and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VII) or Formula (VIII):

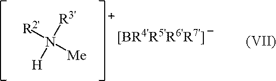

and

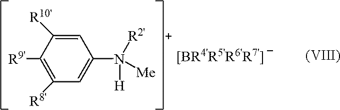

wherein:
N is nitrogen;
R^{2′} and R^{3′} are independently is C₆-C₄₀ hydrocarbyl group optionally substituted with one or more alkoxy groups, silyl groups, a halogen atoms, or halogen containing groups wherein R^{2′} and R^{3′} (if present) together comprise 14 or more carbon atoms;
R^{8′}, R^{9′}, and R^{10′} are independently a C₄-C₃₀ hydrocarbyl or substituted C₄-C₃₀ hydrocarbyl group;
B is boron;
and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Optionally, in any of Formulas (V), (VI), (VII), or (VIII) herein, R^{4′}, R^{5′}, R^{6′}, and R^{7′} are pentafluorophenyl.

Optionally, in any of Formulas (V), (VI), (VII), or (VIII) herein, R^{4′}, R^{5′}, R^{6′}, and R^{7′} are pentafluoronaphthalenyl.

Optionally, in any embodiment of Formula (VIII) herein, R^{8′} and R^{10′} are hydrogen atoms and R^{9′} is a C₄-C₃₀ hydrocarbyl group which is optionally substituted with one or more alkoxy groups, silyl groups, a halogen atoms, or halogen containing groups.

Optionally, in any embodiment of Formula (VIII) herein, R^{9′} is a C₈-C₂₂ hydrocarbyl group which is optionally substituted with one or more alkoxy groups, silyl groups, a halogen atoms, or halogen containing groups.

Optionally, in any embodiment of Formula (VII) or (VIII) herein, R^{2′} and R^{3′} are independently a C₁₂-C₂₂ hydrocarbyl group.

Optionally, R^{1′}, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9′}, and R^{10′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q is a fluorophenyl group, then R^{2′} is not a C₁-C₄₀ linear alkyl group (alternately R^{2′} is not an optionally substituted C₁-C₄₀ linear alkyl group).

Optionally, each of R⁴, R^{5′}, R^{6′}, and R^{7′} is an aryl group (such as phenyl or naphthalenyl), wherein at least one of R^{4′}, R^{5′}, R^{6′}, and R^{7′} is substituted with at least one fluorine atom, preferably each of R^{4′}, R^{5′}, 7^{6′}, and R^{7′} is a perfluoroaryl group (such as perfluorophenyl or perfluoronaphthalenyl).

Optionally, each Q is an aryl group (such as phenyl or naphthalenyl), wherein at least one Q is substituted with at least one fluorine atom, preferably each Q is a perfluoroaryl group (such as perfluorophenyl or perfluoronaphthalenyl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalenyl) group, and most preferably each Q is a perflourinated aryl (such as phenyl or naphthalenyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

In some embodiments of the invention, R^{1′} is not methyl, R^{2′} is not C₁₈ alkyl and R^{3′} is not C₁₈ alkyl, alternately R^{1′} is not methyl, R^{2′} is not C₁₈ alkyl and R^{3′} is not C₁₈ alkyl and at least one Q is not substituted phenyl, optionally all Q are not substituted phenyl.

Useful cation components in Formulas (III) and (V) to (VIII) include those represented by the formula:

| | | | | | |
|---|---|---|---|---|---|
| 10 | 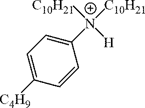 | 11 | 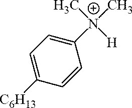 | 12 | 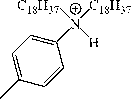 |
| 13 | 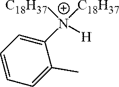 | 14 | 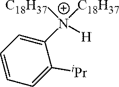 | 15 | 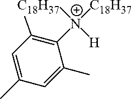 |
| 16 | 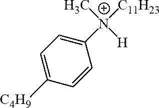 | 17 | 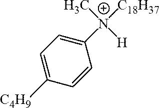 | 18 | 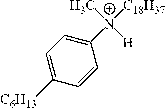 |
| 19 | 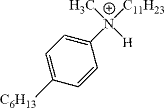 | 20 | 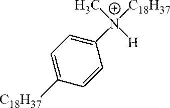 | 21 | 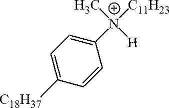 |
| 22 | 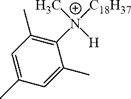 | 23 | 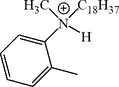 | 24 | 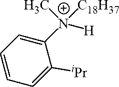 |
| 25 | 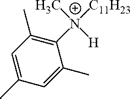 | 26 | 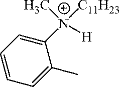 | 27 | 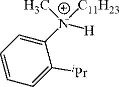 |
| 29 | 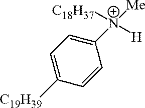 | 28 | 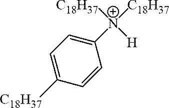 | 30 | 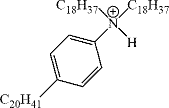 |
| 31 | 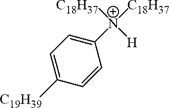 | 32 | 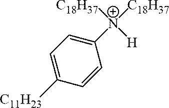 | 33 | 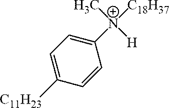 |
| 34 | 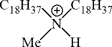 | 35 | 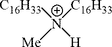 | 36 | 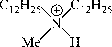 |

Useful cation components in Formulas (III) and (V) to (VIII) include those represented by the formulas:

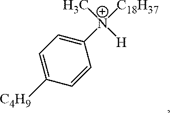

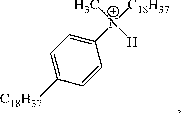

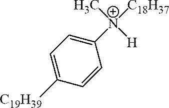

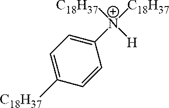

and

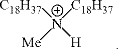

The anion component of the activators described herein includes those represented by the formula [Mt^{k+}Qₙ]⁻ wherein k is 1, 2, or 3; n is 1, 2, 3, 4, 5, or 6 (preferably 1, 2, 3, or 4), (preferably k is 3; n is 4, 5, or 6, preferably when M is B, n is 4); Mt is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group, optionally having 1 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

In one embodiment, the borate activator comprises tetrakis(heptafluoronaphth-2-yl)borate.

In one embodiment, the borate activator comprises tetrakis(pentafluorophenyl)borate.

Anions for use in the non-coordinating anion activators described herein also include those represented by Formula 7, below:

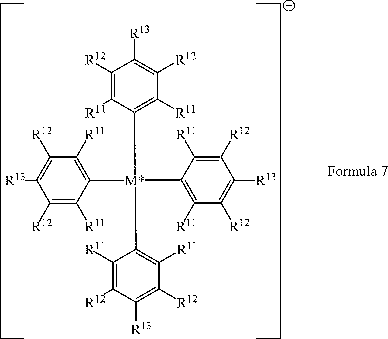

wherein:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula —O—Si—Rₐ, where R^{a} is a C₁ to C₂₀ hydrocarbyl or hydrocarbylsilyl group, preferably R¹³ is a fluoride or a C₆ perfluorinated aromatic hydrocarbyl group;
wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple “Back of the Envelope″ Method for Estimating the Densities and Molecular Volumes of Liquids and Solids,” Journal of Chemical Education, Vol. 71, No. 11, November 1994, pp. 962-964. Molecular volume (MV), in units of cubic Å, is calculated using the formula: MV = 8.3 V_{S}, where V_{S} is the scaled volume. V_{S} is the sum of the relative volumes of the constituent atoms, and is calculated from the molecular formula of the substituent using Table A below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE B

| Ion | Structure of Boron Substituents | Molecular Formula of Each Substituent | V_{S} | MV Per subst. (Å3) | Calculated Total MV (Å3) |
|---|---|---|---|---|---|
| tetrakis(perfluorophenyl)borate | 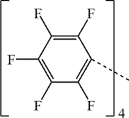 | C₆F₅ | 22 | 183 | 732 |
| tris(perfluorophenyl)-(perfluoronaphthalenyl)borate | 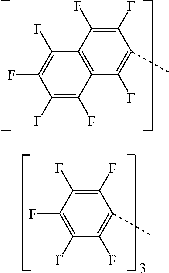 | C₆F₅ C₁₀F₇ | 22 34 | 183 261 | 810 |
| (perfluorophenyl)tris-(perfluoronaphthalenyl)borate | 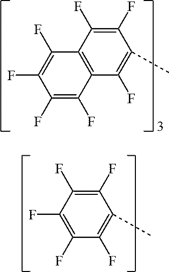 | C₆F₅ C₁₀F₇ | 22 34 | 183 261 | 966 |
| tetrakis(perfluoronaphthalenyl)borate | 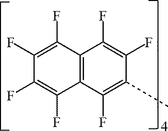 | C₁₀F₇ | 34 | 261 | 1044 |
| tetrakis(perfluorobiphenyl)borate | 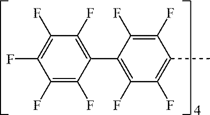 | C₁₂F₉ | 42 | 349 | 1396 |
| [(C₆F(C₆F₅)₂)₄B] | 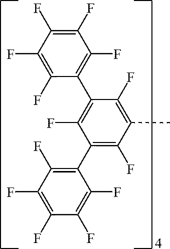 | C₁₈F₁₃ | 62 | 515 | 2060 |

The activators may be added to a polymerization in the form of an ion pair using, for example, [M2HTH]+ [NCA]- in which the di(hydrogenated tallow)methylamine (“M2HTH”) cation reacts with a basic leaving group on the transition metal complex to form a transition metal complex cation and [NCA]-. Alternatively, the transition metal complex may be reacted with a neutral NCA precursor, such as B(C₆F₅)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium [tetrakis(pentafluorophenyl)borate] (i.e., [DOdTH]B(C₆F₅)₄).

Activator compounds that are particularly useful in this invention include one or more of:
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Additional useful activators and the synthesis non-aromatic-hydrocarbon soluble activators, are described in USSN 16/394,166 filed Apr. 25, 2019, USSN 16/394,186, filed Apr. 25, 2019, and USSN 16/394,197, filed Apr. 25, 2019, which are incorporated by reference herein.

Likewise, particularly useful activators also include dimethylaniliniumtetrakis (pentafluorophenyl) borate and dimethyl anilinium tetrakis(heptafluoro-2-naphthalenyl) borate. For a more detailed description of useful activators please see WO 2004/026921 page 72, paragraph [00119] to page 81 paragraph [00151]. A list of additionally particularly useful activators that can be used in the practice of this invention may be found at page 72, paragraph [00177] to page 74, paragraph [00178] of WO 2004/046214.

For descriptions of useful activators please see US 8,658,556 and US 6,211,105.

Preferred activators for use herein also include N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalenyl)borate, N,N-dimethylanilinium tetrakis(perfluoronaphthalenyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthalenyl)borate, N,N-dialkylanilinium tetrakis(perfluoronaphthalenyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA’s (see for example, US 5,153,157; US 5,453,410; EP 0 573 120 B1; WO 1994/007928; and WO 1995/014044 (the disclosures of which are incorporated herein by reference in their entirety) which discuss the use of an alumoxane in combination with an ionizing activator).

### Optional Scavengers, Co-Activators, Chain Transfer Agents

In addition to activator compounds, scavengers or co-activators may be used. A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Co-activators can include alumoxanes such as methylalumoxane, modified alumoxanes such as modified methylalumoxane, and aluminum alkyls such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors.

Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and dialkyl zinc, such as diethyl zinc.

Chain transfer agents may be used in the compositions and or processes described herein. Useful chain transfer agents are typically hydrogen, alkylalumoxanes, a compound represented by the formula AlR₃, ZnR₂ (where each R is, independently, a C₁-C₈ aliphatic radical, preferably methyl, ethyl, propyl, butyl, pentyl, hexyl octyl or an isomer thereof) or a combination thereof, such as diethyl zinc, trimethylaluminum, triisobutylaluminum, trioctylaluminum, or a combination thereof.

### Polymerization Processes

Solution polymerization processes may be used to carry out the polymerization reactions disclosed herein in any suitable manner known to one having ordinary skill in the art. In particular embodiments, the polymerization processes may be carried out in continuous polymerization processes. The term “batch” refers to processes in which the complete reaction mixture is withdrawn from the polymerization reactor vessel at the conclusion of the polymerization reaction. In contrast, in a continuous polymerization process, one or more reactants are introduced continuously to the reactor vessel and a solution comprising the polymer product is withdrawn concurrently or near concurrently. A solution polymerization means a polymerization process in which the polymer produced is soluble in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in J. Vladimir Oliveira, C. Dariva and J. C. Pinto, Ind. Eng. Chem. Res. v.29, 2000, pg. 4627.

In a typical solution process, catalyst components, solvent, monomers and hydrogen (when used) are fed under pressure to one or more reactors. Temperature control in the reactor can generally be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The monomers are dissolved/dispersed in the solvent either prior to being fed to the first reactor or dissolve in the reaction mixture. The solvent and monomers are generally purified to remove potential catalyst poisons prior entering the reactor. The feedstock may be heated or cooled prior to feeding to the first reactor. Additional monomers and solvent may be added to the second reactor, and it may be heated or cooled. The catalysts/activators can be fed in the first reactor or split between two reactors. In solution polymerization, polymer produced is molten and remains dissolved in the solvent under reactor conditions, forming a polymer solution (also referred as to effluent).

The solution polymerization process of this invention uses stirred tank reactor system comprising one or more stirred polymerization reactors. Generally the reactors should be operated under conditions to achieve a thorough mixing of the reactants. In a multiple reactor system, the first polymerization reactor preferably operates at lower temperature. The residence time in each reactor will depend on the design and the capacity of the reactor. The catalysts/activators can be fed into the first reactor only or split between two reactors. In an alternative embodiment, a loop reactor and plug flow reactors are can be employed for current invention.

The polymer solution is then discharged from the reactor as an effluent stream and the polymerization reaction is quenched, typically with coordinating polar compounds, to prevent further polymerization. On leaving the reactor system the polymer solution is passed through a heat exchanger system on route to a devolatilization system and polymer finishing process. The lean phase and volatiles removed downstream of the liquid phase separation can be recycled to be part of the polymerization feed.

A polymer can be recovered from the effluent of either reactor or the combined effluent, by separating the polymer from other constituents of the effluent. Conventional separation means may be employed. For example, polymer can be recovered from effluent by coagulation with a non-solvent such as isopropyl alcohol, acetone, or n-butyl alcohol, or the polymer can be recovered by heat and vacuum stripping the solvent or other media with heat or steam. One or more conventional additives such as antioxidants can be incorporated in the polymer during the recovery procedure. Other methods of recovery such as by the use of lower critical solution temperature (LCST) followed by devolatilization are also envisioned.

Suitable diluents/solvents for conducting the polymerization reaction include non-coordinating, inert liquids. In particular embodiments, the reaction mixture for the solution polymerization reactions disclosed herein may include at least one hydrocarbon solvent. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); halogenated and perhalogenated hydrocarbons, such as perfluorinated C₄ to C₁₀ alkanes, chlorobenzene, and mixtures thereof; and aromatic and alkyl-substituted aromatic compounds, such as benzene, toluene, mesitylene, ethylbenzene, xylene, and mixtures thereof. Mixtures of any of the foregoing hydrocarbon solvents may also be used. Suitable solvents also include liquid olefins which may act as monomers or co-monomers including ethylene, propylene, 1-butene, 1-hexene, 1-pentene, 3-methyl-1-pentene, 4-methyl-1-pentene, 1-octene, 1-decene, and mixtures thereof. In another embodiment, the solvent is not aromatic, preferably aromatics are present in the solvent at less than 1 wt%, preferably less than 0.5 wt%, preferably less than 0 wt% based upon the weight of the solvents.

Any olefinic feed can be polymerized using polymerization methods and solution polymerization conditions disclosed herein. Suitable olefinic feeds may include any C₂-C₄₀ alkene, which may be straight chain or branched, cyclic or acyclic, and terminal or non-terminal, optionally containing heteroatom substitution. In more specific embodiments, the olefinic feed may comprise a C₂-C₂₀ alkene, particularly linear alpha olefins, such as, for example, ethene, propene, 1-butene, 1-pentene, 1-hexene, 1-octene, 1-decene, or 1-dodecene. Other suitable olefinic monomers may include ethylenically unsaturated monomers, diolefins having 4 to 18 carbon atoms, conjugated or nonconjugated dienes, polyenes, vinyl monomers and cyclic olefins. Non-limiting olefinic monomers may also include norbornene, norbornadiene, isobutylene, isoprene, vinylbenzocyclobutane, styrene, alkyl substituted styrene, ethylidene norbornene, dicyclopentadiene, cyclopentene, and cyclohexene. Any single olefinic monomer or any mixture of olefinic monomers may undergo polymerization according to the disclosure herein.

Preferred diolefin monomers useful in this invention include any hydrocarbon structure, preferably C₅ to C₃₀, having at least two unsaturated bonds wherein at least two unsaturated bonds that can readily be incorporated into polymers to form cross-linked polymers. Examples of such polyenes include alpha,omega-dienes (such as butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, and 1,13-tetradecadiene) and certain multi-ring alicyclic fused and bridged ring dienes (such as tetrahydroindene; divinylbenzene, norbornadiene; methyl-tetrahydroindene; dicyclopentadiene; bicyclo-(2.2.1)-hepta-2,5-diene; and alkenyl-, alkylidene-, cycloalkenyl-, and cylcoalkyliene norbornenes [including, e.g., 5-methylene-2-norbornene, 5-ethylidene-2-norbornene, 5-propentyl-2-norbornene, 5-isopropylidene-2-norbornene, 5-(4-cyclopentenyl)-2-norbomene, 5-cyclohexylidene-2-norbornene, and 5-vinyl-2-norbornene]).

Alternately, diene is absent from the copolymers produced herein.

Preferred polymerizations can be run at any temperature and/or pressure suitable to obtain the desired polymers. Solution polymerization conditions suitable for use in the polymerization processes disclosed herein include temperatures ranging from about 0° C. to about 300° C., or from about 50° C. to about 250° C., or from about 70° C. to about 200° C., or from about 90° C. to about 180° C., or from about 90° C. to about 140° C., or from about 120° C. to about 140° C. Pressures may range from about 0.1 MPa to about 15 MPa, or from about 0.2 MPa to about 12 MPa, or from about 0.5 MPa to about 10 MPa, or from about 1 MPa to about 7 MPa. Polymerization run times (residence time) may range up to about 300 minutes, particularly in a range from about 5 minutes to about 250 minutes, or from about 10 minutes to about 120 minutes.

Small amounts of hydrogen, for example 1-5000 parts per million (ppm) by weight, based on the total solution fed to the reactor may be added to one or more of the feed streams of the reactor system in order to improve control of the melt index and/or molecular weight distribution. In some embodiments, hydrogen may be included in the reactor vessel in the solution polymerization processes. According to various embodiments, the concentration of hydrogen gas in the reaction mixture may range up to about 5000 ppm, or up to about 4000 ppm, or up to about 3000 ppm, or up to about 2000 ppm, or up to about 1000 ppm, or up to about 500 ppm, or up to about 400 ppm, or up to about 300 ppm, or up to about 200 ppm, or up to about 100 ppm, or up to about 50 ppm, or up to about 10 ppm, or up to about 1 ppm. In some or other embodiments, hydrogen gas may be present in the reactor vessel at a partial pressure of about 0.007 to 345 kPa, or about 0.07 to 172 kPa, or about 0.7 to 70 kPa. In some embodiments, the process will exclude the addition of hydrogen.

In a preferred embodiment, the polymerization: 1) is conducted at temperatures of 100° C. or higher (preferably 120° C. or higher, preferably 140° C. or higher); 2) is conducted at a pressure of atmospheric pressure to 18 MPa (preferably from 0.35 to 18 MPa, preferably from 0.35 to 10 MPa, preferably from 0.45 to 6 MPa, preferably from 0.5 to 4 MPa); 3) is conducted in an aliphatic hydrocarbon solvent (such as, isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics (such as toluene) are preferably present in the solvent at less than 1 wt%, preferably less than 0.5 wt%, preferably less than 0.1 wt%, preferably at 0 wt% based upon the weight of the solvents); 4) ethylene is present in the polymerization reactor at a concentration of 6 mole/liter or less); 5) the polymerization preferably occurs in one reaction zone; 6) the productivity of the catalyst compound is 50,000 kg of polymer per kg of catalyst or more (preferably 100,000 kg of polymer per kg of catalyst or more, such as 150,000 kg of polymer per kg of catalyst or more, such as 200,000 kg of polymer per kg of catalyst or more).

In more particular embodiments, the one or more olefinic monomers present in the reaction mixtures disclosed herein comprise at least ethylene and one alpha olefin such as butene, hexene and octene. In still more specific embodiments, the one or more olefinic monomers may comprise ethylene and C₄ to C₈ alpha olefin. In still more specific embodiments, the one or more olefinic monomers may comprise ethylene and a mixture of alpha olefins.

The molecular weight distribution of the polymer made by a solution process can be advantageously controlled by preparing the polymers in multiple reactors which are operated under different conditions, most frequently at different temperatures and/or monomer concentration. These conditions determine the molecular weight and density of the polymer fractions that are produced. The relative amounts of the different fractions is controlled by adjusting the process condition in each of the reactors. The process condition typically used include the catalyst type and concentration in each reactor, and the reactor residence time. In one embodiment, the polymerization process include at least two reactors connected either in series and parallel configuration.

In embodiments herein, the invention relates to polymerization processes where monomers (such as ethylene), and optionally comonomer, are contacted with a catalyst system comprising an activator and at least one catalyst compound, as described above. The catalyst compound and activator may be combined in any order, and are combined typically prior to contacting with the monomers.. In one embodiment, the catalyst and the activator can be fed into the polymerization reactor in form of dry powder or slurry without the need of preparing a homogenous catalyst solution by dissolving the catalyst into a carrying solvent.

Polymerization processes of this invention can be carried out in any manner known in the art. Any suspension, homogeneous, bulk, solution, slurry, or gas phase polymerization process known in the art can be used. Such processes can be run in a batch, semi-batch, or continuous mode. Homogeneous polymerization processes are preferred. (A homogeneous polymerization process is preferably a process where at least 90 wt% of the product is soluble in the reaction media.) In useful embodiments the process is a solution process.

A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. In one embodiment, multiple reactors are used in the polymerization processes.

Other additives may also be used in the polymerization, as desired, such as one or more scavengers, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, preferably methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof).

The process of the present invention may be used to prepare homopolymers of ethylene and copolymers of ethylene and alpha-olefins having densities in the range of, for example, about 0.900-0.970 g/cm³ and especially 0.915-0.965 g/cm³. Such polymers may have a melt index, as measured by the method of ASTM D-1238, in the range of, for example, about 0.1-200, and especially in the range of about 0.5-120 dg/min. The polymers may be manufactured with narrow or broad molecular weight distribution. For example, the polymers may have a MWD in the range of about 1.5-10 and especially in the range of about 2 to 7. The process of the invention is believed to be particularly useful in the manufacture of narrow molecular distribution polymers.

The process of the present invention may be used to prepare homopolymers of ethylene and copolymers of ethylene and alpha-olefins having densities in the range of, for example, about 0.84-0.970 g/cm³ and especially 0.88-0.965 g/cm³. Such polymers may have a melt index, as measured by the method of ASTM D-1238, of 0.1 or less, and in the range of about 0.5-120 dg/min.

### Polyolefin Products

This invention also relates to compositions of matter produced by the methods described herein. The processes described herein may be used to produce polymers of olefins or mixtures of olefins. Polymers that may be prepared include copolymers of ethylene and C₃-C₂₀ olefins, and terpolymers of ethylene and C₃-C₂₀ olefins.

Preferably, diene is absent from the polyethylene compositions, such as ethylene copolymers, produced herein.

In a preferred embodiment, the process described herein produces polyethylene compositions, such as ethylene-alpha olefin (preferably C₃ to C₂₀) copolymers (such as ethylene-hexene copolymers or ethylene-octene copolymers) having a Mw of 50,000 g/mol or more, preferably 100,000 g/mol or more, more preferably 150,000 g/mol or more, and a Mw/Mn of between 1 to 20 (preferably 2-15, preferably 2-10, preferably 2-8).

In a preferred embodiment the polymer produced herein has a unimodal or multimodal molecular weight distribution as determined by Gel Permeation Chromatography (GPC). By “unimodal” is meant that the GPC chromatograph has one peak or inflection point. By “multimodal” is meant that the GPC chromatograph has at least two peaks or inflection points. An inflection point is that point where the second derivative of the curve changes in sign (e.g., from negative to positive or vice versus).

In an embodiment, the polymers produced herein are copolymers of ethylene having from 0 to 70 mol% (alternately from 0 to 65 mol%, alternately from 0.5 to 50 mol%, alternately from 1 to 25 mol%, alternatively from 20 to 40 mol%, alternatively from 0.1 to 10 mol%, alternatively from 0.1 to 65 mol%, preferably from 3 to 15 mole%) of one or more C₃ to C₂₀ olefin comonomer (preferably C₃ to C₁₂ alpha-olefin, preferably propylene, butene, hexene, octene, decene, dodecene, more preferably, butene, hexene, octene).

In an embodiment, the polymers produced herein are copolymers of ethylene with one or more C₃ to C₂₀ olefin comonomer, with the polymer having a composition of over 35 mol% (alternately from 35.1 to 99.9 mol%, alternately from 50 to 85 mol%, alternatively from 60 to 80 mol%, alternatively from 60 to 99.9 mol%, alternatively from 50 to 99.9 mol%, preferably from 60 to 99 mol%) ethylene. The mol% of monomer A in a copolymer of monomers A and B is equal to ((100)(moles of monomer A))/((moles of monomer A)+(moles of monomer B)). The mol% of monomer A in a terpolymer of monomers A, B, and C is equal to ((100)(moles of monomer A))/((moles of monomer A)+(moles of monomer B)+(moles of monomer C)). The mol% of monomer A in a tetrapolymer of monomers A, B, C, and D is equal to ((100)(moles of monomer A))/((moles of monomer A)+(moles of monomer B)+(moles of monomer C)+(moles of monomer D)).

In a preferred embodiment, the polymers produced herein are copolymers of ethylene preferably having from 0 to 25 mol% (alternately from 0.5 to 20 mol%, alternately from 1 to 15 mol%, preferably from 3 to 15 mol%) of one or more C₃ to C₂₀ olefin comonomer (preferably C₃ to C₁₂ alpha-olefin, preferably propylene, butene, hexene, octene, decene, dodecene, more preferably, butene, hexene, octene).

Preferably the copolymers produced herein are copolymers of ethylene and from 5 to 35 wt% (alternately from 10 to 32 wt%, alternately from 11 to 25 wt%) of one, two, three, four or more of propylene, butene, hexene, octene, decene, dodecene, preferably ethylene, butene, hexene, and octene.

In a preferred embodiment, the monomer is ethylene and the comonomer is hexene, preferably from 1 to 20 mol% hexene, alternately 1 to 15 mol%.

In one embodiment, the polyethylene composition has non-uniform comonomer distribution across the molecular weight. Preferably, the comonomer content is higher at the lower molecular side and is lower the higher molecular side. Composition distribution across the range of molecular weight can be determined using size exclusion chromatography as described below.

In one embodiment, the polyethylene composition is homopolymers of ethylene and copolymers of ethylene and alpha-olefins having densities in the range of, for example, about 0.900-0.970 g/cm³ and especially 0.915-0.965 g/cm³. Such polymers may have a melt index, as measured by the method of ASTM D-1238, in the range of, for example, about 0.1-200, and especially in the range of about 0.5-120 dg/min. The polymers may be manufactured with narrow or broad molecular weight distribution. For example, the polymers may have a MWD in the range of about 1.5-10 and especially in the range of about 2 to 7.

In one embodiment, the polyethylene composition preferably has a density within the range of from 0.850 or 0.870 g/cm³ to 0.900 or 0.910 g/cm³.

The properties of the polyethylene composition can vary depending on the exact process used to make it, but preferably the polyethylene composition has the following measurable features. Certain GPC measurable features include the following: The weight average molecular weight (Mw) is preferably within a range of from 50,000 or 60,000 or 80,000 g/mol to 150,000 or 180,000 or 250,000 or 300,000 or 400,000 or 500,000 g/mol. The number average molecular weight (Mn) is preferably within a range of from 10,000 or 15,000 or 20,000 g/mol to 30,000 or 50,000 or 100,000 or 150,000 or 200,000 g/mol. The z-average molecular weight (Mz) is preferably greater than 200,000 or 300,000 or 400,000 or 500,000 g/mol, and more preferably within a range of from 150,000 or 200,000 or 300,000 g/mol to 500,000 or 600,000 or 800,000 or 1,000,000 or 1,500,000 or 2,000,000 g/mol. The polyethylene composition has a molecular weight distribution (Mw/Mn) within the range of from 2.0 or 2.5 to 7.0 or 8.0 or 10.0 or 12.0.

Certain DSC measurable properties include the following: The polyethylene composition preferably has a melting point temperature (Tₘ) within the range of from 10 or 20 or 30 or 40 or 50 or 60 or 70 or 80 or 90 or 100 or 110 or 115° C. to 125 or 130 or 135° C. The polyethylene composition also preferably has a crystallization temperature (T_{c}) within the range of from 5 or 10, or 20 or 30 or 40 or 50 or 60 or 70 or 80 or 85 or 90° C. to 110 or 115 or 120 or 125° C. The polyethylene composition also preferably has a heat of fusion (H_{f}) within the range of from 10 or 20 or 30 or 40 or 50 or 60 or 75 or 80 J/g to 90 or 120 or 200 or 250 or 300 J/g. Alternately the polyethylene composition preferably has a melting point temperature (Tₘ) of 50° C. or more, alternately 60° C. or more, alternately 70° C. or more, alternately 80° C. or more, alternately 90° C. or more, alternately 95° C. or more, alternately or 100° C. or more. Alternately the polyethylene composition preferably has a melting point temperature (Tₘ) of 50° C. to 140° C., alternately 60° C. to 135° C., alternately 70° C. to 130° C., alternately 80° C. to 120° C.

The polymer produced herein can have a melt index (I2, ASTM 1238, 2.16 kg, 190° C.) from a low of about 0.1 dg/min, about 0.2 dg/min, about 0.5 dg/min, about 1 dg/min, about 15 dg/min, about 30 dg/min, or about 45 dg/min to a high of about 200 dg/min, about 300 dg/min, about 500 dg/min, or about 1500 dg/min.

Certain melt flow properties of the polyethylene composition include the following: The polyethylene composition preferably has a melt index (190° C./2.16 kg, “I₂”) of 400 g/10 min or less, 300 g/10 min or less, 200 g/10 min or less or 100 g/10 min or less, or more preferably within the range of from 0.10 or 0.20 or 0.30 or 0.80 or 1.0 g/10 min to 40 or 80 or 120 or 200 g/10 min. The polyethylene composition has a wide range of high load melt index (I₂₁), but preferably has a high load melt index (190° C./2.16 kg, “I₂₁”) of 200 g/10 min or less, or 100 g/10 min or less, or 50 g/10 min or less. The polyethylene composition has a melt index ratio (I₂₁/I₂) within a range of from 10 or 20 or 30 to 70 or 75 or 80 or 85 or 90.

Certain dynamic properties of the polyethylene composition include the following: The polyethylene composition preferably has a complex viscosity at a frequency of 0.1 rad/sec and a temperature of 190° C. within the range of from 20,000, or 50,000, or 100,000 or 150,000 Pa·s to 300,000 or 350,000 or 400,000 or 450,000 or 1,000,000 Pa·s. The polyethylene composition preferably has a complex viscosity at a frequency of 128 rad/sec and a temperature of 190° C. within the range of from 200 or 500 Pa·s to 5,000 or 8,000 or 10,000 or 15,000 Pa·s. Also, the polyethylene composition preferably has a phase angle at the complex modulus of 500,000 Pa within the range of 10° to 60°, or from 10° to 50°, or from 10° to 40°, or from 20° to 31°, or from 15° to 40°, or from 20° to 60°, or from 15° to 36° (alternately from 10 or 15 or 20 or 25° to 45 or 50 or 55 or 60°) when the complex shear rheology is measured at a temperature of 190° C.

The polyethylene composition has long chain branch architecture and the level of branching is measured by the branching index (g′ᵥᵢₛ) using GPC(as described below). Thus, a lower value for g′ᵥᵢₛ indicates higher level of branching. The value for g′ᵥᵢₛ is preferably less than 0.98 or 0.95 or 0.92 or 0.90 or 0.88, or within a range of from 0.60 or 0.70 to 0.90 or 0.95 or 0.97, such as from 0.60 to 0.90, or 0.70 to 0.90, or 0.80 to 0.90, or 0.81 to 0.87, or 0.70 to 0.95. A polyethylene is “linear” when the polyethylene has no long chain branches, typically having a g′ᵥᵢₛ of 0.98 or above.

Shear thinning is observed for the polyethylene compositions and is a characteristic used to describe the polyethylene composition. Shear thinning is one of the characteristics of branched polymer due to chain entanglement and long relaxation time. Shear thinning is also used as a measure of level of branching. Melt index ratio, or I₂₁/I₂, and shear thinning ratio (defined as a ratio of the complex shear viscosity at a frequency of 0.245 rad/s to that at a frequency of 128 rad/s) are characteristics used to describe the inventive polyethylene compositions. Preferred values for shear thinning ratio are greater than 30 or 40 or 50 or 60 or 70 or 80 or 100, while preferred values for I₂₁/I₂ are greater than 10 or 20 or 30. More preferred values for shear thinning ratio are from 50 to 200, or 60 to 180, or 70 to 160, or 75 to 150. More particularly, the shear thinning ratio is within the range of from 5 or 10 or 20 to 40 or 50 or 60 or 70 or 100 or 200 or 300, and the I₂₁/I₂ is within the range of from 20 or 30 or 40 to 100 or 200 or 250 or 300 or 400. Notice that some I₂ values are too low to be measured for some of desirable materials, in which case I₂₁/I₂ is very high or not recorded.

Alternately, the shear thinning ratio (e.g., the ratio of complex viscosity at a frequency of 0.245 rad/s to the complex viscosity at a frequency of 128 rad/s) of the polyethylene composition is 30 or more, more preferably 40 or more, even more preferably 50 or more when the complex viscosity is measured using RPA according to the procedure described in the Test methods section below.

### Blends

In another embodiment, the polyethylene compositions produced herein is combined with one or more additional polymers prior to being formed into a film, molded part or other article. Other useful polymers include polyethylene, polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polymer produced herein is present in the above blends, at from 10 to 99 wt%, based upon the weight of the polymers in the blend, preferably 20 to 95 wt%, even more preferably at least 30 to 90 wt%, even more preferably at least 40 to 90 wt%, even more preferably at least 50 to 90 wt%, even more preferably at least 60 to 90 wt%, even more preferably at least 70 to 90 wt%.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder. Alternatively, the blends described above may be produced by mixing the polymers of the invention with one or more polymers (as described above), by connecting reactors together in parallel or in series to make reactor blends.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from BASF); phosphites (e.g., IRGAFOS™ 168 available from BASF); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

### Films

Specifically, any of the foregoing polymers, such as the foregoing polyethylene polymers or blends thereof, may be used in a variety of end-use applications. Such applications include, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15, preferably 7 to 9. However, in another embodiment the film is oriented to the same extent in both the MD and TD directions.

The films may vary in thickness depending on the intended application; however, films of a thickness from 1 to 50 µm are usually suitable. Films intended for packaging are usually from 10 to 50 µm thick. The thickness of the sealing layer is typically 0.2 to 50 µm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

Any of the foregoing polymers and compositions in combination with optional additives (see, for example, U.S. Pat. Application Publication No. 2016/0060430, paragraphs [0082]-[0093]) may be used in a variety of end-use applications. Such end uses may be produced by methods known in the art. End uses include polymer products and products having specific end-uses. Exemplary end uses are films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

### Lubricants and Viscosity Modifiers

The present invention also provides a lubricant composition comprising a blend of the ethylene-olefin copolymers described herein and a lubrication oil. Preferably, the ethylene-olefin copolymers have a branching index (g′vis) of 0.98 or less, 0.90 or less. The long chained branched ethylene copolymer is soluble in the lubrication oil at temperature of from -40 to 150° C. at application concentration. The concentration of the long chain branched ethylene copolymer in the lubrication oil is of 5 wt% or less. The shear stability index (at 30 cycles) of the branched ethylene copolymer in lubricating oil is from about 10% to about 60%, and the kinematic viscosity at 100° C. is from about 5 cSt to about 20 cSt. Shear stability index (SSI) is determined according to ASTM D6278 at 30 cycles using using a Kurt Orbahn diesel injection apparatus. Kinematic viscosity (KV) is determined according to ASTM D445.

In another embodiment, this invention relates to:

1. A polymerization process comprising contacting in a homogeneous phase ethylene and an optional comonomer selected C₃ to C₄₀ alpha olefins with a catalyst system comprising activator and catalyst compound represented by the Formula (I):

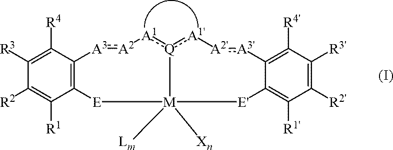

wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl;

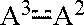

is a divalent group containing 2 to 40 non-hydrogen atoms that links A¹ to the E-bonded aryl group via a 2-atom bridge;

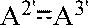

is a divalent group containing 2 to 40 non-hydrogen atoms that links A^{1′} to the E′-bonded aryl group via a 2-atom bridge;
L is a Lewis base; X is an anionic ligand; n is 1, 2 or 3; m is 0, 1, or 2; n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group,
and one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group.

2. The process of paragraph 1, where the catalyst compound represented by the Formula (II):

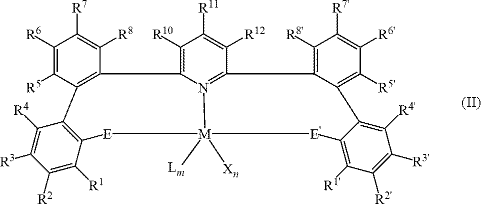

wherein:
M is a group 3, 4, 5, or 6 transition metal or a Lanthanide;
E and E′ are each independently O, S, or NR⁹, where R⁹ is independently hydrogen, a C₁-C₄₀ hydrocarbyl, a C₁-C₄₀ substituted hydrocarbyl, or a heteroatom-containing group;
each L is independently a Lewis base; each X is independently an anionic ligand; n is 1, 2 or 3;
m is 0, 1, or 2; n+m is not greater than 4;
each of R^{1′}, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}, R^{8′}, R¹⁰, R¹¹, and R¹² is independently hydrogen, a C₁-C₄₀ hydrocarbyl, a C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R⁷, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

3. The process of paragraph 1 or 2 wherein the M is Hf, Zr or Ti.

4. The process of paragraph 1, 2 or 3 wherein E and E′ are each O.

5. The process of paragraph 1, 2, 3, or 4 wherein R¹ and R^{1′} is independently a C₄-C₄₀ tertiary hydrocarbyl group.

6. The process of paragraph 1, 2, 3, or 4 wherein R¹ and R^{1′} is independently a C₄-C₄₀ cyclic tertiary hydrocarbyl group.

7. The process of paragraph 1, 2, 3, or 4 wherein R¹ and R^{1′} is independently a C₄-C₄₀ polycyclic tertiary hydrocarbyl group.

8. The process any of paragraphs 1 to 7 wherein each X is, independently, selected from the group consisting of substituted or unsubstituted hydrocarbyl radicals having from 1 to 20 carbon atoms, hydrides, amides, alkoxides, sulfides, phosphides, halides, and a combination thereof, (two X’s may form a part of a fused ring or a ring system).

9. The process any of paragraphs 1 to 8 wherein each L is, independently, selected from the group consisting of: ethers, thioethers, amines, phosphines, ethyl ether, tetrahydrofuran, dimethylsulfide, triethylamine, pyridine, alkenes, alkynes, allenes, and carbenes and a combinations thereof, optionally two or more L’s may form a part of a fused ring or a ring system).

10. The process of paragraph 1, wherein M is Zr or Hf, Q is nitrogen, both A¹ and A^{1′} are carbon, both E and E′ are oxygen, and both R¹ and R^{1′} are C₄-C₂₀ cyclic tertiary alkyls.

11. The process of paragraph 1, wherein M is Zr or Hf, Q is nitrogen, both A¹ and A^{1′} are carbon, both E and E′ are oxygen, and both R¹ and R^{1′} are adamantan-1-yl or substituted adamantan-1-yl.

12. The process of paragraph 1, wherein M is Zr or Hf, Q is nitrogen, both A¹ and A^{1′} are carbon, both E and E′ are oxygen, and X is methyl or chloro, and n is 2.

13. The process of paragraph 1, wherein Q is nitrogen, A¹ and A^{1′} are both carbon, both R¹ and R^{1′} are hydrogen, both E and E′ are NR⁹, where R⁹ is selected from a C₁-C₄₀ hydrocarbyl, a C₁-C₄₀ substituted hydrocarbyl, or a heteroatom-containing group.

14. The process of paragraph 1, wherein Q is carbon, A¹ and A^{1′} are both nitrogen, and both E and E′ are oxygen.

15. The process of paragraph 1, wherein Q is carbon, A¹ is nitrogen, A^{1′} is C(R²²), and both E and E′ are oxygen, where R²² is selected from hydrogen, C₁-C₂₀ hydrocarbyl, C₁-C₂₀ substituted hydrocarbyl.

16. The process of paragraph 1, wherein the heterocyclic Lewis base is selected from the groups represented by the following formulas:

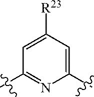

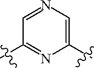

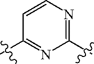

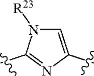

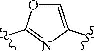

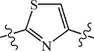

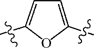

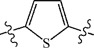

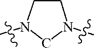

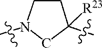

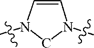

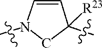

where each R²³ is independently selected from hydrogen, C₁-C₂₀ alkyls, and C₁-C₂₀ substituted alkyls.

17. The process of paragraph 2, wherein M is Zr or Hf, both E and E′ are oxygen, and both R¹ and R^{1′} are C₄-C₂₀ cyclic tertiary alkyls.

18. The process of paragraph 2, wherein M is Zr or Hf, both E and E′ are oxygen, and both R¹ and R^{1′} are adamantan-1-yl or substituted adamantan-1-yl.

19. The process of paragraph 2, wherein M is Zr or Hf, both E and E′ are oxygen, and each of R¹, R^{1′}, R³ and R^{3′} are adamantan-1-yl or substituted adamantan-1-yl.

20. The process of paragraph 2, wherein M is Zr or Hf, both E and E′ are oxygen, both R¹ and R^{1′} are C₄-C₂₀ cyclic tertiary alkyls, and both R⁷ and R^{7′} are C₁-C₂₀ alkyls.

21. The process of paragraph 2, wherein M is Zr or Hf, both E and E′ are O, both R¹ and R^{1′} are C₄-C₂₀ cyclic tertiary alkyls, and both R⁷ and R^{7′} are C₁-C₂₀ alkyls.

22. The process of paragraph 2, wherein M is Zr or Hf, both E and E′ are O, both R¹ and R^{1′} are C₄-C₂₀ cyclic tertiary alkyls, and both R⁷ and R^{7′} are C₁-C₃ alkyls.

23. The process of paragraph 1 wherein the catalyst compound is represented by one or more of the following formulas:

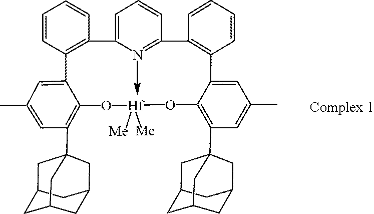

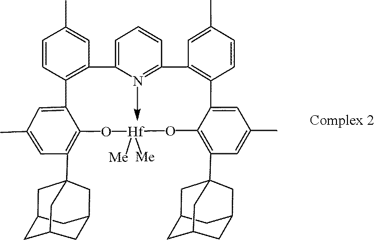

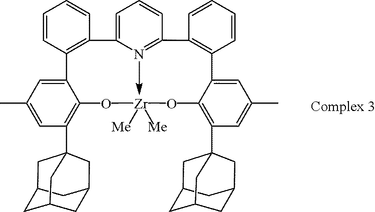

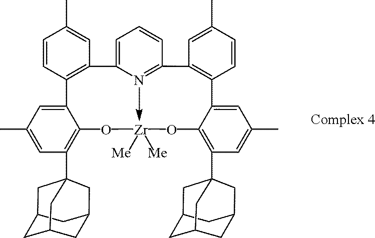

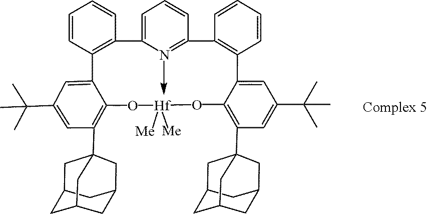

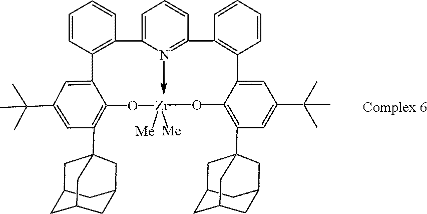

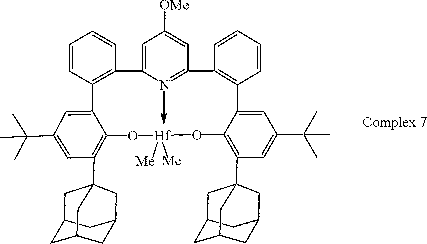

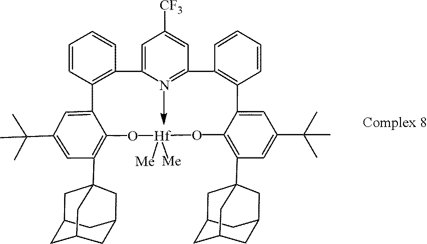

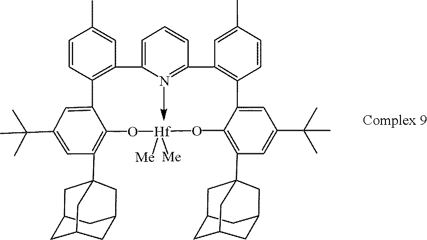

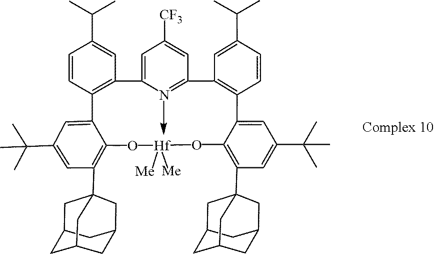

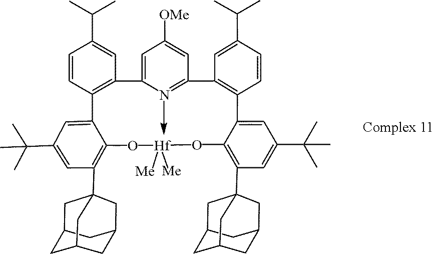

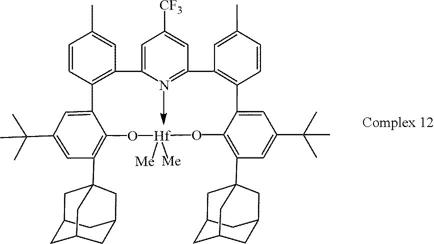

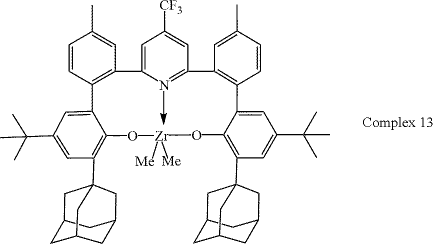

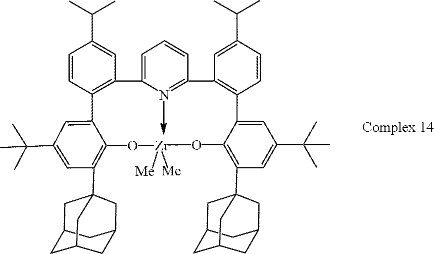

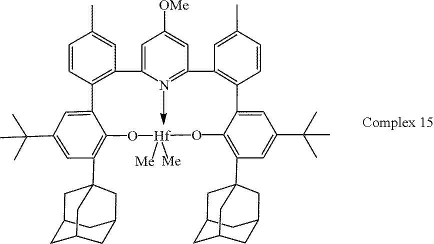

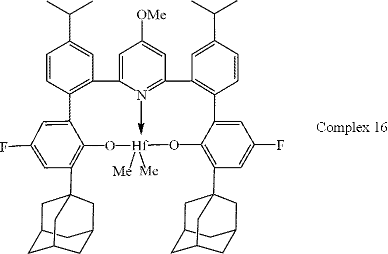

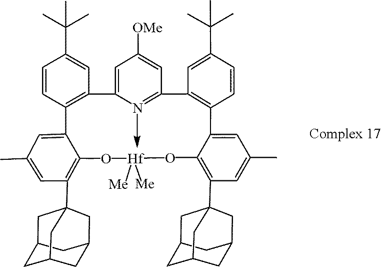

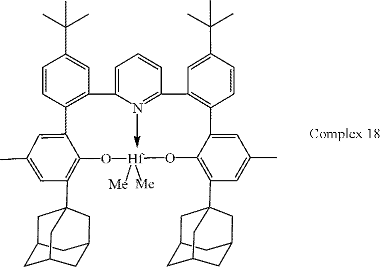

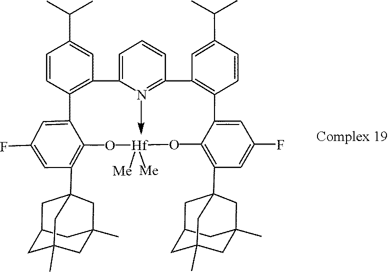

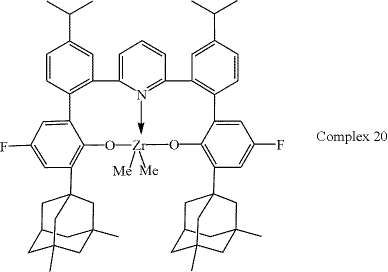

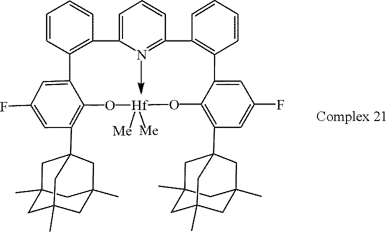

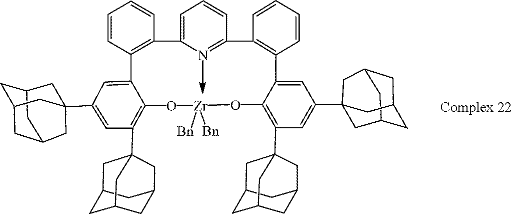

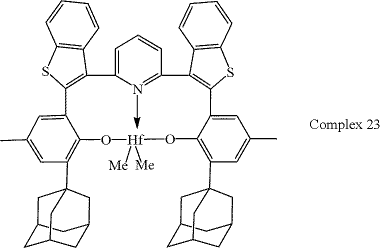

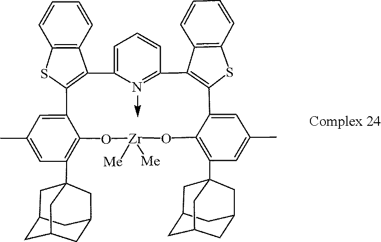

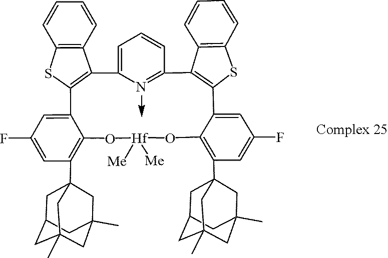

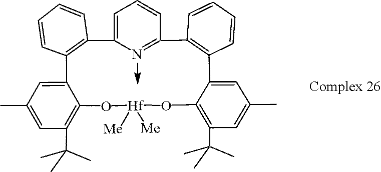

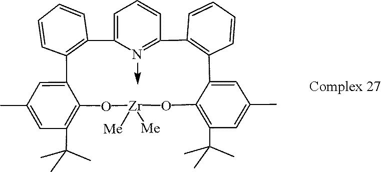

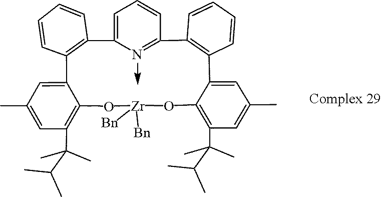

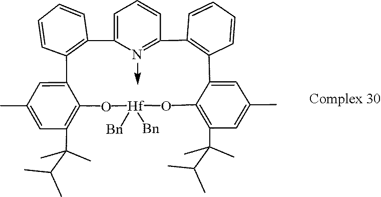

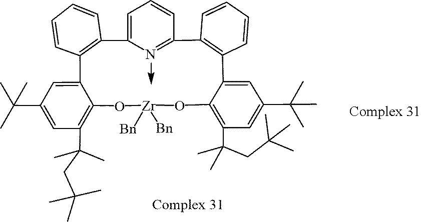

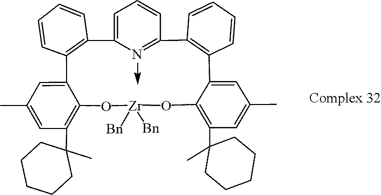

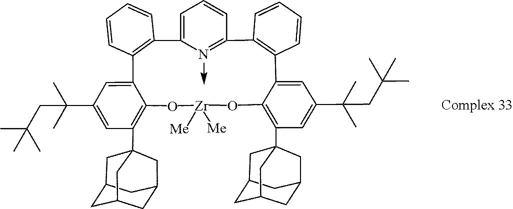

24. The process of paragraph 23 wherein the catalyst compound is one or more of any of complexes 1 to 6.

25. The process of any of paragraphs 1 to 24, wherein the activator comprises an alumoxane or a non-coordinating anion.

26. The process of any of paragraphs 1 to 25, wherein the activator is soluble in nonaromatic-hydrocarbon solvent.

27. The process of any of paragraphs 1 to 26, wherein the catalyst system is free of aromatic solvent.

28. The process of any of paragraphs 1 to 27, wherein the activator is represented by the formula:

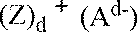

wherein Z is (L-H) or a reducible Lewis Acid, L is an neutral Lewis base; H is hydrogen; (L-H)⁺ is a Bronsted acid; A^{d-} is a non-coordinating anion having the charge d-; and d is an integer from 1 to 3.

29. The process of any of paragraphs 1 to 27, wherein the activator is represented by the formula:

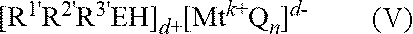

wherein:
E is nitrogen or phosphorous;
d is 1, 2 or 3; k is 1, 2, or 3; n is 1, 2, 3, 4, 5, or 6; n – k = d;
R^{1′}, R^{2′}, and R^{3′} are independently a C₁ to C₅₀ hydrocarbyl group optionally substituted with one or more alkoxy groups, silyl groups, a halogen atoms, or halogen containing groups,
wherein R^{1′}, R^{2′}, and R^{3′} together comprise 15 or more carbon atoms;
Mt is an element selected from group 13 of the Periodic Table of the Elements; and each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

30. The process of paragraph 1, wherein the activator is represented by the formula:

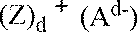

wherein A^{d-} is a non-coordinating anion having the charge d-; and d is an integer from 1 to 3 and (Z)_{d}⁺ is represented by one or more of:

| | | | | | |
|---|---|---|---|---|---|
| 10 | 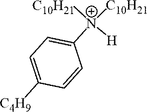 | 11 | 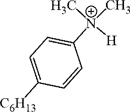 | 12 | 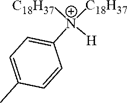 |
| 13 | 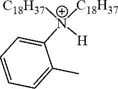 | 14 | 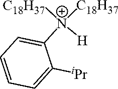 | 15 | 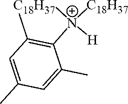 |
| 16 | 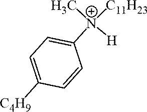 | 17 | 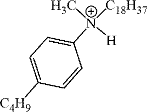 | 18 | 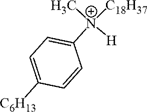 |
| 19 | 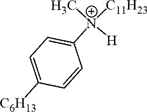 | 20 | 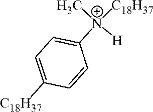 | 21 | 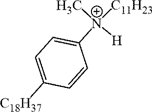 |
| 22 | 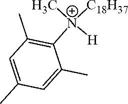 | 23 | 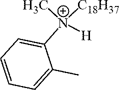 | 24 | 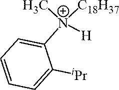 |
| 25 | 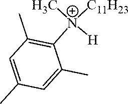 | 26 | 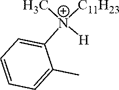 | 27 | 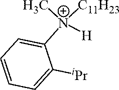 |
| 29 | 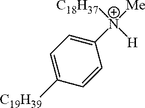 | 28 | 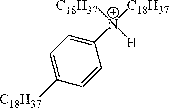 | 30 | 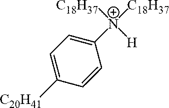 |
| 31 | 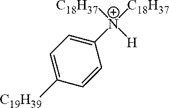 | 32 | 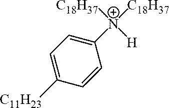 | 33 | 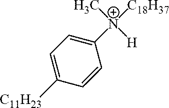 |
| 34 | 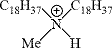 | 35 | 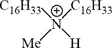 | 36 | 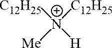 |

31. The process of any of paragraphs 1 to 29 wherein the activator is one or more of:
N-methyl-4-nonadecyl-N-octadecylbenzenaminium tetrakis(pentafluorophenyl)borate,
N-methyl-4-nonadecyl-N-octadecylbenzenaminium tetrakis(perfluoronaphthalenyl)borate,
dioctadecylmethylammonium tetrakis(pentafluorophenyl)borate,
dioctadecylmethylammonium tetrakis(perfluoronaphthalenyl)borate,
N,N-dimethylanilinium tetrakis(pentafluorophenyl)borate,
triphenylcarbenium tetrakis(pentafluorophenyl)borate,
trimethylammonium tetrakis(perfluoronaphthalenyl)borate,
triethylammonium tetrakis(perfluoronaphthalenyl)borate,
tripropylammonium tetrakis(perfluoronaphthalenyl)borate,
tri(n-butyl)ammonium tetrakis(perfluoronaphthalenyl)borate,
tri(t-butyl)ammonium tetrakis(perfluoronaphthalenyl)borate,
N,N-dimethylanilinium tetrakis(perfluoronaphthalenyl)borate,
N,N-diethylanilinium tetrakis(perfluoronaphthalenyl)borate,
N,N-dimethyl-(2,4,6-trimethylanilinium) tetrakis(perfluoronaphthalenyl)borate,
tropillium tetrakis(perfluoronaphthalenyl)borate,
triphenylcarbenium tetrakis(perfluoronaphthalenyl)borate,
triphenylphosphonium tetrakis(perfluoronaphthalenyl)borate,
triethylsilylium tetrakis(perfluoronaphthalenyl)borate,
benzene(diazonium) tetrakis(perfluoronaphthalenyl)borate,
trimethylammonium tetrakis(perfluorobiphenyl)borate,
triethylammonium tetrakis(perfluorobiphenyl)borate,
tripropylammonium tetrakis(perfluorobiphenyl)borate,
tri(n-butyl)ammonium tetrakis(perfluorobiphenyl)borate,
tri(t-butyl)ammonium tetrakis(perfluorobiphenyl)borate,
N,N-dimethylanilinium tetrakis(perfluorobiphenyl)borate,
N,N-diethylanilinium tetrakis(perfluorobiphenyl)borate,
N,N-dimethyl-(2,4,6-trimethylanilinium) tetrakis(perfluorobiphenyl)borate,
tropillium tetrakis(perfluorobiphenyl)borate,
triphenylcarbenium tetrakis(perfluorobiphenyl)borate,
triphenylphosphonium tetrakis(perfluorobiphenyl)borate,
triethylsilylium tetrakis(perfluorobiphenyl)borate,
benzene(diazonium) tetrakis(perfluorobiphenyl)borate,
[4-t-butyl-PhNMe₂H][(C₆F₃(C₆F₅)₂)₄B],
trimethylammonium tetraphenylborate,
triethylammonium tetraphenylborate,
tripropylammonium tetraphenylborate,
tri(n-butyl)ammonium tetraphenylborate,
tri(t-butyl)ammonium tetraphenylborate,
N,N-dimethylanilinium tetraphenylborate,
N,N-diethylanilinium tetraphenylborate,
N,N-dimethyl-(2,4,6-trimethylanilinium) tetraphenylborate, tropillium tetraphenylborate,
triphenylcarbenium tetraphenylborate,
triphenylphosphonium tetraphenylborate,
triethylsilylium tetraphenylborate,
benzene(diazonium)tetraphenylborate,
trimethylammonium tetrakis(pentafluorophenyl)borate,
triethylammonium tetrakis(pentafluorophenyl)borate,
tripropylammonium tetrakis(pentafluorophenyl)borate,
tri(n-butyl)ammonium tetrakis(pentafluorophenyl)borate,
tri(sec-butyl)ammonium tetrakis(pentafluorophenyl)borate,
N,N-dimethylanilinium tetrakis(pentafluorophenyl)borate,
N,N-diethylanilinium tetrakis(pentafluorophenyl)borate,
N,N-dimethyl-(2,4,6-trimethylanilinium) tetrakis(pentafluorophenyl)borate,
tropillium tetrakis(pentafluorophenyl)borate,
triphenylcarbenium tetrakis(pentafluorophenyl)borate,
triphenylphosphonium tetrakis(pentafluorophenyl)borate,
triethylsilylium tetrakis(pentafluorophenyl)borate,
benzene(diazonium) tetrakis(pentafluorophenyl)borate,
trimethylammonium tetrakis-(2,3,4,6-tetrafluorophenyl) borate,
triethylammonium tetrakis-(2,3,4,6-tetrafluorophenyl)borate,
tripropylammonium tetrakis-(2,3,4,6-tetrafluorophenyl)borate,
tri(n-butyl)ammonium tetrakis-(2,3,4,6-tetrafluoro-phenyl)borate,
dimethyl(t-butyl)ammonium tetrakis-(2,3,4,6-tetrafluorophenyl)borate,
N,N-dimethylanilinium tetrakis-(2,3,4,6-tetrafluorophenyl)borate,
N,N-diethylanilinium tetrakis-(2,3,4,6-tetrafluorophenyl)borate,
N,N-dimethyl-(2,4,6-trimethylanilinium) tetrakis-(2,3,4,6-tetrafluorophenyl)borate,
tropillium tetrakis-(2,3,4,6-tetrafluorophenyl)borate,
triphenylcarbenium tetrakis-(2,3,4,6-tetrafluorophenyl)borate,
triphenylphosphonium tetrakis-(2,3,4,6-tetrafluorophenyl)borate,
triethylsilylium tetrakis-(2,3,4,6-tetrafluorophenyl)borate,
benzene(diazonium) tetrakis-(2,3,4,6-tetrafluorophenyl)borate,
trimethylammonium tetrakis(3,5-bis(trifluoromethyl)phenyl)borate,
triethylammonium tetrakis(3,5-bis(trifluoromethyl)phenyl)borate,
tripropylammonium tetrakis(3,5-bis(trifluoromethyl)phenyl)borate,
tri(n-butyl) ammonium tetrakis (3,5-bis(trifluoromethyl)phenyl)borate,
tri(t-butyl)ammonium tetrakis(3,5-bis(trifluoromethyl)phenyl)borate,
N,N-dimethylanilinium tetrakis(3,5-bis(trifluoromethyl)phenyl)borate,
N,N-diethylanilinium tetrakis(3,5-bis(trifluoromethyl)phenyl)borate,
N,N-dimethyl-(2,4,6-trimethylanilinium) tetrakis(3,5-bis(trifluoromethyl)phenyl)borate,
tropillium tetrakis(3,5-bis(trifluoromethyl)phenyl)borate,
triphenylcarbenium tetrakis(3,5-bis(trifluoromethyl)phenyl)borate,
triphenylphosphonium tetrakis(3,5-bis(trifluoromethyl)phenyl)borate,
triethylsilylium tetrakis(3,5-bis(trifluoromethyl)phenyl)borate,
benzene(diazonium) tetrakis(3,5-bis(trifluoromethyl)phenyl)borate,
di-(i-propyl)ammonium tetrakis(pentafluorophenyl)borate,
dicyclohexylammonium tetrakis(pentafluorophenyl)borate,
tri(o-tolyl)phosphonium tetrakis(pentafluorophenyl)borate,
tri(2,6-dimethylphenyl)phosphonium tetrakis(pentafluorophenyl)borate,
triphenylcarbenium tetrakis(perfluorophenyl)borate,
1-(4-(tris(pentafluorophenyl)borate)-2,3,5,6-tetrafluorophenyl)pyrrolidinium,
tetrakis(pentafluorophenyl)borate,
4-(tris(pentafluorophenyl)borate)-2,3,5,6-tetrafluoropyridine, and
triphenylcarbenium tetrakis(3,5-bis(trifluoromethyl)phenyl)borate).

32. The process of any of paragraphs 1 to 31 wherein the process is a solution process.

33. The process of any of paragraphs 1 to 32 wherein the process occurs at a temperature of from about 80° C. to about 300° C., at a pressure in the range of from about 0.35 MPa to about 10 MPa, and at a residence time up to 300 minutes.

34. The process of any of paragraphs 1 to 33 wherein the process is a continuous process.

35. The process of any of paragraphs 1 to 34 further comprising obtaining a polyethylene composition, such as an ethylene copolymer, preferably having 20 mol% or more ethylene content.

36. The process of any of paragraphs 1 to 34 further comprising obtaining an ethylene copolymer, wherein the copolymer has a shear thinning ratio are greater than 30 and an I₂₁/I₂ greater than 10.

37. A copolymer comprising ethylene and comonomer selected from propylene, butene, hexene and octene, where the copolymer has a melt index of 400 g/10 min or less.

38. A polymer produced by process of any of paragraphs 1 to 36 comprising ethylene and one or more comonomer selected from propylene, butene, hexene and octene, where the copolymer has 30 to 50 mol% ethylene content.

39. A polymer produced by process of any of paragraphs 1 to 36 comprising ethylene and one or more comonomer selected from propylene, butene, hexene and octene, where the copolymer has 50 to 70 mol% ethylene content.

40. A polymer produced by process of any of paragraphs 1 to 36 comprising ethylene and one or more comonomer selected from propylene, butene, hexene and octene, where the copolymer has 70 to 90 mol% ethylene content.

41. A polymer produced by process of any of paragraphs 1 to 36 comprising ethylene and one or more comonomer selected from propylene, butene, hexene and octene, where the copolymer has 90 mol% or higher ethylene content.

42. A polymer produced by process of any of paragraphs 1 to 36 comprising ethylene and one or more comonomer selected from propylene, butene, hexene and octene, where the copolymer has a branching index of 0.98 or less.

43. A copolymer produced by a polymerization process comprising contacting in a homogeneous phase ethylene and propylene with a catalyst system comprising an activator and group 4 bis(phenolate) catalyst compound, wherein the polymerization process takes place at a temperature of 90° C. or higher in the absence of added hydrogen, to produce a polymer having: 65 to 80 mol% ethylene; a shear thinning ratio (measured at 125° C.) of 70-150; a phase angle (measured at 125° C.) @ complex modulus G* = 500 kPa of less than 50°; a Mooney Large viscosity (measured at 125° C.) of 80 to 120 mu; and a Mooney relaxation area (measured at 125° C.) of 550 to 3200 mu.sec.

44. A copolymer produced by a polymerization process comprising contacting in a homogeneous phase ethylene and propylene with a catalyst system comprising an activator and group 4 bis(phenolate) catalyst compound, wherein the polymerization process takes place at a temperature of 120° C. or higher in the presence of added hydrogen, to produce a polymer having: 50 to 65 mol% ethylene; a g′ᵥᵢₛ of from 0.8 to 0.9; a Mooney Large viscosity (measured at 125° C.) of 35 to 40 mu; a Mooney relaxation area (measured at 125° C.) of 300-400 mu.sec.

### Test Methods

Molecular weight and composition distribution (GPC-IR): The distribution and the moments of molecular weight (e.g., Mn, Mw, Mz ) and the comonomer distribution (C₂, C₃, C₆, etc.), are determined with a high temperature Gel Permeation Chromatography (PolymerChar GPC-IR) equipped with a multiple-channel band filter based infrared detector ensemble IR5, in which a broad-band channel is used to measure the polymer concentration while two narrow-band channels are used for characterizing composition. Three Agilent PLgel 10 µm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 micrometer Teflon filter and degassed with an online degasser before entering the GPC instrument. The nominal flow rate is 1.0 mL/min and the nominal injection volume is 200 microliter. The whole system including transfer lines, columns, detectors are contained in an oven maintained at 145° C. Given amount of polymer sample is weighed and sealed in a standard vial with 10 microliter flow marker (Heptane) added to it. After loading the vial in the autosampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration, c, at each point in the chromatogram is calculated from the baseline-subtracted IR5 broadband signal, I, using the following equation:

$$c = α I$$

where α is the mass constant determined with PE standard NBS1475. The mass recovery is calculated from the ratio of the integrated area of the concentration chromatography over elution volume and the injection mass which is equal to the pre-determined concentration multiplied by injection loop volume.

The molecular weight is determined by combining universal calibration relationship with the column calibration which is performed with a series of mono-dispersed polystyrene (PS) standards. The molecular weight is calculated at each elution volume with following equation.

$$log {M}_{X} = \frac{log \left({K}_{X} / {K}_{P S}\right)}{{a}_{X} + 1} + \frac{{a}_{P S} + 1}{{a}_{X} + 1} log {M}_{P S}$$

where K and α are the coefficients in the Mark-Houwink equation. The variables with subscript “X” stand for the test sample while those with subscript “PS” stand for polystyrene. In this method, a_{PS} = 0.67 and K_{PS} = 0.000175 while aₓ and Kₓ are determined based on the composition of linear ethylene/propylene copolymer and linear ethylene-propylene-diene terpolymers using a standard calibration procedure. The comonomer composition is determined by the ratio of the IR detector intensity corresponding to CH₂ and CH₃ channel calibrated with a series of PE and PP homo/copolymer standards whose nominal value are predetermined by NMR.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{\text{K}}_{\text{o}} \text{c}}{\text{Δ} \text{R} \left(\text{θ}\right)} = \frac{1}{\text{MP} \left(\text{θ}\right)} + 2 {\text{A}}_{2} \text{c} \text{.}$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system:

$${\text{K}}_{\text{o}} = \frac{4 {π}^{2} {\text{n}}^{2} {\left(\text{dn} / \text{dc}\right)}^{2}}{{\text{λ}}^{4} {\text{N}}_{\text{A}}}$$

where N_{A} is Avogadro’s number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1-0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]= η_{S}/_{C}, where c is concentration and is determined from the IR5 broadband channel output. The viscosity MW at each point is calculated as

$$M = {K}_{P S} {M}^{{α}_{P S} + 1} / \left[η\right] ,$$

where αₚₛ is 0.67 and K_{PS} is 0.000175.

The branching index (g′ᵥᵢₛ) is calculated using the output of the GPC-IR5-LS-VIS method as follows. The average intrinsic viscosity, [η]_{avg}, of the sample is calculated by:

$${\left[\text{η}\right]}_{\text{avg}} = \frac{\sum {\text{c}}_{\text{i}} {\left[\text{η}\right]}_{\text{i}}}{\sum {\text{c}}_{\text{i}}}$$

where the summations are over the chromatographic slices, i, between the integration limits.

The branching index g′ᵥᵢₛ is defined as

$${{g}^{′}}_{v i s} = \frac{{\left[η\right]}_{a v g}}{K {M}_{v}^{α}} ,$$

where Mᵥ is the viscosity-average molecular weight based on molecular weights determined by LS analysis and the K and α are for the reference linear polymer, which are, for purposes of the present disclosure, α = 0.695 and K = 0.000579 for linear ethylene polymers, α = 0.705 and K = 0.0002288 for linear propylene polymers, α = 0.695 and K = 0.000181 for linear butene polymers, α is 0.695 and K is 0.000579*(1-0.0087*w2b+0.000018*(w2b)^2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, and α is 0.695 and K is 0.000579*(1-0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Experimental and analysis details not described above, including how the detectors are calibrated and how to calculate the composition dependence of Mark-Houwink parameters and the second-virial coefficient, are described by T. Sun, P. Brant, R. R. Chance, and W. W. Graessley (Macromolecules, 2001, Vol. 34(19), pp. 6812-6820).

Comonomer content such as butene, hexene and octene was determined via FTIR measurements according to ASTM D3900 (calibrated versus ¹³C NMR). A thin homogeneous film of polymer, pressed at a temperature of about 150° C., was mounted on a Perkin Elmer Spectrum 2000 infrared spectrophotometer. The weight percent of copolymer is determined via measurement of the methyl deformation band at ^{~}1375 cm-1. The peak height of this band is normalized by the combination and overtone band at ^{~}4321 cm-1, which corrects for path length differences. The content of other comonomer can be obtained using C¹³ NMR. The content of other diene if present can be obtained using C¹³ NMR.

The comonomer content and sequence distribution of the polymers can be measured using ¹³C nuclear magnetic resonance (NMR) by methods well known to those skilled in the art. Reference is made to U.S. Pat. No. 6,525,157 which contains more details of the determination of ethylene content by NMR. Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, v.47, pp. 1128-1130.

Peak melting point, Tm, (also referred to as melting point), peak crystallization temperature, Tc, (also referred to as crystallization temperature), glass transition temperature (Tg), heat of fusion (ΔHf or Hf), and percent crystallinity were determined using the following DSC procedure according to ASTM D3418-03. Differential scanning calorimetric (DSC) data were obtained using a TA Instruments model Q200 machine. Samples weighing approximately 5-10 mg were sealed in an aluminum hermetic sample pan. The DSC data were recorded by first gradually heating the sample to 200° C. at a rate of 10° C./minute. The sample was kept at 200° C. for 2 minutes, then cooled to -90° C. at a rate of 10° C./minute, followed by an isothermal for 2 minutes and heating to 200° C. at 10° C./minute. Both the first and second cycle thermal events were recorded. Areas under the endothermic peaks were measured and used to determine the heat of fusion and the percent of crystallinity. The percent crystallinity is calculated using the formula, [area under the melting peak (Joules/gram) / B (Joules/gram)] * 100, where B is the heat of fusion for the 100% crystalline homopolymer of the major monomer component. These values for B are to be obtained from the Polymer Handbook, Fourth Edition, published by John Wiley and Sons, New York 1999, provided; however, that a value of 189 J/g (B) is used as the heat of fusion for 100% crystalline polypropylene, a value of 290 J/g is used for the heat of fusion for 100% crystalline polyethylene. The melting and crystallization temperatures reported here were obtained during the second heating/cooling cycle unless otherwise noted.

For polymers displaying multiple endothermic and exothermic peaks, all the peak crystallization temperatures and peak melting temperatures were reported. The heat of fusion for each endothermic peak was calculated individually. The percent crystallinity is calculated using the sum of heat of fusions from all endothermic peaks. Some of the polymer blends produced show a secondary melting/cooling peak overlapping with the principal peak, which peaks are considered together as a single melting/cooling peak. The highest of these peaks is considered the peak melting temperature/crystallization point. For the amorphous polymers, having comparatively low levels of crystallinity, the melting temperature is typically measured and reported during the first heating cycle. Prior to the DSC measurement, the sample was aged (typically by holding it at ambient temperature for a period of 2 days) or annealed to maximize the level of crystallinity.

Rubber process analyzer (RPA): Dynamic shear melt rheological data was measured using the ATD® 1000 Rubber Process Analyzer from Alpha Technologies. A sample of approximately 4.5 gm weight is mounted between the parallel plates of the ATD® 1000. A nitrogen stream was circulated through the sample oven during the experiments. The test temperature is 125° C. for ethylene-propylene copolymers containing 60-80 wt% ethylene and 190° C. for all other ethylene copolymers. The applied strain is 14% and the frequency was varied from 0.1 rad/s to 385 rad/s. The complex modulus (G*), complex viscosity (η*) and the phase angle (δ) are measured at each frequency. A sinusoidal shear strain is applied to the material. If the strain amplitude is sufficiently small the material behaves linearly. As those of ordinary skill in the art will be aware, the resulting steady-state stress will also oscillate sinusoidally at the same frequency but will be shifted by a phase angle 8 with respect to the strain wave. For purely elastic materials 8=0° (stress is in phase with strain) and for purely viscous materials, 8=90°. For viscoleastic materials, 0 < δ < 90. Complex viscosity, loss modulus (G″) and storage modulus (G′) as function of frequency are provided by the small amplitude oscillatory shear test. Dynamic viscosity is also referred to as complex viscosity or dynamic shear viscosity. The phase or the loss angle (8), is the inverse tangent of the ratio of G″ (shear loss modulus) to G′ (shear storage modulus).

Shear Thinning Ratio: Shear-thinning is a rheological response of polymer melts, where the resistance to flow (viscosity) decreases with increasing shear rate. The complex shear viscosity is generally constant at low shear rates (Newtonian region) and decreases with increasing shear rate. In the low shear-rate region, the viscosity is termed the zero shear viscosity, which is often difficult to measure for polydisperse and/or LCB polymer melts. At the higher shear rate, the polymer chains are oriented in the shear direction, which reduces the number of chain entanglements relative to their un-deformed state. This reduction in chain entanglement results in lower viscosity. Shear thinning is characterized by the decrease of complex dynamic viscosity with increasing frequency of the sinusoidally applied shear. Shear thinning ratio is defined as a ratio of the complex shear viscosity at frequency of 0.245 rad/sec to that at frequency of 128 rad/sec.

Mooney Large viscosity (ML) and Mooney Relaxation Area (MLRA): ML and MLRA are measured using a Mooney viscometer according to ASTM D-1646, modified as detailed in the following description. A sample is placed on either side of the rotor. The cavity is filled by pneumatically lowering the upper platen. The upper and lower platens are electrically heated and controlled at 125° C. The torque to turn the rotor at 2 rpm is measured by a torque transducer. Mooney viscometer is operated at an average shear rate of 2 s-1. The sample is pre-heated for 1 minute after the platens are closed. The motor is then started and the torque is recorded for a period of 4 minutes. The results are reported as ML (1+4) 125° C., where M is the Mooney viscosity number, L denotes large rotor, 1 is the pre-heat time in minutes, 4 is the sample run time in minutes after the motor starts, and 125° C. is the test temperature.

The torque limit of the Mooney viscometer is about 100 Mooney units. Mooney viscosity values greater than about 100 Mooney unit cannot generally be measured under these conditions. In this event, a non-standard rotor design is employed with a change in Mooney scale that allows the same instrumentation on the Mooney viscometer to be used for more viscous polymers. This rotor that is both smaller in diameter and thinner than the standard Mooney Large (ML) rotor is termed MST—Mooney Small Thin. Typically when the MST rotor is employed, the test is also run at different time and temperature. The pre-heat time is changed from the standard 1 minute to 5 minutes and the test is run at 200° C. instead of the standard 125° C. Thus, the value will be reported as MST (5+4) at 200° C. Note that the run time of 4 minutes at the end of which the Mooney reading is taken remains the same as the standard conditions. According to EP 1 519 967, one MST point is approximately 5 ML points when MST is measured at (5+4@200° C.) and ML is measured at (1+4@125° C.). The MST rotor should be prepared as follows:
a. The rotor should have a diameter of 30.48+/-0.03 mm and a thickness of 2.8+/-0.03 mm (tops of serrations) and a shaft of 11 mm or less in diameter.
b. The rotor should have a serrated face and edge, with square grooves of 0.8 mm width and depth of 0.25-0.38 mm cut on 1.6 mm centers. The serrations will consist of two sets of grooves at right angles to each other (form a square crosshatch).
c. The rotor shall be positioned in the center of the die cavity such that the centerline of the rotor disk coincides with the centerline of the die cavity to within a tolerance of +/-0.25 mm. A spacer or a shim may be used to raise the shaft to the midpoint.
d. The wear point (cone shaped protuberance located at the center of the top face of the rotor) shall be machined off flat with the face of the rotor.

The MLRA data is obtained from the Mooney viscosity measurement when the rubber relaxes after the rotor is stopped. The MLRA is the integrated area under the Mooney torque-relaxation time curve from 1 to 100 seconds. The MLRA is a measure of chain relaxation in molten polymer and can be regarded as a stored energy term which suggests that, after the removal of an applied strain, the longer or branched polymer chains can store more energy and require longer time to relax. Therefore, the MLRA value of a bimodal rubber (the presence of a discrete polymeric fraction with very high molecular weight and distinct composition) or a long chain branched rubber are larger than a broad or a narrow molecular weight rubber when compared at the same Mooney viscosity values.

Mooney Relaxation Area is dependent on the Mooney viscosity of the polymer, and increases with increasing Mooney viscosity. In order to remove the dependence on polymer Mooney Viscosity, a corrected MLRA (cMLRA) parameter is used, where the MLRA of the polymer is normalized to a reference of 80 Mooney viscosity. The formula for cMLRA is provided below

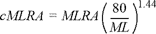

where MLRA and ML are the Mooney Relaxation Area and Mooney viscosity of the polymer sample measured at 125° C.

Melt index (I₂) was determined according to ASTM D1238 using a load of 2.16 kg at a temperature of 190° C. The melt index at the high load condition (I₂₁) was determined according to ASTM D1238 using a load of 21.6 kg at a temperature of 190° C.

Density is determined according to ASTM D1505 using a density-gradient column, as described in ASTM D 1505, on a compression-molded specimen that has been slowly cooled to room temperature (i.e., over a period of 10 minutes or more) and allowed to age for a sufficient time that the density is constant within +/- 0.001 g/cm³.

Shore hardness was determined according to ISO 868 at 23° C. using a Durometer.

Stress-strain properties such as ultimate tensile strength, ultimate elongation, and 100% modulus were measured on 2 mm thick compression molded plaques at 23° C. by using an Instron testing machine according to ISO 37.

### Experimental

Cat-Hf (Complex 5) and Cat-Zr (Complex 6) and complex 33 were prepared as follows:

### Starting Materials

2-Isopropoxy-4,4,5,5-tetramethyl-1,3,2-dioxaborolane (Aldrich), 2,6-dibromopyridine (Aldrich), 2-bromoiodobenzene (Acros), 2.5 M ⁿBuLi in hexanes (Chemetall GmbH), Pd(PPh₃)₄ (Aldrich), methoxymethyl chloride (Aldrich), NaH (60% wt. in mineral oil, Aldrich), THF (Merck), ethyl acetate (Merck), methanol (Merck), toluene (Merck), hexanes (Merck), dichloromethane (Merck), HfCl₄ (<0.05% Zr, Strem), ZrC1₄ (Strem), C_{S2}CO₃ (Merck), K₂CO₃ (Merck), Na₂SO₄ (Akzo Nobel), silica gel 60 (40-63 um; Merck), CDCl₃ (Deutero GmbH) were used as received. Benzene-d₆ (Deutero GmbH) and dichloromethane-d₂ (Deutero GmbH) were dried over MS 4A prior use. THF for organometallic synthesis was freshly distilled from sodium benzophenone ketyl. Toluene and hexanes for organometallic synthesis were dried over MS 4A. 2-(Adamantan-1-yl)-4-(tert-butyl)phenol was prepared from 4-tert-butylphenol (Merck) and adamantanol-1 (Aldrich) as described in Organic Letters, 2015, 17(9), 2242-2245.

### 2-(Adamantan-1-yl)-6-bromo-4-(tert-butyl)phenol

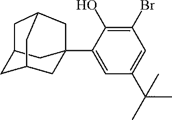 [SMILES: CC(C)(C)c1cc(Br)c(O)c(C23CC4CC(CC(C4)C2)C3)c1]

To a solution of 57.6 g (203 mmol) of 2-(adamantan-1-yl)-4-(tert-butyl)phenol in 400 mL of chloroform a solution of 10.4 mL (203 mmol) of bromine in 200 mL of chloroform was added dropwise for 30 min at room temperature. The resulting mixture was diluted with 400 mL of water. The obtained mixture was extracted with dichloromethane (3 × 100 mL), the combined organic extract was washed with 5% NaHCO₃, dried over Na₂SO₄, and then evaporated to dryness. Yield 71.6 g (97%) of a white solid. ¹H NMR (CDCl₃, 400 MHz): δ 7.32 (d, J = 2.3 Hz, 1 H), 7.19 (d, J = 2.3 Hz, 1 H), 5.65 (s, 1 H), 2.18 - 2.03 (m, 9 H), 1.78 (m, 6 H), 1.29 (s, 9 H). ¹³C NMR (CDCl₃, 100 MHz): δ 148.07, 143.75, 137.00, 126.04, 123.62, 112.11, 40.24, 37.67, 37.01, 34.46, 31.47, 29.03.

### 1-Bromo-5-(tert-butyl)-2-(methoxymethoxy)phenyl)adamantane

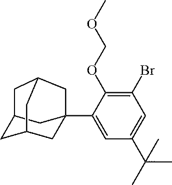 [SMILES: COCOc1c(Br)cc(C(C)(C)C)cc1C12CC3CC(CC(C3)C1)C2]

To a solution of 71.6 g (197 mmol) of 2-(adamantan-1-yl)-6-bromo-4-(tert-butyl)phenol in 1000 mL of THF 8.28 g (207 mmol, 60% wt. in mineral oil) of sodium hydride was added portionwise at room temperature. To the resulting suspension 16.5 mL (217 mmol) of methoxymethyl chloride was added dropwise for 10 min at room temperature. The obtained mixture was stirred overnight, then poured into 1000 mL of water. The obtained mixture was extracted with dichloromethane (3 × 300 mL), the combined organic extract was washed with 5% NaHCO₃, dried over Na₂SO₄ and then evaporated to dryness. Yield 80.3 g (~quant.) of a white solid. ¹H NMR (CDCl₃, 400 MHz): δ 7.39 (d, J = 2.4 Hz, 1 H), 7.27 (d, J = 2.4 Hz, 1 H), 5.23 (s, 2 H), 3.71 (s, 3 H), 2.20 - 2.04 (m, 9 H), 1.82 - 1.74 (m, 6 H), 1.29 (s, 9 H). ¹³C NMR(CDCl₃, 100 MHz): δ 150.88, 147.47, 144.42, 128.46, 123.72, 117.46, 99.53, 57.74, 41.31, 38.05, 36.85, 34.58, 31.30, 29.08.

### (3-Adamantan-1-yl)-5-(tert-butyl)-2-(methoxymethoxy)phenyl)-4,4,5,5-tetramethyl-1,3,2-dioxaborolane

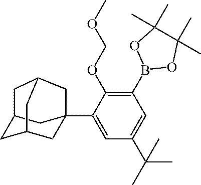 [SMILES: COCOc1c(B2OC(C)(C)C(C)(C)O2)cc(C(C)(C)C)cc1C12CC3CC(CC(C3)C1)C2]

To a solution of 22.5 g (55.0 mmol) of 1-(3-bromo-5-(tert-butyl)-2-(methoxymethoxy)phenyl)adamantane in 300 mL of dry THF 23.2 mL (57.9 mmol, 2.5 M) of ⁿBuLi in hexanes was added dropwise for 20 min at -80° C. The reaction mixture was stirred at this temperature for 1 h followed by addition of 14.5 mL (71.7 mmol) of 2-isopropoxy-4,4,5,5-tetramethyl-1,3,2-dioxaborolane. The obtained suspension was stirred at room temperature for 1 h, then poured into 300 mL of water. The obtained mixture was extracted with dichloromethane (3 × 300 mL), the combined organic extract was dried over Na₂SO₄, and then evaporated to dryness. Yield 25.0 g (~quant.) of a colorless viscous oil. ¹H NMR (CDCl₃, 400 MHz): δ 7.54 (d, J = 2.5 Hz, 1 H), 7.43 (d, J = 2.6 Hz, 1 H), 5.18 (s, 2 H), 3.60 (s, 3 H), 2.24 -2.13 (m, 6 H), 2.09 (br. s., 3 H), 1.85 - 1.75 (m, 6 H), 1.37 (s, 12 H), 1.33 (s, 9 H). ¹³C NMR (CDCl₃, 100 MHz): δ 159.64, 144.48, 140.55, 130.58, 127.47, 100.81, 83.48, 57.63, 41.24, 37.29, 37.05, 34.40, 31.50, 29.16, 24.79.

### 1-(2′-Bromo-5-(tert-butyl)-2-(methoxymethoxy)-[1,1′-biphenyl]-3-yl)adamantane

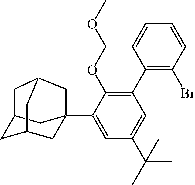 [SMILES: COCOc1c(-c2ccccc2Br)cc(C(C)(C)C)cc1C12CC3CC(CC(C3)C1)C2]

To a solution of 25.0 g (55.0 mmol) of (2-(3-adamantan-1-yl)-5-(tert-butyl)-2-(methoxymethoxy)phenyl)-4,4,5,5-tetramethyl-1,3,2-dioxaborolane in 200 mL of dioxane 15.6 g (55.0 mmol) of 2-bromoiodobenzene, 19.0 g (137 mmol) of potassium carbonate, and 100 mL of water were subsequently added. The mixture obtained was purged with argon for 10 minfollowed by addition of 3.20 g (2.75 mmol) of Pd(PPh₃)₄. Thus obtained mixture was stirred for 12 h at 100° C., then cooled to room temperature and diluted with 100 mL of water. The obtained mixture was extracted with dichloromethane (3 × 100 mL), the combined organic extract was dried over Na₂SO₄ and then evaporated to dryness. The residue was purified by flash chromatography on silica gel 60 (40-63 um, eluent: hexane-dichloromethane = 10:1, vol.). Yield 23.5 g (88%) of a white solid. ¹H NMR (CDCl₃, 400 MHz): δ 7.68 (dd, J = 1.0, 8.0 Hz, 1 H), 7.42 (dd, J = 1.7, 7.6 Hz, 1 H), 7.37 - 7.32 (m, 2 H), 7.20 (dt, J = 1.8, 7.7 Hz, 1 H), 7.08 (d, J = 2.5 Hz, 1 H), 4.53 (d, J = 4.6 Hz, 1 H), 4.40 (d, J = 4.6 Hz, 1 H), 3.20 (s, 3 H), 2.23 -2.14 (m, 6 H), 2.10 (br. s., 3 H), 1.86 - 1.70 (m, 6 H), 1.33 (s, 9 H). ¹³C NMR (CDCl₃, 100 MHz): δ 151.28, 145.09, 142.09, 141.47, 133.90, 132.93, 132.41, 128.55, 127.06, 126.81, 124.18, 123.87, 98.83, 57.07, 41.31, 37.55, 37.01, 34.60, 31.49, 29.17.

### 2-(3′-(Adamantan-1-yl)-5′-(tert-butyl)-2′-(methoxymethoxy)-[1,1′-biphenyl]-2-yl)-4,4,5,5-tetramethyl-1,3,2-dioxaborolane

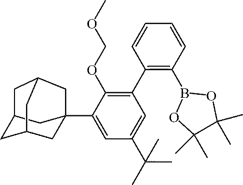 [SMILES: COCOc1c(-c2ccccc2B2OC(C)(C)C(C)(C)O2)cc(C(C)(C)C)cc1C12CC3CC(CC(C3)C1)C2]

To a solution of 30.0 g (62.1 mmol) of 1-(2′-bromo-5-(tert-butyl)-2-(methoxymethoxy)-[1,1′-biphenyl]-3-yl)adamantane in 500 mL of dry THF 25.6 mL (63.9 mmol, 2.5 M) of ⁿBuLi in hexanes was added dropwise for 20 min at -80° C. The reaction mixture was stirred at this temperature for 1 h followed by addition of 16.5 mL (80.7 mmol) of 2-isopropoxy-4,4,5,5-tetramethyl-1,3,2-dioxaborolane. The obtained suspension was stirred at room temperature for 1 h, then poured into 300 mL of water. The obtained mixture was extracted with dichloromethane (3 × 300 mL), the combined organic extract was dried over Na₂SO₄ and then evaporated to dryness. Yield 32.9 g (~quant.) of a colorless glassy solid. ¹H NMR (CDCl₃, 400 MHz): δ 7.75 (d, J = 7.3 Hz, 1 H), 7.44 - 7.36 (m, 1 H), 7.36 - 7.30 (m, 2 H), 7.30 - 7.26 (m, 1 H), 6.96 (d, J = 2.4 Hz, 1 H), 4.53 (d, J = 4.7 Hz, 1 H), 4.37 (d, J = 4.7 Hz, 1 H), 3.22 (s, 3 H), 2.26 - 2.14 (m, 6 H), 2.09 (br. s., 3 H), 1.85 - 1.71 (m, 6 H), 1.30 (s, 9 H), 1.15 (s, 6 H), 1.10 (s, 6 H). ¹³C NMR (CDCl₃, 100 MHz): δ 151.35, 146.48, 144.32, 141.26, 136.15, 134.38, 130.44, 129.78, 126.75, 126.04, 123.13, 98.60, 83.32, 57.08, 41.50, 37.51, 37.09, 34.49, 31.57, 29.26, 24.92, 24.21.

### (2′,2‴-(Pyridine-2,6-diyl)bis((3-adamantan-1-yl)-5-(tert-butyl)-[1,1′-biphenyl]-2-ol))

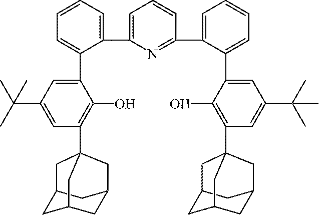 [SMILES: CC(C)(C)c1cc(-c2ccccc2-c2cccc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 32.9 g (62.0 mmol) of 2-(3′-(adamantan-1-yl)-5′-(tert-butyl)-2′-(methoxymethoxy)-[1,1′-biphenyl]-2-yl)-4,4,5,5-tetramethyl-1,3,2-dioxaborolane in 140 mL of dioxane 7.35 g (31.0 mmol) of 2,6-dibromopyridine, 50.5 g (155 mmol) of cesium carbonate and 70 mL of water were subsequently added. The mixture obtained was purged with argon for 10 min followed by addition of 3.50 g (3.10 mmol) of Pd(PPh₃)₄. This mixture was stirred for 12 h at 100° C., then cooled to room temperature and diluted with 50 mL of water. The obtained mixture was extracted with dichloromethane (3 × 50 mL), the combined organic extract was dried over Na₂SO₄ and then evaporated to dryness. To the resulting oil 300 mL of THF, 300 mL of methanol, and 21 mL of 12 N HCl were subsequently added. The reaction mixture was stirred overnight at 60° C. and then poured into 500 mL of water. The obtained mixture was extracted with dichloromethane (3 × 350 mL), the combined organic extract was washed with 5% NaHCO₃, dried over Na₂SO₄, and then evaporated to dryness. The residue was purified by flash chromatography on silica gel 60 (40-63 um, eluent: hexane-ethyl acetate = 10:1, vol.). The obtained glassy solid was triturated with 70 mL of n-pentane, the precipitate obtained was filtered off, washed with 2 × 20 mL of n-pentane, and dried in vacuo. Yield 21.5 g (87%) of a mixture of two isomers as a white powder. ¹H NMR (CDCl₃, 400 MHz): δ 8.10 + 6.59 (2 s, 2H), 7.53 - 7.38 (m, 10H), 7.09 + 7.08 (2d, J = 2.4 Hz, 2H), 7.04 + 6.97 (2d, J = 7.8 Hz, 2H), 6.95 + 6.54 (2d, J = 2.4 Hz), 2.03 - 1.79 (m, 18H), 1.74 - 1.59 (m, 12H), 1.16 + 1.01 (2 s, 18H). ¹³C NMR (CDCl₃, 100 MHz, minor isomer shifts labeled with *): δ 157.86, 157.72*, 150.01, 149.23*, 141.82*, 141.77, 139.65*, 139.42, 137.92, 137.43, 137.32*, 136.80, 136.67*, 136.29*, 131.98*, 131.72, 130.81, 130.37*, 129.80, 129.09*, 128.91, 128.81*, 127.82*, 127.67, 126.40, 125.65*, 122.99*, 122.78, 122.47, 122.07*, 40.48, 40.37*, 37.04, 36.89*, 34.19*, 34.01, 31.47, 29.12, 29.07*.

### Dimethylhafnium(2′,2‴-(pyridine-2,6-diyl)bis((3-adamantan-1-yl)-5-(tert-butyl)-[1,1′-biphenyl]-2-olate)) (Cat-Hf; Complex 5)

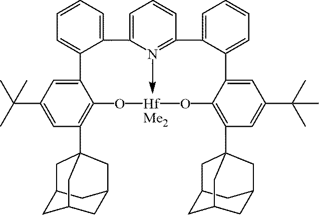

To a suspension of 3.22 g (10.05 mmol) of hafnium tetrachloride (<0.05% Zr) in 250 mL of dry toluene 14.6 mL (42.2 mmol, 2.9 M) of MeMgBr in diethyl ether was added in one portion via syringe at 0° C. The resulting suspension was stirred for 1 min, and 8.00 g (10.05 mmol) of (2′,2‴-(pyridine-2,6-diyl)bis((3-adamantan-1-yl)-5-(tert-butyl)-[1,1′-biphenyl]-2-ol)) was added portionwise for 1 min. The reaction mixture was stirred for 36 h at room temperature and then evaporated to near dryness. The solid obtained was extracted with 2 × 100 mL of hot toluene, and the combined organic extract was filtered through a thin pad of Celite 503. Next, the filtrate was evaporated to dryness. The residue was triturated with 50 mL of n-hexane, the obtained precipitate was filtered off (G3), washed with 20 mL of n-hexane (2 × 20 mL), and then dried in vacuo. Yield 6.66 g (61%, ~1:1 solvate with n-hexane) of a light-beige solid. Anal. Calc. for C₅₉H₆₉HfNO₂×1.0(C₆H₁₄): C, 71.70; H, 7.68; N, 1.29. Found: C 71.95; H, 7.83; N 1.18. ¹H NMR (C₆D₆, 400 MHz): δ 7.58 (d, J = 2.6 Hz, 2 H), 7.22 - 7.17 (m, 2 H), 7.14 -7.08 (m, 4 H), 7.07 (d, J = 2.5 Hz, 2 H), 7.00 - 6.96 (m, 2 H), 6.48 - 6.33 (m, 3 H), 2.62 - 2.51 (m, 6H), 2.47 - 2.35 (m, 6H), 2.19 (br.s, 6H), 2.06 - 1.95 (m, 6H), 1.92 - 1.78 (m, 6H), 1.34 (s, 18 H), -0.12 (s, 6 H). ¹³C NMR (C₆D₆, 100 MHz): δ 159.74, 157.86, 143.93, 140.49, 139.57, 138.58, 133.87, 133.00, 132.61, 131.60, 131.44, 127.98, 125.71, 124.99, 124.73, 51.09, 41.95, 38.49, 37.86, 34.79, 32.35, 30.03.

### Dimethylzirconium(2′,2‴-(pyridine-2,6-diyl)bis((3-adamantan-1-yl)-5-(tert-butyl)-[1,1′-biphenyl]-2-olate)) (Cat-Zr; Complex 6)

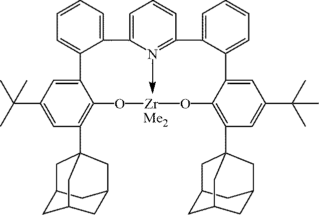

To a suspension of 2.92 g (12.56 mmol) of zirconium tetrachloride in 300 mL of dry toluene 18.2 mL (52.7 mmol, 2.9 M) of MeMgBr in diethyl ether was added in one portion via syringeat 0° C. To the resulting suspension 10.00 g (12.56 mmol) of (2\2‴-(pyridine-2,6-diyl)bis((3-adamantan-1-yl)-5-(tert-butyl)-[1,1′-biphenyl]-2-ol)) was immediately added in one portion. The reaction mixture was stirred for 2 h at room temperature and then evaporated to near dryness. The solid obtained was extracted with 2 × 100 mL of hot toluene, and the combined organic extract was filtered through a thin pad of Celite 503. Next, the filtrate was evaporated to dryness. The residue was triturated with 50 mL of n-hexane, the obtained precipitate was filtered off (G3), washed with n-hexane (2 × 20 mL), and then dried in vacuo. Yield 8.95 g (74%, ~ 1:0.5 solvate with n-hexane) of a beige solid. Anal. Calc. for C₅₉H₆₉ZrNO₂×0.5(C₆H₁₄): C, 77.69; H, 7.99; N, 1.46. Found: C 77.90; H, 8.15; N 1.36. ¹H NMR (C₆D₆, 400 MHz): δ 7.56 (d, J = 2.6 Hz, 2 H), 7.20 - 7.17 (m, 2 H), 7.14 - 7.07 (m, 4 H), 7.07 (d, J = 2.5 Hz, 2 H), 6.98 - 6.94 (m, 2 H), 6.52 - 6.34 (m, 3 H), 2.65 - 2.51 (m, 6H), 2.49 - 2.36 (m, 6H), 2.19 (br.s., 6H), 2.07 - 1.93 (m, 6H), 1.92 - 1.78 (m, 6H), 1.34 (s, 18 H), 0.09 (s, 6 H). ¹³C NMR (C₆D₆, 100 MHz): δ 159.20, 158.22, 143.79, 140.60, 139.55, 138.05, 133.77, 133.38, 133.04, 131.49, 131.32, 127.94, 125.78, 124.65, 124.52, 42.87, 41.99, 38.58, 37.86, 34.82, 32.34, 30.04.

### (Adamantan-1-yl)-2-(methoxymethoxy)-5-(2,4,4-trimethylpentan-2-yl)phenyl)lithium

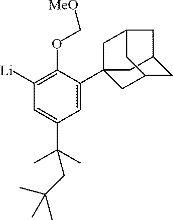

Hexane (100 mL) was added to 1-(2-(methoxymethoxy)-5-(2,4,4-trimethylpentan-2-yl)phenyl)adamantane (12.15 g, 31.59 mmol) to form a clear pale yellow solution. BuLi (12.69 mL, 31.59 mmol) was added dropwise to form a yellow solution. DME (3.284 mL, 31.59 mmol) was added quickly. After stirring overnight white solid was collected on a frit and washed with hexane (3 × 10 mL). The solid was dried under reduced pressure. HNMR analysis indicated the presence of 0.88 equiv of DME. Used without further purification. Yield: 8.36 g, 56.3%.

### 1-(2′-Bromo-2-(methoxymethoxy)-5-(2,4,4-trimethylpentan-2-yl)-[1,1′-biphenyl]-3-yl)adamantane

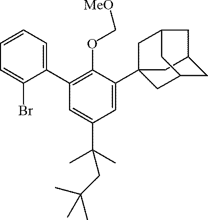 [SMILES: COCOc1c(-c2ccccc2Br)cc(C(C)(C)CC(C)(C)C)cc1C12CC3CC(CC(C3)C1)C2]

Toluene (120 mL) was added to the (3-(adamantan-1-yl)-2-(methoxymethoxy)-5-(2,4,4-trimethylpentan-2-yl)phenyl)lithium(dme)_{0.88} (8.36 g, 17.79 mmol) to form a suspension. A toluene solution (25 mL) of 1-bromo-2-chlorobenzene (3.747 g, 19.57 mmol) was added dropwise over 3.5 hours. After stirring overnight the cloudy mixture was transferred to a separatory funnel and extracted with water (5 × 50 mL), then brine (2 × 10 mL). The organics were dried over MgSO₄, filtered, and evaporated to a pale yellow oil. HNMR indicates the presence of 0.5 equiv of toluene in the crude product. Used without further purification. Yield: 9.92 g, 95.2%.

### 2-(3′-(Adamantan-1-yl)-2′-(methoxymethoxy)-5′-(2,4,4-trimethylpentan-2-yl)-[1,1′-biphenyl]-2-yl)-4,4,5,5-tetramethyl-1,3,2-dioxaborolane.

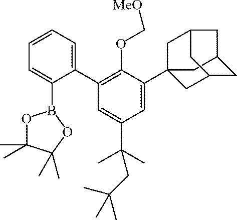 [SMILES: COCOc1c(-c2ccccc2B2OC(C)(C)C(C)(C)O2)cc(C(C)(C)CC(C)(C)C)cc1C12CC3CC(CC(C3)C1)C2]

Hexane (200 mL) was added to 1-(2′-bromo-2-(methoxymethoxy)-5-(2,4,4-trimethylpentan-2-yl)-[1,1′-biphenyl]-3-yl)adamantane (9.92 g, 16.94 mmol) to form a clear solution. The mixture was cooled to -40 C and BuLi (6.84 mL, 17.79 mmol) was added dropwise. After stirring for 20 minutes the mixture was removed from the cold bath and allowed to warm to near ambient temperature over 25 minutes. The mixture was then cooled to -40 C and a cold hexane solution (2 mL) of 2-isopropoxy-4,4,5,5-tetramethyl-1,3,2-dioxaborolane (4.964 g, 26.68 mmol) was added in one portion. The mixture was allowed to warm to ambient temperature slowly then stirred at ambient temperature. After 1 hour the cloudy mixture was poured into a separatoryfunnel and extracted with water (6 × 100 mL) until the aqueous layer was neutral. The organics were the extracted with brine (2 × 20 mL). The organics were dried over MgSO4, filtered, and dried for several days under reduced pressure to afford the product as an amorphous solid. Used without further purificatoin. Yield: 9.197 g, 92.6%.

### 2′,2‴-(Pyridine-2,6-diyl)bis(3-((3r,5r,7r)-adamantan-1-yl)-5-(2,4,4-trimethylpentan-2-yl)-[1″,1‴-biphenyl]-2-ol)

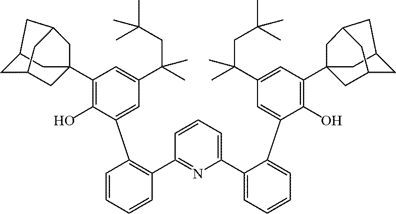 [SMILES: CC(C)(C)CC(C)(C)c1cc(-c2ccccc2-c2cccc(-c3ccccc3-c3cc(C(C)(C)CC(C)(C)C)cc(C45CC6CC(CC(C6)C4)C5)c3O)n2)c(O)c(C23CC4CC(CC(C4)C2)C3)c1]

A 500 mL round-bottomed flask was loaded with 2-(3′-(adamantan-1-yl)-2′-(methoxymethoxy)-5′-(2,4,4-trimethylpentan-2-yl)-[1,1′-biphenyl]-2-yl)-4,4,5,5-tetramethyl-1,3,2-dioxaborolane (9.197 g, 15.68 mmol), 2,6-dibromopyridine (1.783 g, 7.525 mol), Na₂CO₃ (4.154 g, 39.19 mmol), dioxane (180 mL) and water (90 mL). The mixture was sparged with nitrogen for 50 minutes then solid Pd(PPh₃)₄ (0.906 g, 0.784 mmol) was added. The mixture was sparged for an additional 40 minutes, then stirred rapidly and heated in an oil bath maintained at 100 C. After 20 hours the volatiles were evaporated to afford a yellow foamy solid. The solid was broken up and stirred with water (200 mL) for several minutes. The solid was then collected on a frit and washed with water (3 × 200 mL). The yellow solid was then dried under reduced pressure. Methanol (100 mL), thf (100 mL), and concentrated HCl (7 mL) were added and the mixture was heated to 60 C overnight. The volatiles were then evaporated and the residue was extracted with ether (200 mL) and loaded into a separatory funnel. The organics were extracted with dilute NaHCO₃ (100 mL), water (4 × 150 mL) and then brine (20 mL). The organics were dried over MgSO₄ then evaporated to a foamy yellow solid (8.4 g). Crude product was purified on SiO2, eluted with 1-5% EtOAc in isohexane. Yield: 4.92 g, 72.0%.

### Dichloroziconium(2′,2‴-(pyridine-2,6-diyl)bis(3-((3r,5r,7r)-adamantan-1-yl)-5-(2,4,4-trimethylpentan-2-yl)-[1″,1‴-biphenyl]-2-olate)) (Complex 33-dichloride)

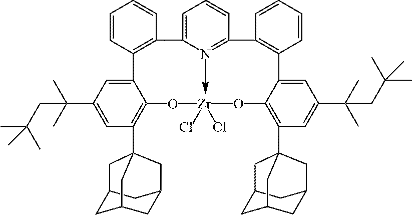

Benzene (4 mL) was added to ZrCl₂(NMe₂)₂(dme) (0.0374 g, 0.110 mmol) to form a slightly cloudy solution. Then 2′,2‴-(pyridine-2,6-diyl)bis(3-((3r,5r,7r)-adamantan-1-yl)-5-(2,4,4-trimethylpentan-2-yl)-[1″,1‴-biphenyl]-2-ol) (0.0998 g, 0.110 mmol) and a little toluene (2 mL) were added and the mixture was stirred at 35° C. After 30 minutes an aliquot was taken for HNMR analysis, which showed fairly clean formation of the presumed dichloride. The solution was then heated to 80° C. for 25 min. The volatiles were evaporated and the residue was dried under reduced pressure. The residue was extracted with hot isohexane (8 mL) and filtered. The volatiles were evaporated to afford a white solid that was dried under reduced pressure at 80° C. for about 5 minutes. Yield: 0.0948 g, 80.7%.

### Dimethylziconium(2′,2‴-(pyridine-2,6-diyl)bis(3-((3r,5r,7r)-adamantan-1-yl)-5-(2,4,4-trimethylpentan-2-yl)-[1″,1‴-biphenyl]-2-olate)) (Complex 33)

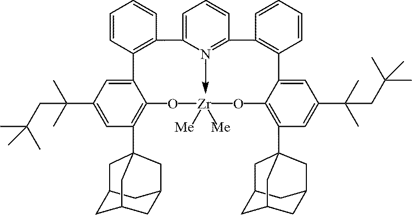

Toluene (6 mL) was added to complex 33-dichloride (0.0948 g, 0.0887 mmol) to form a clear colorless solution. The mixture was cooled to -15° C. and MeMgBr (0.0995 mL, 0.326 mmol) was added. The mixture was allowed to warm to ambient temperature over about 15 minutes. After an hour the solution was evaporated to a residue and a little isohexane (1 mL) was added. The mixture was stirred and evaporated. A little isohexane (1 mL) was added to dissolve the residue and the volatiles were then evaporated again. Then the residue was dried under reduced pressure. The residue was then extracted with isohexane (10 mL), filtered through Celite 503, evaporated to a residue and dried under reduced pressure. Scraping the vial afforded complex 33 as a pale brown solid. Yield: 0.0819 g, 90.0%.

### Polymerization

Polymerizations were carried out in a continuous stirred tank reactor system. A 1-liter Autoclave reactor was equipped with a stirrer, a pressure controller, and a water cooling/steam heating element with a temperature controller. The reactor was operated in liquid fill condition at a reactor pressure in excess of the bubbling point pressure of the reactant mixture, keeping the reactants in liquid phase. Propylene (optional) and isohexane were pumped into the reactors by Pulsa feed pumps and octene (optional) was fed under N₂ head pressure in a holding tank. All flow rates of liquid were controlled using Coriolis mass flow controller (Quantim series from Brooks). Ethylene and hydrogen flowed as a gas under their own pressure through a Brooks flow controller. Ethylene, hydrogen and alpha olefin feeds were combined into one stream and then mixed with a pre-chilled isohexane stream that had been cooled to at least 0° C. The mixture was then fed to the reactor through a single line. Solutions of tri(n-octyl)aluminum (TNOA) were added to the combined solvent and monomer stream just before they entered the reactor. Catalyst solution was fed to the reactor using an ISCO syringe pump through a separated line.

Isohexane (used as solvent), and monomers (e.g., ethylene, octene, and propylene) were purified over beds of alumina and molecular sieves. Toluene for preparing catalyst solutions was purified by the same technique.

The complex Cat-Zr (Complex 6) was used for Examples 1 to 17. The catalyst solution was prepared by combining complex Cat-Zr (ca. 20 mg) with N,N-dimethylanilinium tetrakis(pentafluorophenyl) borate at a molar ratio of about 1:1 in 900 ml of toluene. Solution of tri-n-octyl aluminum (TNOA) (25 wt% in hexane, Sigma Aldrich) was further diluted in isohexane at a concentration of 2.7 × 10⁻³ mol/liter.

The polymer produced in the reactor exited through a back pressure control valve that reduced the pressure to atmospheric. This caused the unconverted monomers in the solution to flash into a vapor phase which was vented from the top of a vapor liquid separator. The liquid phase, comprising mainly polymer and solvent, was collected for polymer recovery. The collected samples were first air-dried in a hood to evaporate most of the solvent, and then dried in a vacuum oven at a temperature of about 90° C. for about 12 hours. The vacuum oven dried samples were weighed to obtain yields. Detailed process condition and some characterization data for ethylene-octene copolymers are listed in Table 2 for Examples 1 to 10. Detailed process condition and some characterization data for ethylene-propylene copolymers are listed in Table 3 for Examples 11 to 17.

TABLE 2

| | | | |
|---|---|---|---|
| Example # | 1 | 2 | 3 |
| Polymerization temperature (°C) | 120 | 120 | 120 |
| Hydrogen feed rate (cc/min) | 0 | 0 | 0 |
| Ethylene feed rate (g/min) | 9.05 | 9.05 | 9.05 |
| Octene feed rate (g/min) | 3.0 | 2.5 | 2.0 |
| Catalyst feed rate (mol/min) | 3.641E-08 | 3.641E-08 | 3.641E-08 |
| TNOA feed rate (mol/min) | 1.480E-05 | 1.237E-05 | 1.115E-05 |
| Isohexane feed rate (g/min) | 50.79 | 49.02 | 48.13 |
| Polymer yield (gram/min) | 1.6 | 3.5 | 2.6 |
| Conversion (%) | 17.80% | 39.20% | 28.20% |
| Ethylene content (wt %) | 86.5% | 87.6% | 88.7% |
| Ethylene content (mol %) | 96.3% | 96.6% | 96.9% |
| Tc (°C) | 84.0 | 86.3 | 88.0 |
| Tm (°C) | 100.2 | 101.6 | 103.2 |
| Heat of fusion (J/g) | 79.9 | 87.6 | 90.9 |
| Mn_IR (g/mol) | 252,315 | 293,485 | 348,497 |
| Mw_IR (g/mol) | 608,270 | 688,996 | 824,306 |
| Mz_IR (g/mol) | 1,283,191 | 1,424,268 | 1,571,506 |
| Mn_LS (g/mol) | 345,381 | 393,277 | 397,501 |
| Mw_LS (g/mol) | 772,614 | 859,383 | 924,509 |
| Mz_LS (g/mol) | 1,287,733 | 1,445,069 | 1,678,352 |
| Mw/Mn | 2.24 | 2.19 | 2.33 |
| Long chain branching index, g′ᵥᵢₛ (-) | 0.946 | 0.928 | 0.889 |
| Melt flow index (I₂) (g/10 min) | <0.1 | <0.1 | <0.1 |
| Complex viscosity @ 0.1 rad/s (Pa.s) | 1,789,088 | 2,216,378 | 2,210,482 |
| Complex viscosity @ 0.245 rad/s (Pa.s) | 1,002,088 | 1,140,702 | 1,117,755 |
| Complex viscosity @ 128 rad/s (Pa.s) | 7,299 | 6,820 | 6,377 |

TABLE 2 (continued)

| | | | | |
|---|---|---|---|---|
| Example # | 4 | 5 | 6 | 7 |
| Polymerization temperature (°C) | 127 | 127 | 127 | 127 |
| Hydrogen feed rate (cc/min) | 30 | 30 | 30 | 15 |
| Ethylene feed rate (g/min) | 9.05 | 9.05 | 9.05 | 9.05 |
| Octene feed rate (g/min) | 2.5 | 2.2 | 2.0 | 2.0 |
| Catalyst feed rate (mol/min) | 4.127E-08 | 4.127E-08 | 4.127E-08 | 4.127E-08 |
| TNOA feed rate (mol/min) | 7.385E-06 | 7.385E-06 | 7.385E-06 | 7.385E-06 |
| Isohexane feed rate (g/min) | 56.7 | 56.7 | 56.7 | 56.7 |
| Polymer yield (gram/min) | 11.3 | 11.0 | 10.9 | 10.6 |
| Conversion (%) | 98.08% | 97.25% | 98.16% | 95.83% |
| Ethylene content (wt %) | 73.3% | 75.8% | 77.8% | 77.5% |
| Ethylene content (mol%) | 91.7% | 92.6% | 93.3% | 93.2% |
| Tc (°C) | 65.6 | 69.8 | 73.7 | 77.6 |
| Tm (°C) | 82.5 | 86.0 | 89.7 | 84.9 |
| Heat of fusion (J/g) | 46.8 | 57.4 | 58.8 | 57.1 |
| Mn_IR (g/mol) | 27,286 | 29,088 | 29,700 | 35,501 |
| Mw_IR (g/mol) | 66,971 | 72,175 | 77,218 | 101,232 |
| Mz_IR (g/mol) | 209,929 | 226,464 | 281,673 | 353,477 |
| Mn_LS (g/mol) | 28,625 | 29,983 | 31,995 | 38,559 |
| Mw_LS (g/mol) | 71,187 | 76,015 | 80,803 | 104,087 |
| Mz_LS (g/mol) | 209,548 | 227,029 | 256,599 | 304,262 |
| Mw/Mn | 2.49 | 2.54 | 2.53 | 2.70 |
| Long chain branching index, g′ᵥᵢₛ (-) | 0.943 | 0.951 | 0.956 | 0.973 |
| Melt flow index (I₂) (g/10 min) | 9.7 | 5.7 | 3.9 | 0.8 |
| I₂₁ (g/10 min) | | | 141.4 | 48.5 |
| I₂₁/I₂ (-) | | | 36.4 | 60.4 |
| Complex viscosity @ 0.1 rad/s (Pa.s) | 2,881 | 2,492 | 10,843 | 10,031 |
| Complex viscosity @ 0.245 rad/s (Pa.s) | 2,043 | 1,163 | 3,870 | 10,453 |
| Complex viscosity @ 128 rad/s (Pa.s) | 340 | 446 | 535 | 922 |

TABLE 2 (continued)

| | | | |
|---|---|---|---|
| Example # | 8 | 9 | 10 |
| Polymerization temperature (°C) | 135 | 136 | 136 |
| Hydrogen feed rate (cc/min) | 10 | 10 | 10 |
| Ethylene feed rate (g/min) | 9.05 | 9.05 | 9.05 |
| Octene feed rate (g/min) | 2.5 | 2.0 | 1.5 |
| Catalyst feed rate (mol/min) | 2.913E-08 | 2.913E-08 | 2.913E-08 |
| TNOA feed rate (mol/min) | 7.385E-06 | 7.385E-06 | 7.385E-06 |
| Isohexane feed rate (g/min) | 72.7 | 72.7 | 72.7 |
| Polymer yield (gram/min) | 10.4 | 10.0 | 9.5 |
| Conversion (%) | 89.8% | 90.1% | 90.3% |
| Ethylene content (wt %) | 83.0% | 86.2% | 87.4% |
| Ethylene content (mol%) | 95.1% | 96.2% | 96.5% |
| Density (g/cm³) | 0.9065 | 0.9093 | 0.9121 |
| Tc (°C) | 93.6 | 97.8 | 99.9 |
| Tm (°C) | 109.4 | 112.9 | 116.5 |
| Heat of fusion (J/g) | 106.8 | 106.4 | 115.0 |
| Mn_IR (g/mol) | 42,285 | 48,090 | 53,138 |
| Mw_IR (g/mol) | 191,588 | 220,635 | 261,686 |
| Mz_IR (g/mol) | 596,420 | 680,920 | 807,216 |
| Mn_LS (g/mol) | 47,427 | 52,978 | 57,207 |
| Mw_LS (g/mol) | 193,371 | 223,486 | 267,335 |
| Mz_LS (g/mol) | 532,380 | 605,164 | 757,077 |
| Mw/Mn | 4.08 | 4.22 | 4.67 |
| Long chain branching index, g′ᵥᵢₛ (-) | 1.002 | 0.981 | 0.976 |
| Melt flow index (I₂) (g/10 min) | <0.1 | <0.1 | <0.1 |
| I₂₁ (g/10 min) | 2.73 | 1.30 | 0.41 |

TABLE 3

| | | | |
|---|---|---|---|
| Example # | 11 | 12 | 13 |
| Polymerization temperature (°C) | 120 | 110 | 90 |
| Ethylene feed rate (g/min) | 6.79 | 6.79 | 6.79 |
| Propylene feed rate (g/min) | 6 | 6 | 6 |
| Isohexane feed rate (g/min) | 63.7 | 63.7 | 63.7 |
| Catalyst feed rate (mol/min) | 3.156E-09 | 3.156E-09 | 1.942E-09 |
| TNOA feed rate (mol/min) | 5.075E-06 | 5.075E-06 | 5.075E-06 |
| Polymer yield (gram/min) | 10.86 | 9.89 | 6.06 |
| Ethylene content (wt %) | 57.80% | 60.40% | 72.47% |
| Ethylene content (mol%) | 67.3% | 69.6% | 79.8% |
| Complex viscosity @ 0.1 rad/s | 602,204 | 669,511 | 1,750,767 |
| Complex viscosity @ 0.245 rad/s | 338,706 | 395,076 | 1,090,844 |
| Complex viscosity @ 128 rad/s | 4,530 | 5,281 | 7,381 |
| Shear thinning ratio (-) | 74.8 | 74.8 | 147.8 |
| Phase angle @ complex modulus G*=500k Pa (degree) | 20.6 | 23.2 | 30.6 |
| ML (mu) | 89.3 | 115.2 | 82.0 |
| MLRA (mu.sec) | 551.7 | 595.5 | 3165.3 |
| cMLRA (mu.sec) | 470.8 | 352.3 | 3053.1 |

TABLE 3 (continued)

| | | | | |
|---|---|---|---|---|
| Example # | 14 | 15 | 16 | 17 |
| Polymerization temperature (°C) | 120 | 120 | 120 | 120 |
| Ethylene feed rate (g/min) | 6.79 | 6.79 | 6.79 | 6.79 |
| Propylene feed rate (g/min) | 6 | 6 | 6 | 6 |
| Isohexane feed rate (g/min) | 62.7 | 62.7 | 62.7 | 62.7 |
| Catalyst feed rate (mol/min) | 6.069E-09 | 6.069E-09 | 6.069E-09 | 6.069E-09 |
| TNOA feed rate (mol/min) | 3.703E-06 | 3.703E-06 | 3.703E-06 | 3.703E-06 |
| H2 feed rate (cc/min) | 2.41 | 4.82 | 10 | 15 |
| Polymer yield (gram/min) | 12.13 | 13.23 | 12.70 | 12.70 |
| Ethylene content (wt %) | 52.80% | 52.26% | 51.57% | 50.69% |
| Ethylene content (mol%) | 62.7% | 62.2% | 61.5% | 60.7% |
| ML (mu) | 38.6 | 40.0 | 38.5 | 34.9 |
| MLRA (mu.sec) | 305.8 | 393.7 | 383.7 | 311.9 |
| cMLRA (mu.sec) | 872.4 | 1068.1 | 1101.3 | 1028.7 |
| Mn_IR (g/mol) | 77,318 | 67,497 | 67,466 | 60,569 |
| Mw_IR (g/mol) | 203,846 | 196,217 | 198,879 | 181,239 |
| Mz_IR (g/mol) | 399,036 | 397,133 | 407,484 | 377,335 |
| Mn_LS (g/mol) | 82,896 | 74,123 | 72,476 | 64,962 |
| Mw_LS (g/mol) | 226,633 | 222,238 | 224,060 | 210,045 |
| Mz_LS (g/mol) | 440,440 | 446,149 | 455,231 | 452,025 |
| Branching index, g′ᵥᵢₛ, (-) | 0.867 | 0.833 | 0.828 | 0.817 |
| MWD (-) | 2.73 | 3.00 | 3.09 | 3.23 |

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

What is claimed is:

1. A polymerization process comprising contacting in a homogeneous phase ethylene and an optional comonomer selected from C₃ to C₄₀ alpha olefins with a catalyst system comprising activator and catalyst compound represented by the Formula (I): 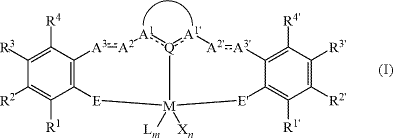
wherein:
M is a group 3, 4, 5, or 6 transition metal or a Lanthanide;
E and E′ are each independently O, S, or NR⁹ where R⁹ is independently hydrogen, a C₁-C₄₀ hydrocarbyl, a C₁-C₄₀ substituted hydrocarbyl or a heteroatom-containing group;
Q is group 14, 15, or 16 atom that forms a dative bond to metal M;
A¹QA^{1′} are part of a heterocyclic Lewis base containing 4 to 40 non-hydrogen atoms that links A² to A^{2′} via a 3-atom bridge with Q being the central atom of the 3-atom bridge, A¹ and A^{1′} are independently C, N, or C(R²²), where R²² is selected from hydrogen, C₁-C₂₀ hydrocarbyl, C₁-C₂₀ substituted hydrocarbyl; 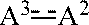
is a divalent group containing 2 to 40 non-hydrogen atoms that links A ¹ to the E-bonded aryl group via a 2-atom bridge; 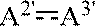
is a divalent group containing 2 to 40 non-hydrogen atoms that links A ^{1′} to the E′-bonded aryl group via a 2-atom bridge;
L is a Lewis base;
X is an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, a C₁-C₄₀ hydrocarbyl, a C₁-C₄₀ substituted hydrocarbyl, a heteroatom or a heteroatom-containing group, and one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
any two L groups may be joined together to form a bidentate Lewis base;
an X group may be joined to an L group to form a monoanionic bidentate group;
any two X groups may be joined together to form a dianionic ligand group;
and obtaining a polymer comprising greater than 35 mole% ethylene.

2. The process of claim 1 where the catalyst compound represented by the Formula (II) 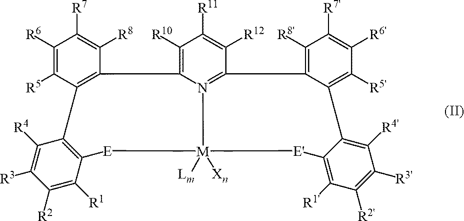
wherein:
M is a group 3, 4, 5, or 6 transition metal or a Lanthanide;
E and E′ are each independently O, S, or NR⁹, where R⁹ is independently hydrogen, a C₁-C₄₀ hydrocarbyl, a C₁-C₄₀ substituted hydrocarbyl, or a heteroatom-containing group;
each L is independently a Lewis base;
each X is independently an anionic ligand;
n is 1, 2 or 3;
m is 0, 1, or 2;
n+m is not greater than 4;
each of R¹, R², R³, R⁴, R^{1′}, R^{2′}, R^{3′}, and R^{4′} is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; any two L groups may be joined together to form a bidentate Lewis base;
an X group may be joined to an L group to form a monoanionic bidentate group;
any two X groups may be joined together to form a dianionic ligand group;
each of R⁵, R⁶, R⁷, R⁸, R^{5′}, R^{6′}, R^{7′}, R^{8′}, R¹⁰, R¹¹, and R¹² is independently hydrogen, a C₁-C₄₀ hydrocarbyl, a C₁-C₄₀ substituted hydrocarbyl, a heteroatom or a heteroatom-containing group, or one or more of R⁵ and R⁶, R⁶ and R⁷, R⁷ and R⁸, R^{5′} and R^{6′}, R^{6′} and R^{7′}, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

3. The process of claim 1 wherein the M is Hf, Zr or Ti.

4. The process of claim 1, wherein E and E′ are each O.

5. The process of claim 1, wherein R¹ and R^{1′} are independently selected from the group consisting of a C₄-C₄₀ tertiary hydrocarbyl group, a C₄-C₄₀ cyclic tertiary hydrocarbyl group, and a C₄-C₄₀ polycyclic tertiary hydrocarbyl group.

6-7. (canceled)

8. The process of claim 1 wherein each X is, independently, selected from the group consisting of substituted or unsubstituted hydrocarbyl radicals having from 1 to 20 carbon atoms, hydrides, amides, alkoxides, sulfides, phosphides, halides, and a combination thereof, (two X’s may form a part of a fused ring or a ring system).

9. The process claim 1 wherein each L is, independently, selected from the group consisting of: ethers, thioethers, amines, phosphines, ethyl ether, tetrahydrofuran, dimethylsulfide, triethylamine, pyridine, alkenes, alkynes, allenes, and carbenes and a combinations thereof, optionally two or more L’s may form a part of a fused ring or a ring system).

10. The process of claim 1, wherein M is Zr or Hf, Q is nitrogen, both A¹ and A^{1′} are carbon, both E and E′ are oxygen, and both R¹ and R^{1′} are independently selected from the group consisting of C₄-C₂₀ cyclic tertiary alkyls, adamantan-1-yl, and substituted adamantan-1-yl.

11. (canceled)

12. The process of claim 1, wherein M is Zr or Hf, Q is nitrogen, both A¹ and A^{1′} are carbon, both E and E′ are oxygen, and X is methyl or chloro, and n is 2.

13. The process of claim 1, wherein Q is nitrogen, A¹ and A^{1′} are both carbon, both R¹ and R^{1′} are hydrogen, both E and E′ are NR⁹, where R⁹ is selected from a C₁-C₄₀ hydrocarbyl, a C₁-C₄₀ substituted hydrocarbyl, or a heteroatom-containing group.

14. The process of claim 1, wherein Q is carbon, A¹ and A^{1′} are both nitrogen, and both E and E′ are oxygen.

15. The process of claim 1, wherein Q is carbon, A¹ is nitrogen, A^{1′} is C(R²²), and both E and E′ are oxygen, where R²² is selected from hydrogen, C₁-C₂₀ hydrocarbyl, C₁-C₂₀ substituted hydrocarbyl.

16. The process of claim 1, wherein the heterocyclic Lewis base is selected from the groups represented by the following formulas: 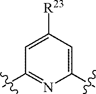 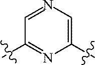 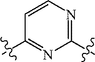 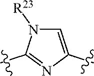 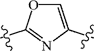 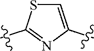 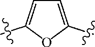 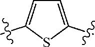 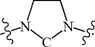 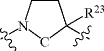 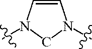 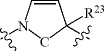
where each R
²³ is independently selected from hydrogen, C₁-C₂₀ alkyls, and C₁-C₂₀ substituted alkyls.

17-22. (canceled)

23. The process of claim 1 wherein the catalyst compound is represented by one or more of the following formulas: 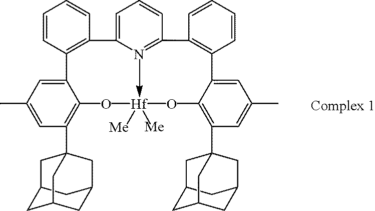 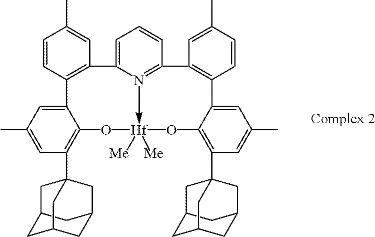 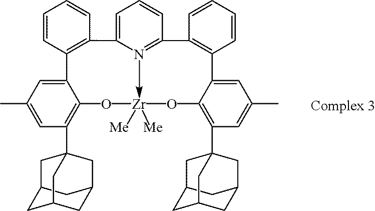 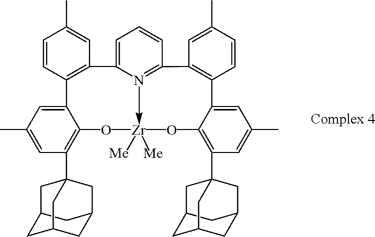 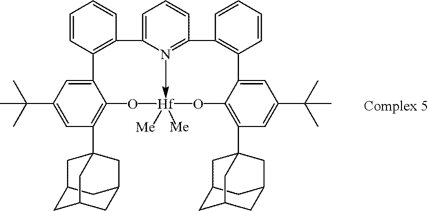 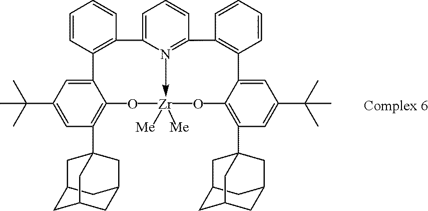 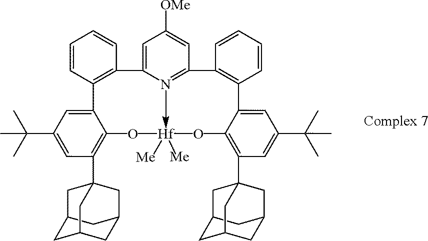 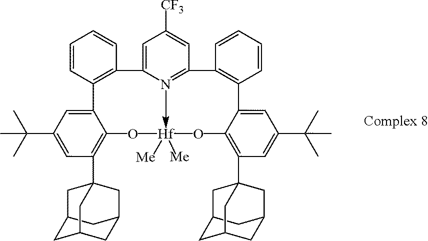 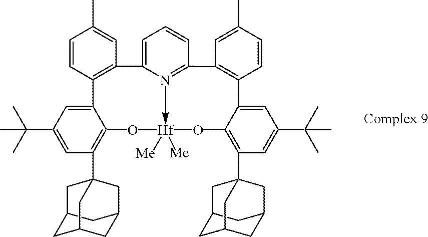 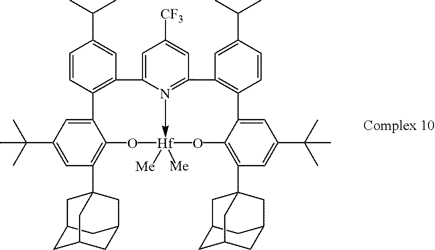 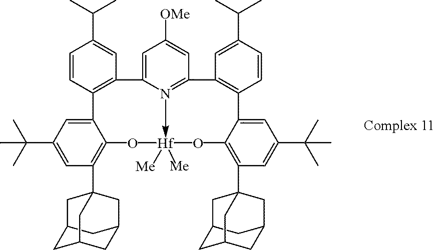 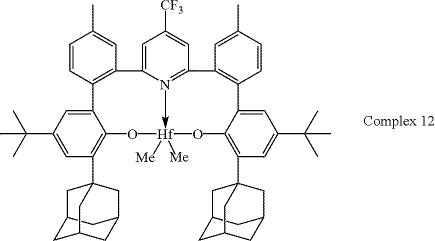 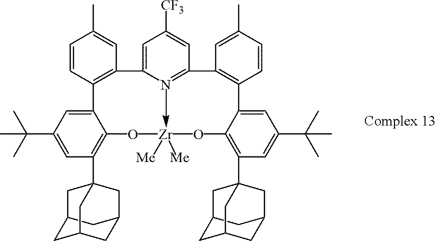 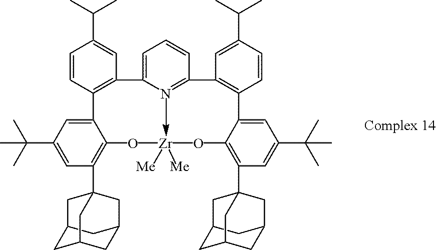 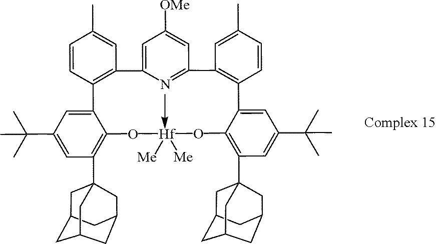 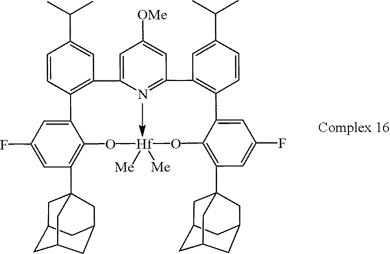 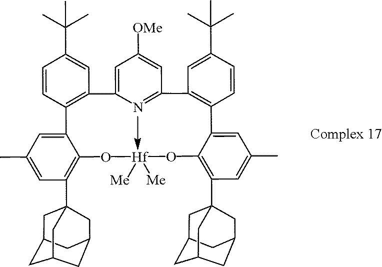 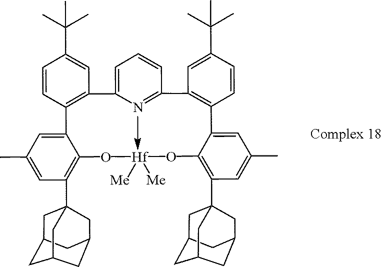 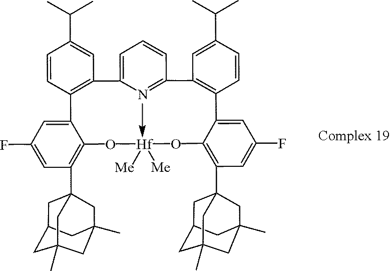 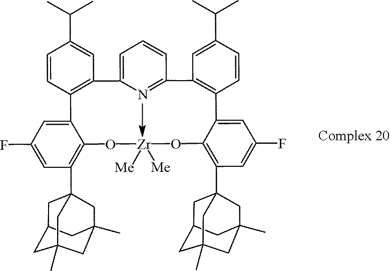 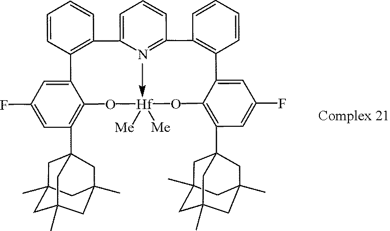 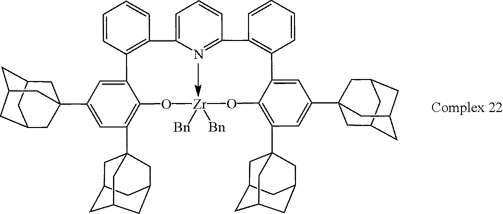 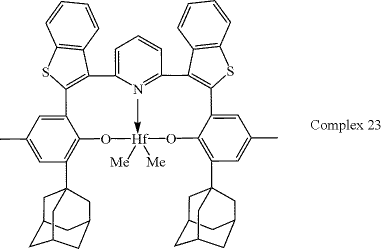 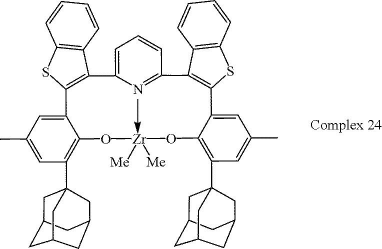 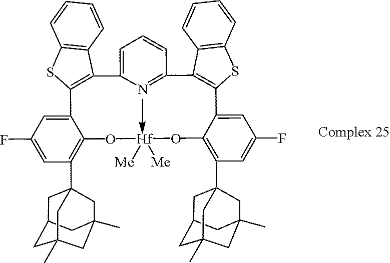 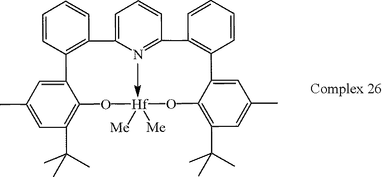 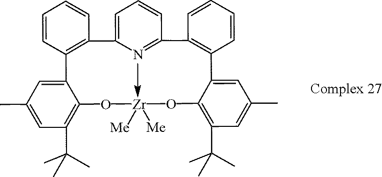 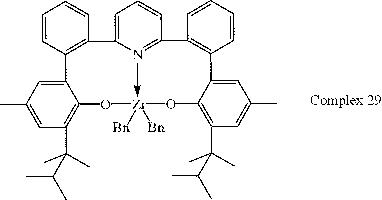 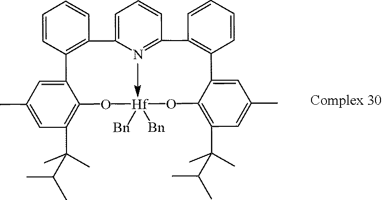 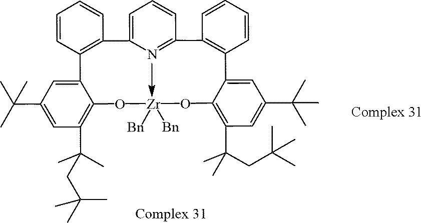 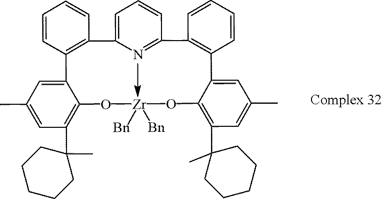 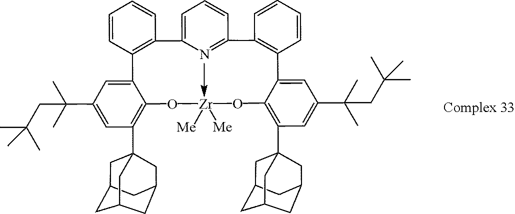
.

24-31. (canceled)

32. The process of claim 1, wherein the process is a solution process.

33-34. (canceled)

35. The process of claim 1 further comprising obtaining a polyethylene composition with at least 20 mol% ethylene content.

36. The process of claim 1 further comprising obtaining an ethylene copolymer wherein the copolymer has a composition of at least 20 mol% ethylene, and a shear thinning ratio that is greater than 30, and an I₂₁/I₂ greater than 10.

37. A polymer comprising ethylene and comonomer selected from propylene, butene, hexene and octene, where the copolymer has a composition of at least 20 mol% ethylene and a melt index of 400 g/10 min or less.

38. A polymer produced by the process of claim 1 comprising ethylene and one or more comonomer selected from propylene, butene, hexene and octene, where the copolymer has 30 to 50 mol% ethylene content.

39. A polymer produced by the process of claim 1 comprising ethylene and one or more comonomer selected from propylene, butene, hexene and octene, where the copolymer has 50 to 70 mol% ethylene content.

40. A polymer produced by the process of claim 1 comprising ethylene and one or more comonomer selected from propylene, butene, hexene and octene, where the copolymer has 70 to 90 mol% ethylene content.

41. A polymer produced by the process of claim 1 comprising ethylene and one or more comonomer selected from propylene, butene, hexene and octene, where the copolymer has 90 mol% or higher ethylene content.

42. A polymer produced by process of claim 1 comprising ethylene and one or more comonomer selected from propylene, butene, hexene and octene, where the copolymer has a branching index of 0.98 or less.

43. (canceled)

44. A copolymer produced by a polymerization process comprising contacting in a homogeneous phase ethylene and propylene with a catalyst system comprising an activator and group 4 bis(phenolate) catalyst compound, wherein the polymerization process takes place at a temperature of 120° C. or higher in the presence of added hydrogen, to produce a polymer having:
(i) 50 to 65 mol% ethylene;
(ii) a g′ᵥᵢₛ of from 0.8 to 0.9;
(iii) a Mooney Large viscosity (measured at 125° C.) of 35 to 40 mu;
(iv) a Mooney relaxation area (measured at 125° C.) of 300-400 mu.sec.
